(19) United States
(12) Patent Application Publication
(10) Pub. No.: US 2026/0010420 A1
(43) Pub. Date: Jan. 8, 2026

(54) APPLICATION PROGRAMMING INTERFACE UTILIZATION SUPPORT SYSTEM

(71) Applicant: ASANUMA HOLDINGS CO., LTD., TOKYO (JP)

(72) Inventor: Katsuhide ASANUMA, YAMANASHI (JP)

(73) Assignee: ASANUMA HOLDINGS CO., LTD., TOKYO (JP)

(21) Appl. No.: 19/262,105

(22) Filed: Jul. 8, 2025

Related U.S. Application Data
(60) Provisional application No. 63/668,301, filed on Jul. 8, 2024.
(60) Provisional application No. 63/686,167, filed on Aug. 23, 2024.

(51) Int. Cl. G06F 9/54; G06F 9/451; G06F 16/248

(52) U.S. Cl. CPC G06F 9/543; G06F 9/451; G06F 16/248

(57) ABSTRACT

The present invention relates to an API utilization support system that collaborates with APIs of AI systems and supports data processing and utilization of AI models through the construction of visual data flows. The present invention relates to an application programming interface (API) utilization support system that supports data processing and utilization of artificial intelligence (AI) models in cooperation with APIs of AI systems. The system is implemented on a computer system equipped with processors and memory and includes a chest flow configuration GUI processor that enables visual construction of data flows via a graphical user interface (GUI) while supporting the use of APIs, a database that stores configuration information, and a chest flow execution controller that controls the data flows and chests.

### CROSS-REFERENCE TO RELATED APPLICATIONS

The present application claims priority based on U.S. Provisional Patent Application No. 63/668,301 filed on Jul. 8, 2024, and U.S. Provisional Patent Application No. 63/686,167 filed on Aug. 23, 2024, and the entire contents of which are incorporated herein by reference.

### BACKGROUND OF THE INVENTION

### Technical Field

The present invention relates to a computer system technically configured to efficiently support the use of application programming interfaces (APIs), and more particularly, to an API utilization support system that generates and executes a structured dataflow which influences the behavior or output of the API, based on input to a plurality of objects displayed via a graphical user interface (GUI), in a manner that allows trial operations at any time.

### Description of the Related Arts

In recent years, artificial intelligence (AI) systems have been deployed as open-access computing services via the Internet, allowing public access. Various types of AI models have been developed, including language models such as the “GPT” series for natural language processing, image generation models such as “DALL-E,” and speech recognition models such as “Whisper.” To facilitate the use of such AI models, platform services are provided in different forms. For instance, an API platform is made available for programmatic access to the models. A conversational AI system referred to as “ChatGPT” is also offered as an interface for interacting with a language model. In addition, various AI models, including those mentioned above, are published and made accessible on open platforms such as Hugging Face. Cloud service providers such as Amazon Web Services (AWS), Google Cloud, and Microsoft Azure offer environments and tools for integrating and executing API calls to such AI models.

A developer of computer programs may incorporate the functionality of external AI models into their own application programs or services by utilizing an API provided for such models. In some cases, the developer may customize the AI models to suit specific requirements. For example, they may adjust model behavior by modifying parameters such as “temperature” or “token count,” the latter referring to the number of discrete language units into which a sentence is divided. By contrast, general users-namely, users who do not possess programming expertise-typically interact with the AI model by inputting a single query (also referred to as a prompt), observing the generated response, and iteratively adjusting the input in an attempt to obtain a desired result.

From the perspective of general users, even when a developer offers a user-friendly AI model and constructs a platform for its use, there may be concern that utilizing such a platform inherently involves accepting the developer's subjective preferences or design choices. Given that human reasoning processes, conceptual frameworks, and underlying assumptions differ among individuals, users tend to prefer platforms that support their own process of trial and error, rather than platforms that reflect or impose the biases of the developer. Even if trial-and-error requires additional effort, there is a tendency for users to favor platforms that make the interaction process visually accessible and allow them to reach a final conclusion with greater personal conviction or understanding.

LangSmith, offered by LangChain, is a platform designed to support the debugging and evaluation of applications incorporating large language models (LLMs). The platform is known to include a function for visualizing the end-to-end processing flow—from the input query to the generated response—by presenting it to the user in the form of a directed graph.

### PRIOR ART DOCUMENTS

[Non-Patent Literature 1] LangChain, “LangSmith-Development Tool for LLM Applications,” https://www.langchain.com/langsmith (last accessed Apr. 11, 2025).

### SUMMARY OF THE INVENTION

### Problems to be Solved by the Invention

Conventionally, tools such as LangSmith for LLM application development support and API-based AI utilization frameworks are certainly useful in that they provide functionality for tracing, visualizing, and debugging the behavior of LLMs; however, these tools have a problem in that the improvement or adjustment of output mainly depends on the iterative evaluation of “test datasets” or “prompt history,” and lacks mechanisms that guide output results through direct and intuitive manipulation of the user's topic of interest or intent. In addition, such conventional technologies are developer-driven in the output adjustment process and are not intuitive in terms of visual or operational aspects for general users, and do not visualize causal relationships or structural backgrounds regarding “why such a result was produced,” while improvement of output is easily influenced by design constraints of tools or models, API specifications, or fixed step structures, thereby imposing technical limitations that hinder users' free expression of intent.

Discussing the conventional issues in more detail, in conventional AI service integrations, users needed to understand different API specifications for each service and implement them individually, which resulted in extremely high costs for development and maintenance. API authentication, log management, and usage restriction operations were also handled individually, causing significant burdens in security management and lack of consistency. Because the structure was dependent on a single service, flexible integration or switching among multiple AI models was difficult, impairing general versatility and scalability. Additionally, operations such as model construction and data processing were not visualized, making the system extremely difficult to use for non-engineering users.

Under such an environment, monolithic server configurations were mainstream, making it difficult to perform function-level scaling or load balancing, which greatly restricted the availability and scalability of the system. The architecture lacked clear separation of roles between the data flow configuration unit, the chest flow execution controller, and the database on the front-end side, resulting in maintainability issues in the system. The user interface and data flow design were not intuitive, and because data dependencies were not explicitly indicated, users were forced to perform complex operations, thereby increasing the operational burden.

Context management using LLMs also depended on internal logic and was difficult to control through arbitrary operations. Mechanisms for real-time display and user experience (UX) design were insufficient, providing few means for users to immediately grasp the current processing status. Furthermore, message processing and integration with external APIs were tightly coupled, making expansion and reuse difficult, and when adding new APIs, individual implementation by manual work was required. Because tag management and pre- and post-processing descriptions were distributed, achieving both flexibility and scalability was difficult, and modular independence among components was not maintained.

Due to the insufficient visualization of processing flows and structures, encapsulation of the entire flow was not achieved, and the dependencies among chests (processing nodes) were statically defined. Since the registration and execution of processing were performed as separate processes, consistency checks were required each time, resulting in frequent rework. The linkage between the UI and execution results was also weak, and operations such as editing or tag setting were not immediately reflected, posing significant usability issues.

The global/local mapping of tags was not integrated, making inheritance and centralized management of data difficult, and issues remained with maintaining data consistency during recovery from erroneous operations and state transitions. Generation, execution, and property editing of chests were intermittent, requiring multiple steps before execution, which hindered construction efficiency. There was no unified mechanism for map/yield processing or sequence registration, resulting in a lack of flexibility.

Additionally, the message structure was not unified, and plain text and structured data were managed in a mixed state, making subsequent processing and tracking difficult. The type validation mechanism was insufficient, leading to reliability issues in error detection and prevention. Injecting file data, defining functions, and linking with message structures were cumbersome and lacked structured management. The input/output specifications for REST APIs, LLM integration, and various queries were not unified, which increased development workload.

In response extraction processing as well, branching for each condition was divided on a module basis, causing problems with maintainability and reusability. Furthermore, consistency between argument processing and notebook definitions was low, and flexible data linkage spanning both was not achieved. Property and structure settings were cumbersome, and definition updates were not always immediately reflected. There was no mechanism to inherit previous processing results or to implement bidirectional mapping of data, leading to low overall system integration.

In view of such issues, the present invention provides a processing mechanism that receives user input for a plurality of objects (such as topic nodes and output elements) presented visually via GUI and based on sequential and experimental operations such as selection, editing, and reconfiguration of the objects, sequentially constructs and optimizes the output results. According to the present invention, it becomes possible to visually operate on topics corresponding to one's own interests or inquiries, and to freely adjust or develop output content without being constrained by predefined API structures or system design limitations, thereby realizing a user-oriented output improvement system. Furthermore, it enables adjustment without being affected by uncontrollable disruptive factors such as external model design or specification changes and provides a visual feedback loop indicating “which operation influenced which output,” thereby facilitating meaningful trial-and-error processes.

### Means to Solve the Problems

To solve the above problems, a representative configuration of an application programming interface (API) utilization support system according to the present invention implemented on a computer system comprising a plurality of processors and memory is designed such that the API utilization support system designed to operate in conjunction with an API of an external artificial intelligence (AI) system supporting complex data processing, the API utilization support system includes: (a) a chest flow configuration graphical user interface (GUI) processor including a GUI rendered on a display and interface elements arranged to enable visual creation, connection, and selection of a plurality of data processing nodes (chests) on a canvas, to generate a flow structure defining a data flow between the chests, and to allow definition of processing order and dependencies for each of the chests; (b) a database unit comprising a plurality of tables including at least account information, project information, chest detail information, connection relationship information among chests, message processing support helper information, AI model information, uploaded data file information, script data, and data flow identification information; and (c) a chest flow execution controller operatively connected to the chest flow configuration GUI processor and the database unit, which comprises circuitry and logic components to respond to sequential operation requests from the GUI by performing data exchange with the database unit, managing generation, deletion, placement, and updating of chests, controlling data flows and dependencies among chests, supporting graphical selection of execution of processing steps associated with the chests, constructing and transmitting messages to the API of the external AI system, receiving corresponding responses, and processing the responses in relation to the associated chests, in which the chest flow configuration GUI processor, the database unit, and the chest flow execution controller are network-connected components structured to make collaborative operation resulting in construction and execution of complex processing flows that involve interactions with the external AI system and are defined by visual and sequential user inputs.

In the API utilization support system of the present invention, the chest flow execution controller further includes a notebook executor including a virtualized execution environment for processing scripts or structured queries associated with the chests and memory and output modules adapted to retain and provide execution results in a format usable for subsequent processing within the system; and a file storage including memory components arranged to user-uploaded data files and system-generated files and management logic for holding storage and retrieval operations.

In the API utilization support system of the present invention, the chest flow execution controller further includes a computation processing support module containing a transmission interface for sending a script associated with the chest and corresponding input data to the API of the external AI system; a response handler for acquiring a response from the API and performing analysis and formatting of the response as a processing result; and a delivery component for providing the processed response to the chest or to subsequent processing modules within the system.

In the API utilization support system of the present invention, the chest flow execution controller further comprises a text preprocessing unit including a text analysis module for processing unstructured or semi-structured text data and a data extraction module for generating structured data formatted in a manner suitable for processing by the API of the external AI system

In the API utilization support system of the present invention, the chest flow execution controller includes: a dependency management module that regulates the execution order and interdependencies of data processing operations across a plurality of chests, based on construction information of the dataflow defined by the chest flow configuration GUI processor; a message generation module that constructs and transmits inquiries to the API of the external AI system from each chest in a consistent message format defined according to the configuration of each chest, and a response management module that stores the obtained API responses as messages associated with the respective chests; and a message propagation module that enables sequential propagation and transformation of messages through subsequent chests, applying content conversion as needed, in which the entire processing flow is thereby updated dynamically and in real time to allow feedback control of outputs throughout the system.

In the API utilization support system of the present invention, a respective chest is a basic unit for data processing and includes at least one of different operation modes including: a map-type chest that performs identical processing in parallel to a plurality of target data sets; a yield-type chest that performs repeated processing in a sequential manner; a reduce-type chest that combines multiple input data into an integrated result; and a split-type chest that divides input data into subsets for application of different processing thereto, in which the chests are represented as visual objects in a field on the user interface of the chest flow configuration GUI processor, and a user interface allows a user to construct the entire dataflow by setting visual flow objects between the plurality of chests on the field

In the API utilization support system of the present invention, the chest flow execution further comprises a partial execution unit including: a selection mechanism for executing only a portion of the plurality of chests included in the dataflow as designated by a user; and a snapshot generator for producing a shot data structure that records input/output states of the designated chests as a snapshot based on the user specification, in which the partial execution unit further comprises a control mechanism arranged to selectively execute the designated portion of the chests by comparing and matching their states with those of other chests based on the shot data structure.

In the API utilization support system of the present invention, the chest flow execution controller further comprises a recalculation unit including: a dependency-based execution engine for performing recalculation and re-execution of related flows in accordance with dependency relationships among a plurality of chests included in the dataflow; a re-editing interface operable in conjunction with the GUI to accept range-designation inputs from the user and to permit modification of configuration content for a selected group of chests; and a consistency verification module for automatically verifying consistency between the re-edited chests and their dependent chests, and for initiating recalculation within the designated range based on the verification result.

In the API utilization support system of the present invention, the chest flow execution controller may include a message helper unit that describes processing logic related to the generation, transformation, formatting, or transmission of API messages in each chest in a common definition format, in which the message helper unit has a structure that can be referenced by multiple chests, allowing the same message processing definitions to be shared and reused across multiple chests.

In the API utilization support system of the present invention, the dataflow construction processor may include a stream display unit that displays summary information related to processing results or states associated with each chest in a stream-format interface that is dynamically updated along a timeline or processing order, in which the user can visually and continuously grasp the summary information of multiple chests on a single screen via the stream display unit, thereby efficiently tracking state changes in the overall processing flow and dynamically monitoring dependency relationships and transitions in processing results among the chests.

In the API utilization support system of the present invention, the chest flow execution controller further includes: a chest initial calculation unit including a processing engine that performs initial computation based on scripts or templates associated with a chest at the time of generating a new chest in the dataflow and produces corresponding properties and tags; and a recalculation unit including an editing interface dependency management module for applying modifications to a user-selected range of chests, updating inter-chest dependencies, and executing reprocessing of the entire or partial dataflow, in which the graphical user interface includes a selection mechanism that permits a user to apply either the chest initial calculation unit or the recalculation unit to a corresponding chest.

In the API utilization support system of the present invention, the chest flow execution controller further includes a message tag unit including a tag management structure that retains message tags that include information added to each message to identify conversion rules or processing conditions when the message is processed between chests, in which the message tag unit serves as a mapping reference during conversion processing between chests, and the message tag is also usable as a flag for classification, priority, execution target designation, or processing mode switching of the message.

In the API utilization support system of the present invention, the chest flow execution controller further includes a dataflow backup unit including a storage module for retaining configuration information of a dataflow constructed by a user in a template format, in which the storage module records the entire dataflow, including chest configurations, connection relationships, message processing definitions, and tag information, as a template structure, and wherein the recorded dataflow template is structured to be applicable to any project and is usable as a reusable component within a corresponding project.

In the API utilization support system of the present invention, the API utilization support system includes a project operation interface unit for visually managing projects and operating chests on a field, in which the project operation interface unit includes: a project management unit interface component for listing, selecting, creating, updating, and deleting of multiple projects and to acquire and display relevant information of a selected project; a chest operation unit including a visual display component for presenting chests and dataflows between them on a field corresponding to a selected project, and an input interface for accepting operations including addition, movement, and connection of chests; an output stream display unit including a list display component for presenting messages or processing result data output from each chest; a chest display unit including control components for managing the display state of each chest and handling user interaction and object representation on the field; a flow display unit including graphical components for visually presenting dataflows between chests using connection lines or similar elements, thereby representing the flow of data; a sequence management unit including interface elements for handling expansion and collapse operations based on logical sequence relationships among groups of chests, and for presenting child chests upon expansion; and a field operation processing unit comprising functional modules for executing processing related to creation, updating, recalculation, and sequence execution of chests and flows in response to operation requests from the interface unit, and for supplying corresponding business logic.

In the API utilization support system of the present invention, the chest flow configuration GUI processor further includes a plurality of function management units configured to provide various system functions in a distributed manner in response to user operations. The function management units includes an account management unit including components for user account registration, authentication, and management of account settings; a file operation unit including an interface for uploading, downloading, and deleting data files; a user support unit comprising display modules for presenting information on system usage and frequently asked questions (FAQs); a message helper management unit including editing tools and display elements for adding, editing, deleting, and managing auxiliary information (message helpers) used in message processing; a notebook management unit comprising modules for creating, editing, executing, and deleting notebooks via a user interface; a project management unit including interface components for listing, creating, deleting, selecting, and updating projects; a template management unit comprising logic for storing and retrieving dataflow templates and performing mutual conversion between templates and projects; an AI model management unit including functional modules for training, registering, and using AI models based on user-provided data; an application state sharing unit comprising structures for managing application-wide state information; a utility frame unit including a shared user interface framework for controlling and presenting pages of various utility functions; and a navigation control unit comprising navigation display components for presenting links to respective pages and showing current page information or contextual usage status, in which wherein the navigation control unit serves as a central access interface, facilitating efficient user access to the various function management units, and wherein the AI model management unit supports construction and in-system use of custom AI models by users.

In the API utilization support system of the present invention, the chest flow execution controller further includes an AI chat collaboration unit that includes components for executing coordination processing with a chat API of an external artificial intelligence (AI) system. The AI chat collaboration unit includes: (a) a message formatting unit including a filtering and transformation module for processing message data generated in a chest, the module applying predefined properties based on conditions such as role, tag, and text content, and converting the message into a format required by the AI system, including a list format of role-content pairs; (b) a chat query generation unit comprising logic for constructing request data for a chat model of the AI system based on the formatted message and transmitting the request to acquire an AI response; (c) a response generation unit including processing components for receiving the AI response, extracting relevant information, applying tagging or format conversion where applicable, generating a final response message, and storing the response in an executor or a state management unit within the system. The AI chat collaboration unit comprises functional structures that support dialog processing with the AI system in response to user input and enable automatic generation and delivery of contextually appropriate responses.

In the API utilization support system of the present invention, the chest flow execution controller further includes an AI model tuning unit for constructing and managing AI models. The AI model tuning unit comprises: (a) a custom model tuning module including processing logic for training and updating a user-defined AI model using a dataset output from the message formatting unit as training data; (b) an embedding model query module including components for executing inference processing based on vector embeddings; (c) a model registration management module including structures for recording the above modules in association with AI model helpers, and for maintaining references to the registered models for use in subsequent chest processing; and (d) a model identification response module including functionality for acquiring identification information of the registered AI models and providing such information to the user to indicate availability status of the AI models. The AI model tuning unit includes mechanisms by which a user may register, reference, and utilize independently constructed or trained AI models within the system.

In the API utilization support system of the present invention, the chest flow execution controller further includes an external search collaboration unit for supporting information acquisition using an external search engine. The external search collaboration unit comprises: (a) a search message extraction module including logic for identifying and extracting keywords or URLs from messages in a chest and for converting the extracted content into a format compatible with an external search API; (b) a search execution module including components for transmitting queries to an external search service, such as Google, based on the extracted keywords or URLs, and for acquiring corresponding search result data; and (c) a search response generation module including functionality for automatically generating a response message based on the acquired search results, storing the response in the executor within the system, and formatting the response into a form suitable for presentation to the client. The external search collaboration unit includes structural components that support real-time acquisition of external information from user input or chest messages and integrate such information into the in-system processing flow for generation of contextually enriched responses.

In the API utilization support system of the present invention, the chest flow execution controller further comprises a standard AI system chat query further includes: (a) a query function controller comprising logic for defining primary processing functions related to the chat query and for controlling the operation of sub-function modules; (b) a message formatter including components for formatting query messages, applying tags, and merging the messages with system-level messages; (c) an AI API communicator including interfaces for transmitting queries to and receiving responses from the API of the external AI system; and (d) a system message manager comprising storage and processing structures for maintaining system message templates used as inputs to the AI model, and for embedding context-sensitive instructions into the templates. The query function controller is implemented as a central coordination unit among the modules, and the respective modules operate in cooperation to process dialog interactions with the external AI system using a configuration that supports extensibility and modular reuse.

### Effect of the Invention

Specifically, in response to the various problems inherent in conventional technologies, a comprehensive solution is provided by introducing a unified and highly extensible architecture, an intuitive UI/UX, and a modular separation design. In the present invention, the API utilization support system is introduced as an intermediate layer so that individual implementations according to the API specifications of each AI service become unnecessary and users can handle multiple services in a cross-sectional manner using simple syntax. By enabling centralized management of authentication, log management, and usage restrictions, the burden of security management is greatly reduced. The system in the present invention adopts a structure that supports integrated management and switching of multiple AI models and is designed so that even non-engineers can operate from data collection to model construction through a GUI-based interface.

Furthermore, by changing the architecture from a monolithic structure to a separated microservices architecture and designing functions such as create functions and chest processing as independent, scalable units, load distribution and function addition are facilitated, thereby enhancing the overall system availability and scalability. The dataflow construction processor, chest flow execution controller, and database are layer-separated, and maintainability is significantly improved through a clearly defined responsibility design for each role. Also, dataflow construction can be completed through operations such as clicking and selecting chests, and LLM context management is made configurable by drag-and-drop operations, thereby greatly improving user operability.

Furthermore, by decoupling message generation from external API processing and reconstructing the message helper as an independent module, processes such as message formatting, template definition, and query generation/correction are made separable and modifiable or extensible on a per-unit basis. The message helper is equipped with a structure that allows plug-in processing logic to be added, embedding of tags and variables, and insertion of hooks before and after API transmission/reception, and is made capable of being scaled as a lightweight module. Also, linkage between dependent chests and stream views is implemented to visualize execution dependencies.

The structure for parallel/sequential processing is centrally designed, allowing users to grasp the entire flow on a single screen and improving debugging efficiency. A mechanism has been introduced that dynamically updates processing results in real-time on the stream, and chest operations have also been reconstructed under a unified flow to allow for reuse through function unification. Chest processing branches can be dynamically redefined, with a structure that enables dynamic optimization of processing content according to changes in external API specifications or output results from dependent chests.

Query processing is implemented as a continuous workflow comprising property generation, message creator, query function, and generator, in which each process is robustly separated while sequentially ensuring data consistency. Conventionally disjointed processes—namely, registration and execution—are unified into a single structure that provides an integrated view from UI operations to execution flow, enabling immediate reflection of registered content, consistency verification, and tag completion as a unified process. Furthermore, the system enables continuous processing from global management of tag identifiers to conversion and reverse conversion of local values, thereby allowing automatic bidirectional mapping of data.

User interactions are configured such that selections or modifications in the user interface are immediately reflected in the data model, thereby improving operability and recoverability from erroneous operations. By simply clicking on a blank area of the screen, a user can seamlessly invoke a message helper editing editor and proceed directly to property editing of related queries, thereby reducing the overall construction time. Furthermore, flexible branching design is introduced in which loop-type processing such as map or yield is integrated into a single flow and can be coordinated with partial execution mode or recalculation-waiting processing.

In the present invention, the message data structure is standardized, and comprehensive management is performed, including container management of text and file carriers, data type validation, and history tracking, thereby achieving secure and efficient integration of external API collaboration and AI response processing. By unifying message data, property data, and function processing information, and by adopting a design that allows centralized management and visualization of structured and unstructured data, tag and asset management, and types of extracted data, maintainability and extensibility are significantly improved.

Various query functions, including REST-API processing, notebook execution, embedding-based search, and web scraping, are integrated into a unified structure, thereby enabling centralized management of configuration, development, and input/output consistency. A response extraction logic is implemented as a plugin-type extraction engine that incorporates twelve types of extraction conditions, such as isCodeExtract and isJSONExtract, ensuring both maintainability and extensibility. Furthermore, a matching mechanism between argument definitions and notebook structures is implemented, allowing appropriate linking of properties and arguments to either a notebook or an API, based on AI-generated texts or data. In the overall flow, messages are constructed in a sequential manner by merging properties, function outputs, tags, and arguments, and the generation of last messages or function results is managed as a consistent workflow.

### BRIEF DESCRIPTION OF THE DRAWINGS

FIG. 1 is a block diagram illustrating an overview of an embodiment of the API utilization support system according to the present invention.

FIG. 2 is a block diagram illustrating an example of the embodiment, in which the API utilization support system shown in FIG. 1 is applied to a plurality of external AI services and operates in cooperation therewith.

FIG. 3 is a block diagram illustrating the configuration of the API utilization support system shown in FIG. 2.

FIG. 4 is a block diagram illustrating the configuration and functions of the chest flow configuration GUI processor in the API utilization support system shown in FIG. 3.

FIG. 5 is a block diagram illustrating the configuration of the chest flow execution controller in the API utilization support system shown in FIG. 3.

FIG. 6 is a diagram illustrating the configuration of a chest management screen in the chest flow execution controller shown in FIG. 5.

FIG. 7A is a flowchart illustrating the operation flow when a chest tab is selected on the chest screen shown in FIG. 6.

FIG. 7B is a flowchart illustrating the processing when a chest body is selected on the chest management screen shown in FIG. 6.

FIG. 7C is a flowchart illustrating the processing when a region tab is selected on the chest management screen shown in FIG. 6.

FIG. 8 is a block diagram illustrating a configuration of a message helper and message processing according to the present embodiment.

FIG. 9 is a block diagram illustrating the structure of function data and a flowchart illustrating a message list editing process according to the present embodiment.

FIG. 10 is a flowchart illustrating processes at the time of registration and execution of the message helper and the chest according to the present embodiment.

FIG. 11 is a flowchart illustrating a flow generation process and a message tag editing process according to the present embodiment.

FIG. 12 is a flowchart illustrating a target chest processing operation according to the present embodiment.

FIG. 13 is a block diagram illustrating transitions in data retention formats of a chest according to the present embodiment.

FIG. 14A is a flowchart for explaining selection of a field according to the present embodiment.

FIG. 14B is a flowchart for explaining selection of a field according to the present embodiment.

FIG. 15 is a flowchart illustrating sequence registration according to the present embodiment.

FIG. 16A is a flowchart illustrating chest registration according to the present embodiment.

FIG. 16B is a flowchart illustrating chest execution according to the present embodiment.

FIG. 17 is a flowchart illustrating chest recalculation according to the present embodiment.

FIG. 18 is a block diagram illustrating message data and message formatting according to the present embodiment.

FIG. 19 is a block diagram illustrating the configuration of function processing information, messages, and properties according to the present embodiment.

FIG. 20A is a block diagram of a REST API-type query function of the present embodiment.

FIG. 20B is a block diagram illustrating an example of a REST API query according to the present embodiment.

FIG. 21A is a block diagram illustrating message preprocessing according to the present embodiment.

FIG. 21B is a block diagram illustrating API output processing according to the present embodiment.

FIG. 21C is a block diagram illustrating common properties for message processing according to the present embodiment.

FIG. 21D is a block diagram illustrating a data extraction process from AI-generated text according to the present embodiment.

FIG. 21E is a block diagram illustrating a process of extracting text information from a file according to the present embodiment.

FIG. 22A is a block diagram illustrating a query processing flow that utilizes a message helper list in a yield process according to the present embodiment.

FIG. 22B is a flowchart illustrating system query processing according to the present embodiment.

FIG. 22C is a flowchart illustrating roles related to system query processing according to the present embodiment.

FIG. 23A is a block diagram illustrating functions related to LLM query processing according to the present embodiment.

FIG. 23B is a block diagram illustrating an example implementation of LLM query processing according to the present embodiment.

FIG. 23C is a block diagram illustrating functions related to data query processing according to the present embodiment.

FIG. 23D is a block diagram illustrating functional aspects of an example of data query processing according to the present embodiment.

FIG. 24 is a flowchart illustrating conversion processing of LLM output sentences according to the present embodiment.

FIG. 25 is a block diagram illustrating functions related to file information message conversion processing according to the present embodiment.

FIG. 26 is a block diagram illustrating functions related to argument processing according to the present embodiment.

### MODE FOR CARRYING OUT THE INVENTION

In the following, the present invention will be described, and in this specification, when referring to a “unit,” it refers to a state in which a computer's Central Processing Unit (CPU) or Graphics Processing Unit (GPU) reads a computer program and functions, and since the CPU and GPU are chips composed of integrated circuits, these units are components of a product invention, and therefore the present invention is a product invention. In this sense, the term “function” used in this specification can appropriately be interpreted as “unit.” Moreover, the present invention utilizes a Graphical User Interface (GUI) to visually present objects to the user and encourage user selection and operation, making complex processing performed by an Artificial Intelligence (AI) model understandable to the user, thereby organizing and supporting the user's thinking, and thus differs significantly from merely letting machines do what humans can think of. Also, in this specification, the term “database unit” refers to a unit in which individual information is stored in association with other information and can be extracted and utilized based on such associations, that is, a data structure having the properties of a collection of multiple tables. The AI system utilization support system of the present invention comprises multiple units (components) that operate in coordination, each of which is provided between the AI system's API and the user, and the multiple units operate in coordination via a computer network, and due to the nature of AI systems, services are provided to users via the Internet.

### [Overall Configuration]

The present application programming interface (API) utilization support system is a platform that enables users to visually construct dataflows and perform data processing and utilization of artificial intelligence (AI) models. This API utilization support system is implemented on a computer system that has a plurality of processors and memory and is designed to operate in conjunction with an API of an external AI system for supporting complex data processing. The API utilization support system mainly has a chest flow configuration graphical user interface (GUI) processor, a database unit, and a chest flow execution controller. The chest flow configuration GUI processor includes a GUI rendered on a display and interface elements arranged to enable visual creation, connection, and selection of a plurality of data processing nodes (chests) on a canvas, to generate a flow structure defining a data flow between the chests, and to allow definition of processing order and dependencies for each of the chests. The database unit includes a plurality of tables including at least account information, project information, chest detail information, connection relationship information among chests, message processing support helper information, AI model information, uploaded data file information, script data, and data flow identification information. The chest flow execution controller operatively connected to the chest flow configuration GUI processor and the database unit, which comprises circuitry and logic components to respond to sequential operation requests from the GUI by performing data exchange with the database unit, managing generation, deletion, placement, and updating of chests, controlling data flows and dependencies among chests, supporting graphical selection of execution of processing steps associated with the chests, constructing and transmitting messages to the API of the external AI system, receiving corresponding responses, and processing the responses in relation to the associated chests. The chest flow configuration GUI processor, the database unit, and the chest flow execution controller are network-connected components structured to make collaborative operation resulting in construction and execution of complex processing flows that involve interactions with the external AI system and are defined by visual and sequential user inputs.

The chest flow configuration GUI processor will now be described. The chest flow configuration GUI processor provides a user interface that enables a user to intuitively construct a dataflow and to place and connect data processing nodes (referred to as chests). The chest flow configuration GUI processor further includes functions for performing login/logout and managing account information, as well as functions for user authentication and account management. In addition, it includes functions for creating, editing, and deleting projects and for managing dataflows within each project. Moreover, it is equipped with functions for placing chests via drag-and-drop operations, setting flows (i.e., data paths) between chests (placement and connection of chests), and viewing data and displaying results in a stream format (data visualization). In addition, it includes file upload/download functions that allow users to upload data files and make them available for use within chests, as well as functions for creating, editing, and deleting AI model helpers.

The database defines tables for managing the main data of the application, thereby enabling data persistence and efficient access. The main tables include: (1) users: manages user account information (username, password, storage limits, etc.); (2) projects: manages information of projects created by users (name, notes, tags, chest limits, etc.); (3) unified_chests: manages detailed information of chests (title, position, type, query, response, etc.); (4) chest_flows: manages flows (data streams) between chests and associates source and target chests; (5) message_helpers: manages information of helpers supporting message processing; (6) ai_model_helpers: manages information about AI models (model name, properties, owner, etc.); (7) files: manages information of uploaded files (filename, path, tags, etc.); and (8) notebooks: manages notebook execution data and identification tags.

The chest flow execution controller will now be described. The chest flow execution controller processes requests from the chest flow configuration GUI processor, implements interactions with the database and business logic, and serves as a core component of the present invention. Specifically, it performs secure user management and session maintenance (user authentication and session management), manages information such as users, projects, chests, and files within the database (database operations), and implements business logic for creating, updating, and deleting chests, as well as controlling dataflows. Furthermore, it includes a message processing function that utilizes message helpers to generate and transform messages, and a file storage linkage function for saving, retrieving, and managing files.

Hereinafter, the preferred embodiment of the present invention will be described in detail with reference to the accompanying drawings. Such embodiments are merely illustrative for facilitating understanding of the invention, and unless otherwise specified, do not limit the present invention. In the specification and drawings, elements having substantially the same functions and configurations are assigned the same reference numerals, and redundant descriptions are omitted, and elements not directly related to the present invention are also omitted from the drawings.

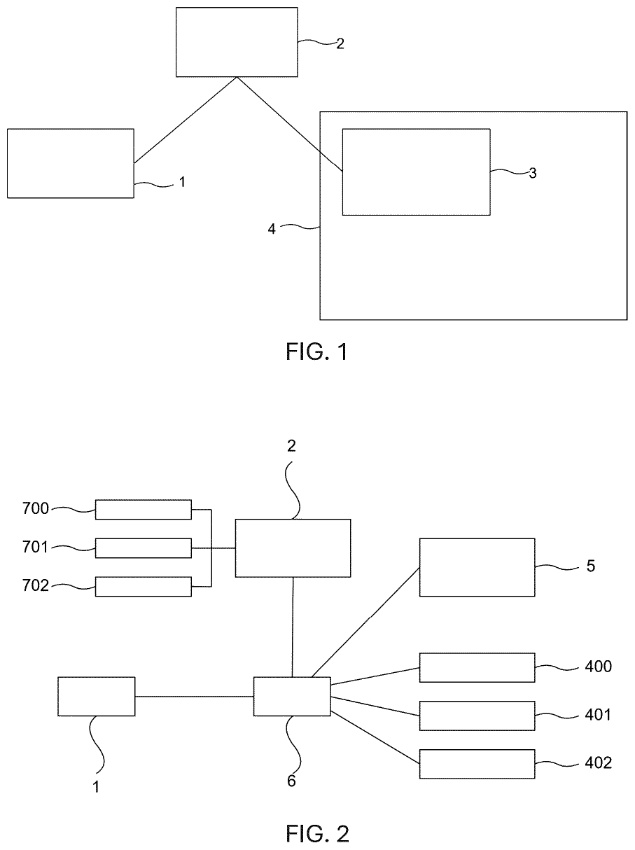

FIG. 1 is a block diagram illustrating an overview of an API utilization support system 2 according to an embodiment of the present invention. In FIG. 1, a user 1 refers to a user terminal device, which may include a personal computer, tablet device, smartphone, or the like. The API utilization support system 2 is a system according to the present invention, positioned between the user 1 and an external AI service 4, and supports the use of an API 3 provided by the external AI service 4. The external AI service 4 may include generative AI services such as ChatGPT provided by OpenAI, as well as other types of external AI services. The API utilization support system 2 is preferably implemented mainly on a server computer accessible via the Internet, but a portion of the system may also be implemented as an application on the user terminal device of the user 1.

In this specification, while assuming that the API utilization support system 2 may be implemented in a distributed manner between the server side and the user side, which functions are assigned to the server and which are to the terminal side is regarded as a design choice, and no particular limitation is imposed. Accordingly, in this specification, the server-side functions and user-side applications are described as cooperating with each other to collectively constitute the API utilization support system 2.

FIG. 2 is a block diagram illustrating an example of the embodiment, in which the API utilization support system shown in FIG. 1 is applied to a plurality of external AI services and operates in cooperation therewith. In FIG. 2, a configuration is shown in which the user 1 uses a plurality of external AI services 400, 401, 402 and an external search server 5 via the Internet 6. The user 1 can utilize the API utilization support system 2 of the present invention to visually construct customized external API utilization models 700, 701, and 702 suited to each user's objectives and needs through a series of processes such as data collection, learning, and evaluation. These customized API utilization models may be referred to simply as “models” in this specification.

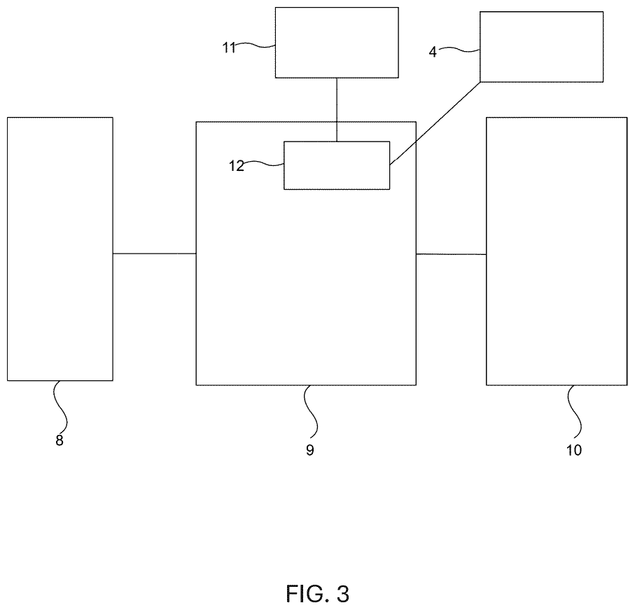

FIG. 3 is a block diagram illustrating the configuration of the API utilization support system 2 shown in FIG. 2. In FIG. 3, the API utilization support system 2 mainly comprises the following three elements: (1) chest flow configuration GUI processor 8 (hereinafter, simply “chest flow configuration GUI processor 8”), (2) chest flow execution controller 9 (hereinafter, simply “chest flow execution controller 9”), and (3) database 10. The chest flow configuration GUI processor 8 is responsible for the user interface part of the system and provides login/logout functionality and account management functions. In addition, when users create or edit projects and construct dataflows, it also provides functions for visually manipulating and managing data processing nodes called “chests.”

On the other hand, the chest flow execution controller 9 processes various requests from the chest flow configuration GUI processor 8 and cooperates with the database 10 to centrally manage various types of information, such as user information, project information, chests, and files. The chest flow execution controller 9 can dynamically control the dataflow through operations such as creation, update, deletion, and arrangement of chests. In addition, server-side calculations such as computational processing can be executed using embedded microservices 11. Furthermore, by utilizing the query function 12, the chest flow execution controller 9 can cooperate with external large language model APIs (LLM APIs) and web query APIs. This cooperation is realized, for example, through external AI services 4 such as the ChatGPT API provided by OpenAI or the Claude API provided by Anthropic.

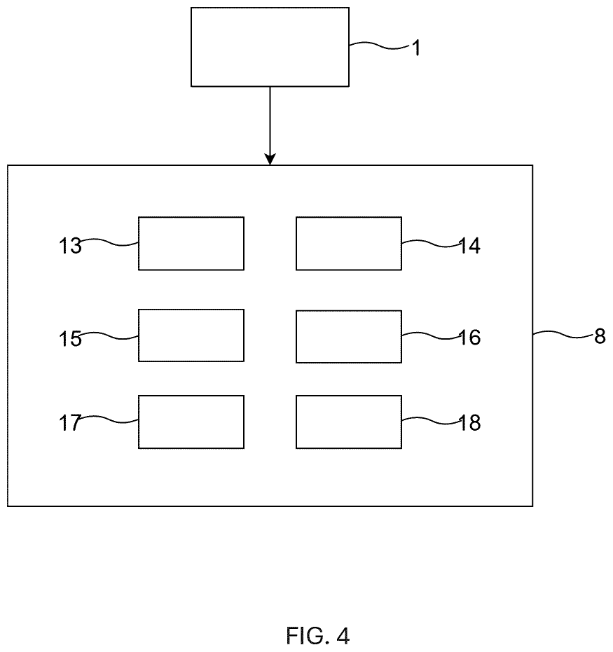

FIG. 4 is a block diagram illustrating the configuration and functions of the chest flow configuration GUI processor 8 in the API utilization support system 2 shown in FIG. 3. In FIG. 4, the chest flow configuration GUI processor 8 mainly provides the user interface (UI) to the user 1 and is responsible for visual representation of the dataflow. The chest flow configuration GUI processor 8 comprises: (1) user information management function 13, (2) dataflow management function 14, (3) chest management function 15, (4) data display function 16, (5) data upload/download function 17, and (6) AI model management function 18. The user information management function 13 manages login/logout and account information based on information from the user terminal 1. The dataflow management function 14 manages the dataflow within a project and controls the selection status of existing chests. The chest management function 15 enables intuitive operations such as creation, arrangement, and editing of data processing nodes called “chests” through drag-and-drop, and allows for visual setting of flows between chests. The data display function 16 allows for viewing data in a stream format and displaying processing results. The upload/download function 17 allows users to upload or download data files and use them within chests. The AI model management function 18 allows for creation, editing, and deletion of AI models via the chest flow configuration GUI processor, supporting user control of models.

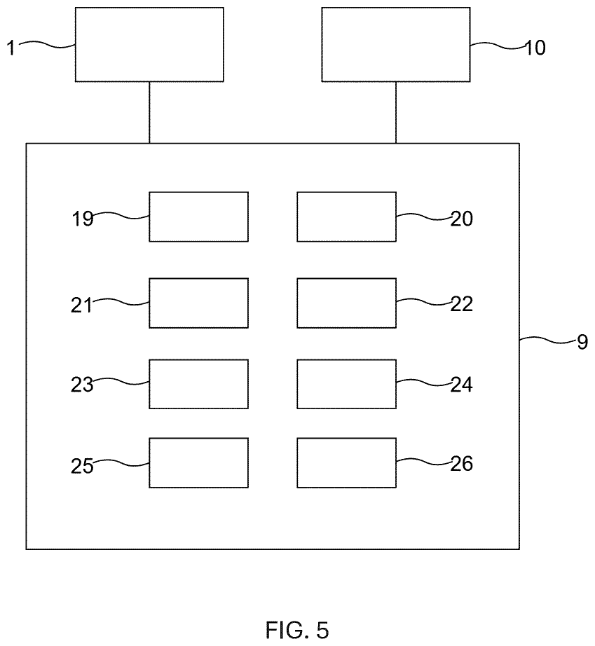

FIG. 5 is a block diagram illustrating the configuration of the chest flow execution controller 9 in the API utilization support system shown in FIG. 3. In FIG. 5, the chest flow execution controller 9 is a core component that receives and processes requests from the chest flow configuration GUI processor 8 shown in FIG. 4 and implements business logic through cooperation with the database (not shown).

The chest flow execution controller 9 includes the following main functions: (1) user management function 19, which manages user information such as login status, authority information, and account settings; and (2) session maintenance function 20, which maintains and controls user login sessions and ensures continuity of the dataflow. With these functions, the chest flow execution controller 9 can flexibly and continuously manage dataflows for each user.

Furthermore, the chest flow execution controller 9 includes the following three functions: (1) business logic implementation function 22, which is the core function for realizing operations such as creation, update, arrangement, and deletion of chests (described later), and control and manipulation of dataflows, and which operates through the database cooperation function 21; (2) message processing function 24, which utilizes the message helper 23 to generate or modify messages from dependent chests and to transmit queries to external APIs; and (3) file storage cooperation function 26, which cooperates with file storage 25 to manage saving, retrieval, and deletion of data files. Through these functions, the chest flow execution controller 9 plays a role in comprehensively supporting inter-chest processing, communication with external APIs, and file management.

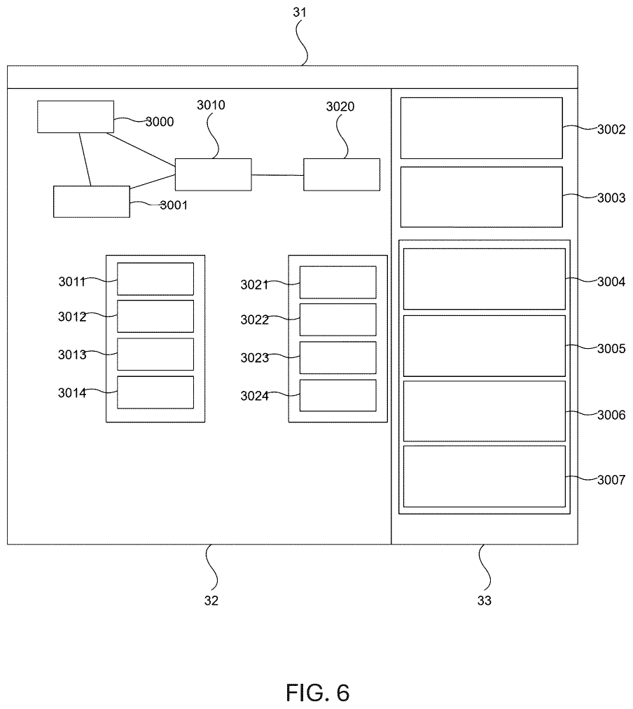

FIG. 6 is a block diagram illustrating the configuration of the chest management screen in the chest flow execution controller 9 shown in FIG. 5. In FIG. 6, an example configuration of a chest 30 visually displayed on the main screen 31 on the user terminal is shown. The main screen 31 is broadly divided into a field section 32 and a stream section 33. In the field section 32, a first chest 3000, visually formed, is displayed as an object and is in an operable state on the field. When the first chest 3000 is executed, the second chest 3001 or the third chest 3002 is deployed in response. Furthermore, when the second chest 3001 is opened after the execution of the first chest 3000, the first chest 3000 and the second chest 3001 are grouped and deployed as a first sequence block 3010 (yield type or split type). The first sequence block 3010 internally generates child chests 3011, 3012, 3013, and 3014 in a stored format. Also, when a map-type second sequence block 3020 is deployed using the first sequence block 3010 as a group (base), child chests 3021, 3022, 3023, and 3024 are similarly generated and stored within it.

On the screen of the stream section 33, when the user selects the group consisting of the first chest 3000, the second chest 3001, and the second sequence block 3020, the corresponding information is displayed as stream chests. In the first stream chest 3002, information of the first chest 3000 is displayed, and in the second stream chest 3003, information of the second chest 3001 is displayed. Furthermore, in the third through sixth stream chests (3004 to 3007), information of the child chests 3021, 3022, 3023, and 3024 is displayed sequentially. As a result, the configuration of chests in the field section and the flow of data and processing content in the stream section can be visually and intuitively grasped.

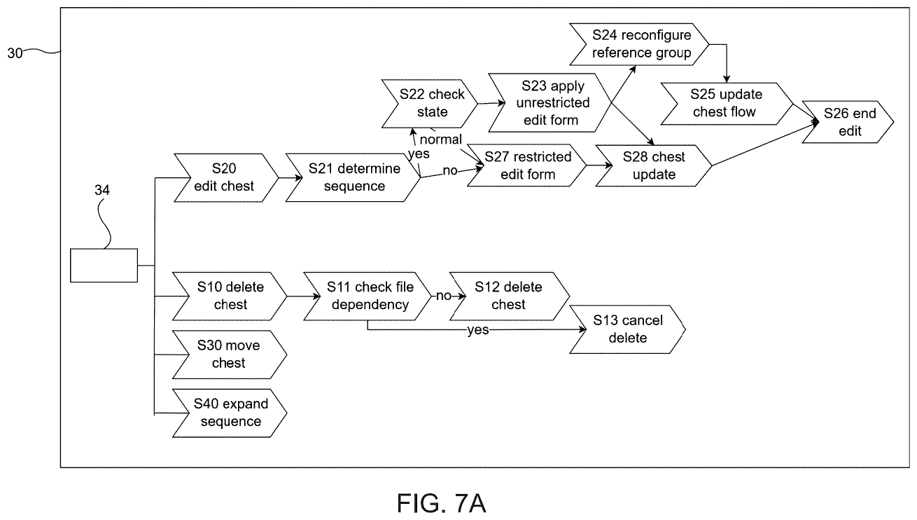

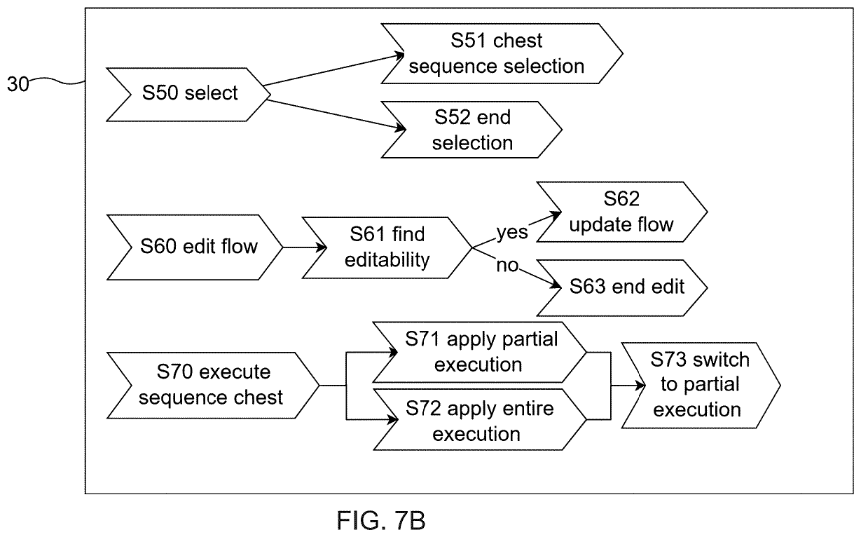

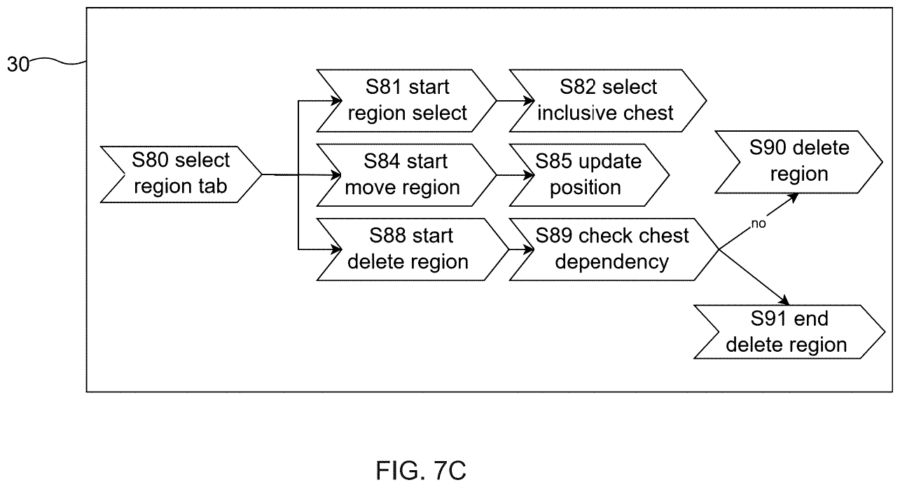

FIG. 7A is a flowchart showing the operation flow when the chest tab 34 is selected on the chest screen shown in FIG. 6. In FIG. 7A, operation functions common to all chests 30 are described. By invoking the tab menu of the chest tab 34, various functions can be selected by the user.

When “Delete Chest” is selected in the tab menu (S10), the following processing is executed: (1) the system checks for the existence of dependent files for the corresponding chest (S11); (2) if it is determined that no dependent files exist, the deletion of the chest is executed (S12); (3) on the other hand, if dependent files exist, the deletion process is canceled (S13).

When “Edit Chest” is selected in the tab menu (S20), the following processing is executed: (1) the selected chest is judged whether it is a sequence (S21); (2) if determined to be a sequence, the state (whether recalculation mode or not) is judged (S22); (3) if the state is non-recalculation mode (normal), an unrestricted edit form is applied (S23); (4) if the chest was generated as an automatic sequence chest item, the group of references is reconfigured (S24), and the chest flow is updated (S25), after which the editing is completed (S26); (5) if it is not automatically generated, the process directly proceeds to chest update processing from the unrestricted form (S28), and editing is completed (S26); and (6) if determined not to be a sequence or not in a normal state, a restricted edit form is applied (S27), and after proceeding to the chest update processing (S28), editing is completed (S26).

When “Move Chest” is selected in the tab menu (S30), drag-and-drop (DD) mode is activated, and when the user moves the chest, a position change process is executed.

When “Expand Sequence” is selected in the tab menu (S40), the corresponding sequence is expanded, and then the positions of the included chests are adjusted.

FIG. 7B is a flowchart showing processing when the chest body is selected on the chest management screen shown in FIG. 6. In FIG. 7B, when the chest body, which is the main part of each chest, is selected by the user (S50), the system determines whether it is a “chest selection” or a “sequence selection” depending on the chest type. If this selection process is not yet conducted, then the chest selection of sequence is conducted (S51). If there is an intervening step, then the process goes on to the next stage. If it is already in a selected state, chest selection cancellation or sequence selection cancellation is executed (S52).

When a flow line connecting multiple chests is selected, the system treats this as flow editing (S60). At this time, the user can register or edit condition keywords, and then a determination is made as to whether editing is possible (S61). If editing is determined to be possible, flow update processing is executed (S62); if editing is determined to be impossible, the editing process is canceled (S63).

Further, when the user selects the sequence chest execution process (S70), partial execution designation for individual child chests (S71) or batch execution processing for the entire sequence chest is performed (S72), and then the process transitions to the partial execution process in accordance with the designation (S73).

FIG. 7C is a flowchart illustrating the process when the region tab is selected on the chest management screen shown in FIG. 6. In FIG. 7C, when the user selects the region tab (S80), and the region selection is subsequently executed, the system transitions into a region selection mode (S81). In this mode, the user selects an inclusive chest (S82). When region movement is selected thereafter (S84), position updating of the corresponding region is executed through drag-and-drop operation (S85), and simultaneously, the position of the inclusive chest is also updated. If region deletion is selected (S88), the system determines whether dependent chests exist in the target region (S89). If it is determined that there are no dependent chests, region deletion is executed (S90); on the other hand, if there are dependent chests, the deletion process is canceled (S91). FIG. 7A to FIG. 7C systematically illustrate flow processes common to all chests on the chest management screen shown in FIG. 6, specifically for operations such as deletion, editing, movement, sequence expansion, and region manipulation.

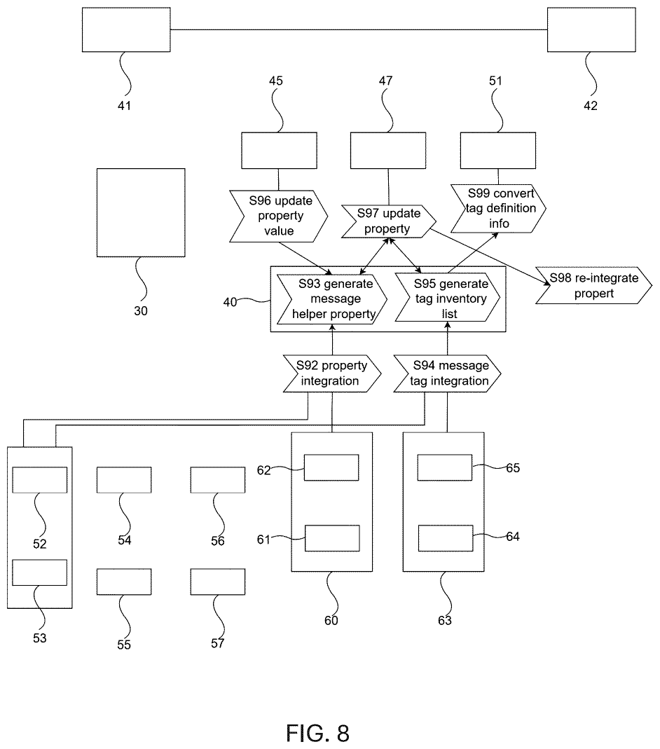

FIG. 8 is a block diagram showing the configuration of the message helper and message processing according to the present embodiment. This figure explains the flow of property processing and message tag processing in flow generation processing executed at the time of generating a target chest from generation and update processing on the source chest side during chest generation/update. In FIG. 8, the chest 30 indicates the source chest, and the processing configuration on the chest side is illustrated as a flowchart. Here, indexes 52 and 53 are indexes for identifying function data defined in the message helper within the chest 30. Conditions 54 and 55 indicate the conditions for executing each function, and functions 56 and 57 represent function call descriptions to execute respective processing. Also, in the property box 60, property definitions for each function (properties 61 and 62) are stored, and in the message tag list unit 63, message tag lists 64 and 65 associated with each function are stored.

The properties within the property unit 60 in FIG. 8 are integrated by a property integration unit with identifiers (S92), and as a result, message helper properties corresponding to the message helper 40 are generated (S93). Meanwhile, the message tag list 63 is integrated through message tag integration processing (S94), resulting in the generation of a tag inventory list (S95).

Also, the chest editing 45 updates the property values of the chest (S96). Similarly, message helper editing processing 47 executes updating of the message helper properties (S97), and if necessary, re-integration of properties is performed (S98). Through these update processes, the message helper property and tag inventory list are each updated to the latest state. Thereafter, message tag information stored in the tag inventory list is converted into tag definition information (S99) for flow by the edit form generation processing 50 and becomes editable by the user in edit 51. However, such editing is allowed only in recalculation mode, and in normal mode, the value updated in the chest is automatically transferred to the target as a message tag value.

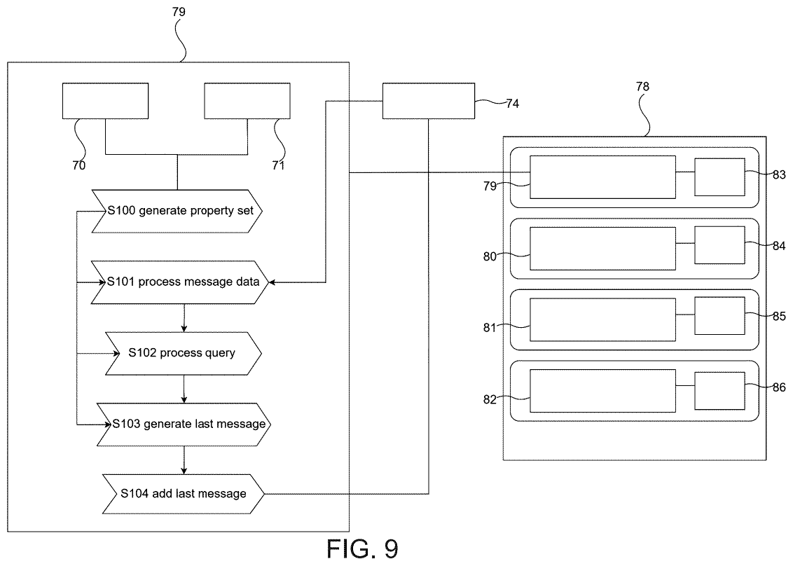

FIG. 9 is a flowchart relating to the structure of function data and the message list editing process according to the present embodiment. This figure illustrates the configuration of function data 79 included in the function data list 78, and the sequence of processing from generation of a property set to appending to the message list 74.

First, the storage method and processing sequence of function data 79 in the function data list 78 are described below.
(1) Each function generates a property set by integrating unique function information 70 with context information of the property implementation unit 71 provided by an executor or the like (S100).
(2) Thereafter, a message creator integrates the generated property set, processing result information up to that point, and processing result information of the preceding chest, and converts it into data that can be transformed into the format of a message list 74 (S101).
(3) Then, a query function uses this data in message list format to execute API query processing for a large language model (LLM), web query, microservice, etc. (S102). The result of this process is received by a generator, processed into message data, and a last message is generated (S103).
(4) This last message is appended to the message list 74, thus passed on to the next processing step (S104).

In the function data list 78, multiple function data 79, 80, 81, and 82 are stored in a sequence format, and corresponding execution conditions 83, 84, 85, and 86 are defined for each. Execution of each function data is determined based on whether the conditions are met using the message information and property information of each, and only the steps satisfying the conditions are executed in sequence.

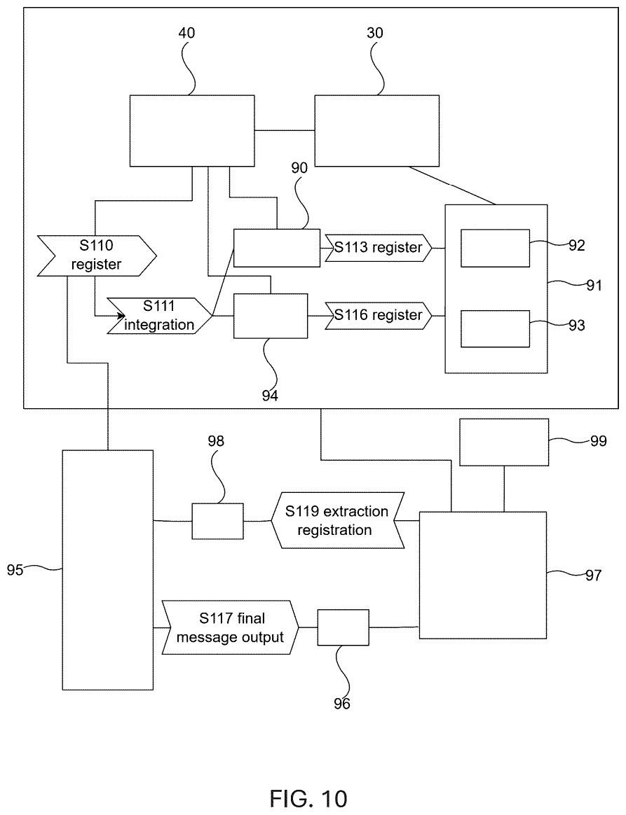

FIG. 10 is a flowchart illustrating the processes at the time of registration and execution of the message helper 40 and chest 30 according to the present embodiment. First, the message helper 40 registers the function data list (S110). Properties included in the registered function data list are integrated via identifier globalization processing (S111) and generated/registered as message helper properties 90. When the message helper is selected, related chest definitions are imported, and after being edited via chest edit form 91, the updated content is registered (S113) as message helper property 92. Similarly, message tags are integrated by identifier globalization processing and generated/registered as tag inventory 94. Likewise, tag definitions are imported upon message helper selection, and the tag information updated via the chest edit form 91 is registered (S116) as tag inventory 93.

The lower section of FIG. 10 illustrates the process flow at chest execution. At execution, property and message tag information sent to execution unit 97 is extracted and registered in function result 98 (S119). This extracted data is sent for function processing and registered as function data list 95 as processing results. Upon completion of processing, a last message is generated (S117), and this last message 96 is registered in executor 97. The registered message is finally added to message list 99 and passed on to subsequent processing.

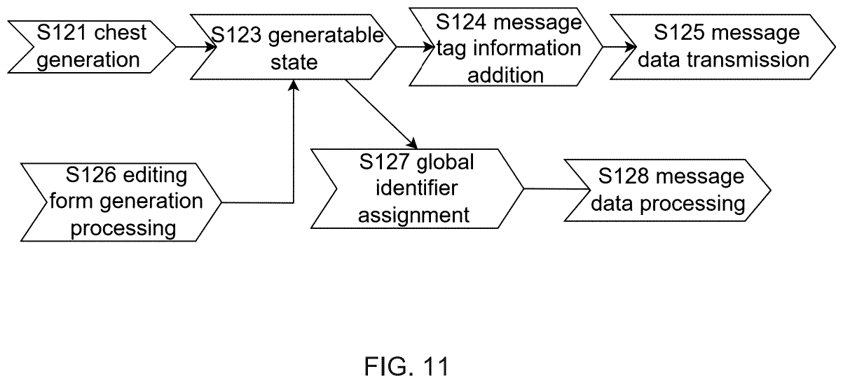

FIG. 11 is a flowchart relating to flow generation and message tag editing processing according to the present embodiment. In FIG. 11, chest generation is first executed (S121). As a result, a preprocessing flow for the source chest is generated, and it subsequently transitions to an editable state (S123). In this editable state, tag definition form information generated by tag definition form generation processing is passed to the message tag (S126). In normal mode, this information is passed as-is with default values to the next step, but in recalculation mode, tag editing is allowed at the generation stage, and the process proceeds with the edited state reflected at the time of recalculation execution. If editing has occurred, the information is added to the source execution information as tag information (S124), and then converted to message data and transmitted to the target chest (S125). The converted data is structured in a message tag: identifier map format and assigned a global identifier (S127). This message data is then passed to the next processing step, i.e., message data processing (S128).

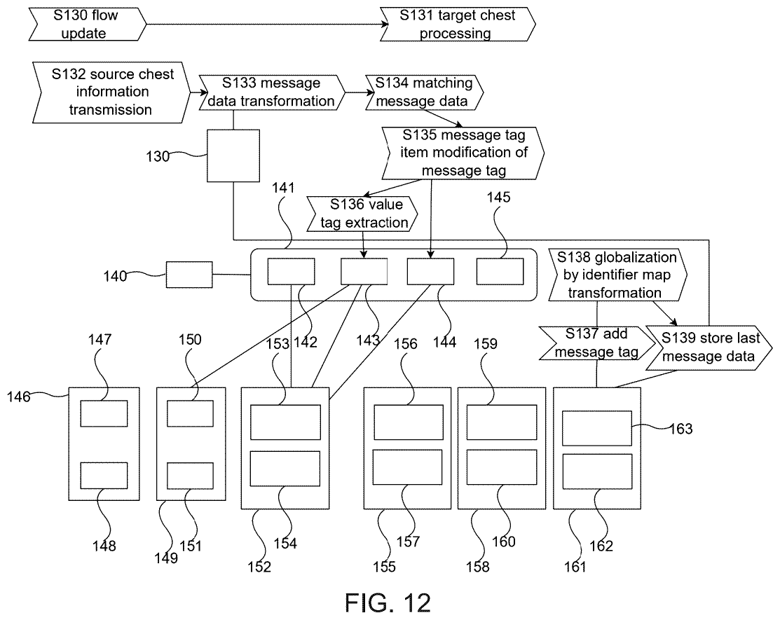

FIG. 12 is a flowchart illustrating the target chest processing according to the present embodiment. This figure explains the flow from flow update processing (S130) to target chest processing (S131). In the figure, target chest 141 consists of the following five types of information: (1) index information 146 (e.g., first index 147, second index 148); (2) execution conditions 149 (e.g., first execution condition 150, second execution condition 151); (3) function definition information 152 (e.g., first function definition 153, second function definition 154); (4) property definition information 155 (e.g., first property definition 156, second property definition 157); and (5) message tag definition information 158 (e.g., first message tag definition 159, second message tag definition 160). As a result of processing based on these definitions, message data 161 is generated and output as first execution result 162 and second execution result 163. This message data 161 is supplemented with the necessary message tags (S137), subjected to identifier map conversion and expanded as a global identifier (S138), and ultimately integrated as last message data and stored in the target chest 130 (S139).

Function list processing is executed via chest execution unit 141 generated by generation execution unit 140. This chest execution unit 141 includes as components: (1) property sequence message tag items 142 and (2) value tag list 143 defined through property processing, (3) message list sequence data 144 as message-related data, and (4) response list sequence message data 145 as function execution results.

The flow of message data generation processing is explained as follows. First, source chest information with message tags is transmitted in a message data tag identifier map format (S132). This is converted into message data format (S133) and structured as compatible message data (S134). Among this, message tags with global identifiers are compared with the predefined tag definition information 158 and converted into message tag items based on the tag definitions. The converted information is stored in a localized form in message list sequence message data 144 (S135). Additionally, tag elements that do not modify messages but are treated as variables in function definition information 152 are separated through value tag extraction processing (S136) and stored in value tag list 143.

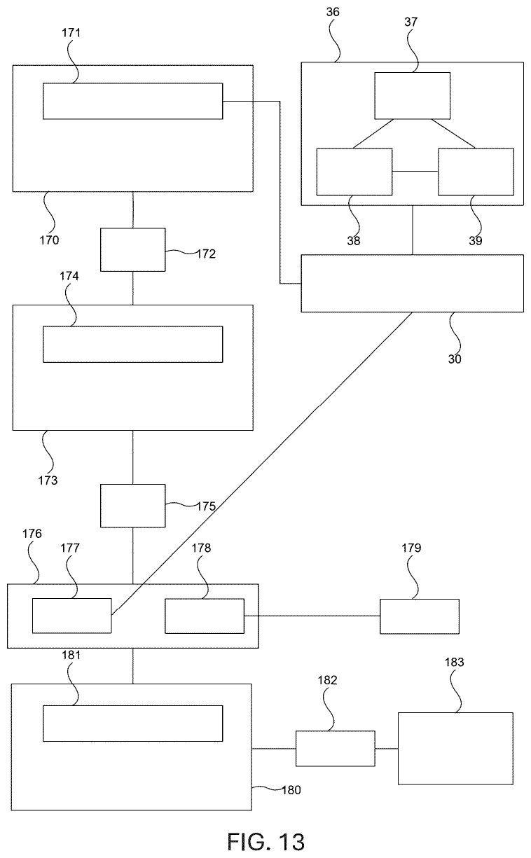

FIG. 13 is a block chart showing transitions of data retention forms of chests according to the present embodiment. In this figure, when the chest 30 is selected, the type information box 36 in chest group 170 is sequentially replaced. By repeatedly selecting chest 30, the non-selected state 37 changes to selected state 38, selected state 38 to base selected state 39, and clicking again returns it to non-selected state 37. This selection operation is immediately reflected in the data of chest group 170, and the type information is updated. When it becomes non-selected state 37, the previous data is discarded.

The data model 171 of chest group 170 retains the selection state of chest 30 and the sequence information of messages. The index information at this time is automatically updated based on the operation order, but it can also be manually corrected as a property. In a certain project, the group information in the selected state 38 corresponds to chest group 170. Here, when chest generation 172 is selected, a chest flow 173 is formed using the selected chest as the source and the newly generated chest as the target. At this time, the correlation between groups is recorded as a persistent correlation definition object. Chest flow data model 174 that retains this correlation information includes, in addition to the basic information of the group, the information of the source chest and the target chest. Furthermore, when chest execution 175 is selected, message generation logic 176 is activated, the last message information 177 of the source chest is obtained, and by adding tag information and the like, it is converted into message data 181. On the other hand, in the map operation, a map-type chest is used as the primary reference for the generated chest. In that case, it is determined whether or not to use the base-type chest as a message for each target sequence child chest, and an extraction operation 178 is performed. Subsequently, sequence processing 179 is executed, and individual reference source chest information is provided to each child chest. The message data 181 generated in this way in the message data array 180 is aligned in sequence based on the index information and becomes a message data array. This array is accumulated as history message 182 and utilized in execution processing in target chest 183.

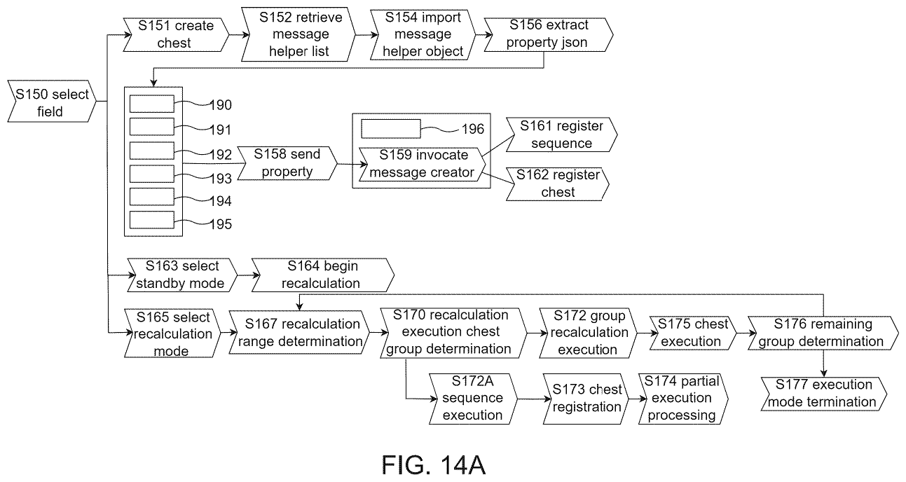

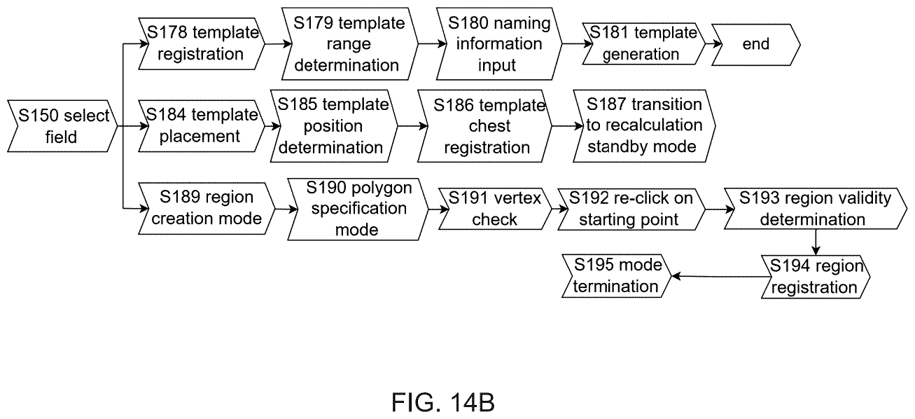

FIG. 14 is a flowchart for explaining field selection operation according to the present embodiment. In FIG. 14A, field selection begins by clicking on a blank field (S150), upon which a field menu is displayed, enabling field selection operation. When new chest creation is first selected (S151), a message helper list is retrieved from the chest flow execution controller (S152), and a message helper selection menu is displayed. Here, a message helper object is imported (S154), and when an arbitrary helper is selected, property JSON extraction is performed (S156), and the query editor is activated. In this editor, the following items can be edited: (1) position information 190, (2) properties 191, (3) query 192, (4) query file 193, (5) auto sequence chest item generation 194, and (6) yieldTestNum 195. The edited information is sent as property transmission to the chest flow execution controller (S158), followed by invocation of a message creator (S159), where history messages are retrieved from chest group information 196 and integrated with the transmitted properties to generate a message to be sent to the LLM. Then, it is determined whether the chest type is a sequence; if it is, the process transitions to sequence registration (S161), otherwise to chest registration (S162).

When recalculation standby mode is selected (S163), the system enters recalculation standby mode, and initial processing begins (S164). Afterward, when recalculation execution is selected (S165), the recalculation range is determined based on range selection information from the standby chest group 197 or the remaining group information after the previous standby group processing, and the standby group is confirmed (S167). Then, management processing related to recalculation such as dependency analysis is performed, the target chest group for recalculation is confirmed (S170), and the target chest group is extracted. Group recalculation execution is performed for these targets (S172). If sequence execution is performed at this time (S172A), sequence belonging and chest registration are executed (S173), partial execution processing is applied (S174), and the chest is executed (S175). Meanwhile, for a single chest with reduce specified, execution proceeds as is. After recalculation, when group recalculation is completed, remaining group determination is performed (S176). If there are remaining groups, the process returns to S167 again; if none, execution mode ends (S177).

In FIG. 14B, if template registration (recalculation mode) is selected (S178), the template range is determined based on the group information at that time (S179). After naming information is entered from the form (S180), the template is generated (S181), registered (S182), and the template registration process is completed. When template placement is selected next (S184), template location is confirmed through screen click operation, etc. (S185), the template is deployed there, and the template chest is registered (S186). The system then transitions to recalculation standby mode (S187), entering the recalculation standby mode state (S188).

When region creation mode is selected (S189), the system switches to polygon specification mode on the field (S190), and the cursor event configuration is changed to enable vertex checking (S191). When the starting point is re-clicked and the polygon is closed (S192), the range is confirmed, and region eligibility judgment is made for each chest (S193). Chests judged to be within the region are registered as regions (S194), and finally, the mode ends (S195).

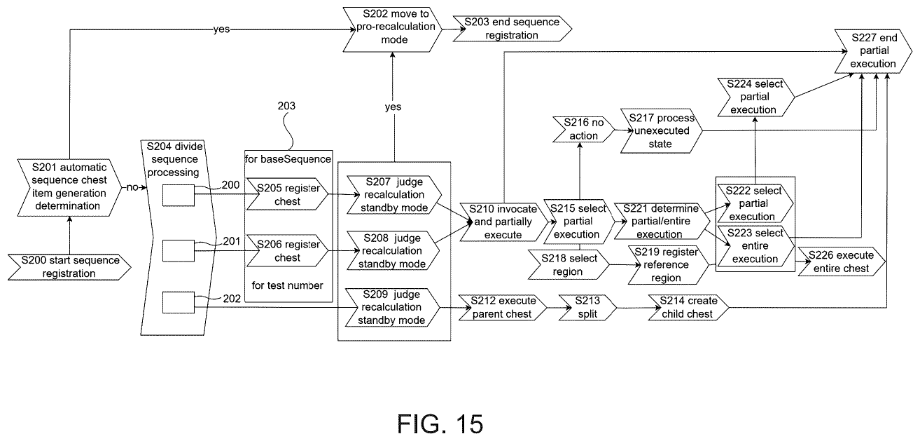

FIG. 15 is a flowchart relating to sequence registration processing according to the present embodiment. In FIG. 15, when sequence registration is executed (S200), it is first determined whether to generate auto sequence chest items (S201). If determined to be “auto-generate,” the process transitions to post-processing of recalculation standby mode (S202) and ends (S203). If determined to “not auto-generate,” subsequent processing is divided into three types of sequence processing (map, yield, split) (S204). (1) Map 200: Based on chest information extracted as base sequence, chest registration belonging to the sequence is executed in chest registration section 203 (S205). (2) Yield 201: According to the number of testNumbers, chest registration is similarly executed in chest registration section 203 (S206). (3) Split 202 (see later reference). After map processing is completed, the necessity of recalculation standby mode is determined (S207). For yield processing, the necessity of recalculation standby mode is also determined (S208). Subsequently, sequence expansion invocation and preprocessing of partial execution mode are executed (S210). Thereafter, either user input is awaited, or the process transitions to re-execution mode, but at this stage, partial execution mode remains unchanged.

When partial execution (range) selection is performed (S215) and the sequence display screen is exited without any selection (S216), unexecuted processing is carried out (S217), and the process ends (S227). If the range selection is valid, based on the user selection information, it is determined whether the sequence is “full execution” or “partial execution” (S221). If partial execution is selected (S222), post-processing for partial execution is performed (S224), and each chest is sequentially executed (S226), after which the partial execution mode is canceled. If full execution is selected (S223), all chests proceed to execution (S226). Additionally, if SHOT (range) selection is simultaneously performed during partial execution (S215) (S218), SHOT reference registration is executed (S219), and this reference is reflected in the subsequent execution processing (S222) and post-partial execution processing (S223).

With respect to the split 202 as well, the process branches in accordance with the flow of processing. First, it is determined whether the recalculation standby mode is active (S209), and then the execution of the parent chest (sequence chest) is performed (S212). Based on the result output, the response is split according to the response splitting logic (S213), and based on each output, an executed chest is newly generated as a sequence child chest (S214).

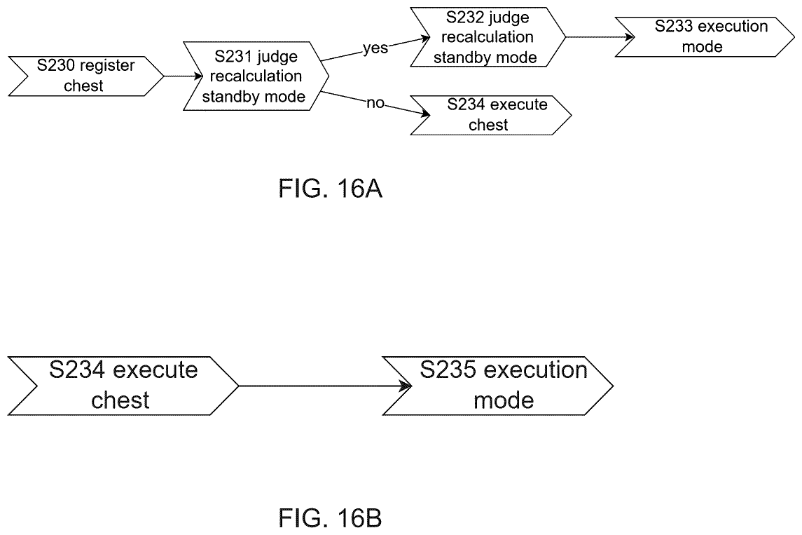

FIG. 16 is a flowchart illustrating chest registration processing according to the present embodiment. In FIG. 16, chest registration processing is first initiated (S230). Next, it is determined whether the current processing mode is recalculation standby mode (S231). If it is determined to be recalculation standby mode, post-processing corresponding to recalculation standby mode is executed (S232), and the process ends (S233). On the other hand, if it is determined not to be recalculation standby mode, the process proceeds to chest execution processing (S234), after which it ends (S235).

FIG. 16B is a flowchart illustrating the detailed flow of chest execution processing in FIG. 16. In FIG. 16B, if it is not recalculation standby mode (S232), chest execution processing is similarly executed (S234), and the process then ends (S235).

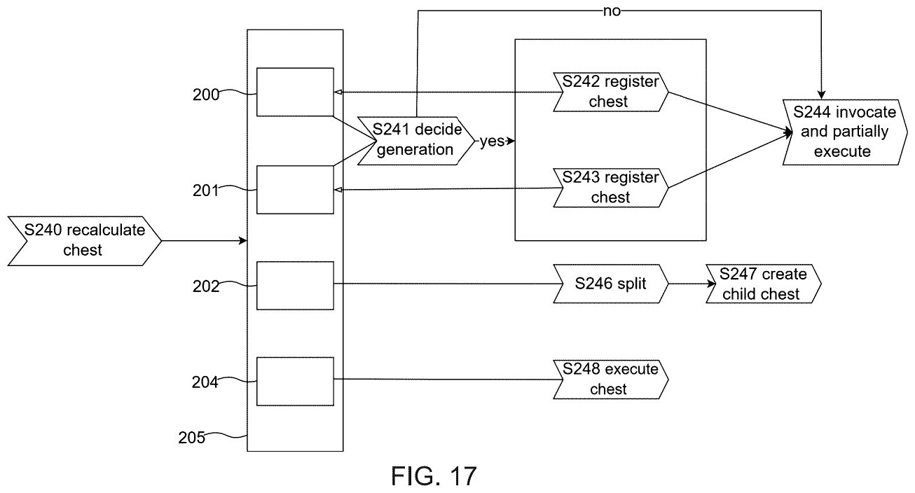

FIG. 17 is a flowchart illustrating the recalculation processing of a chest according to the present embodiment. In FIG. 17, recalculation processing of a chest is initiated (S240). Next, the process branches depending on the chest type 205.

In the case of map type (Map Type: 200) and yield type 201, it is determined whether to generate auto sequence chest items (S241). If auto-generation is selected, for map type, chest registration for base sequence is executed based on base sequence information (S242). For yield type, chest registration for test number is performed based on test number information (S243). If auto-generation is not selected: the process moves directly to sequence expansion invocation (preprocessing of partial execution mode) (S244). Even after automatic registration, the process continues to sequence expansion processing at S244.

For split type 202, the chest is first executed (S245). Then, the response is divided by response splitting processing (S246). Based on the divided data, sequence child chests (executed) are generated (S247). For reduce type 204, no special splitting process is performed, and only chest execution is carried out (S248).

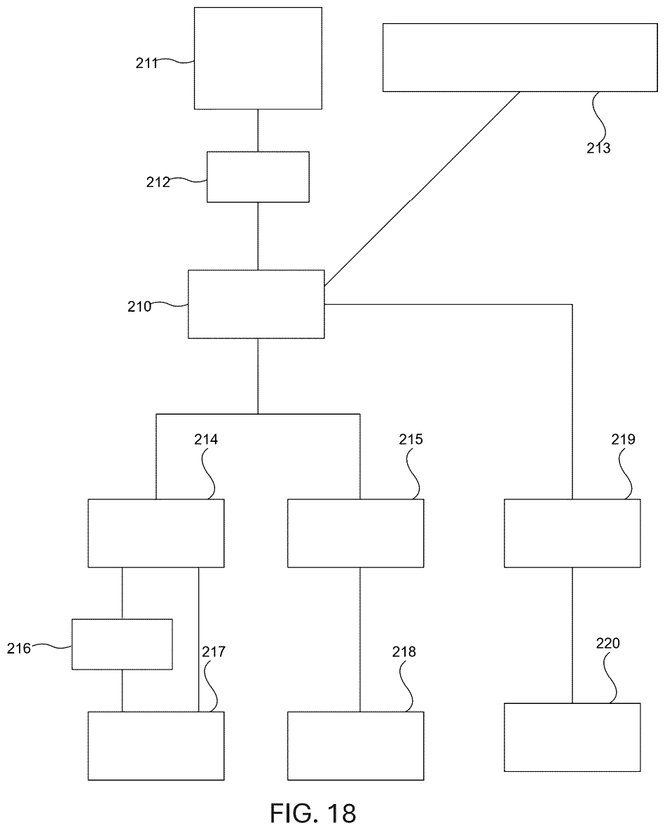

FIG. 18 is a block diagram showing the configuration of message data and message format according to the present embodiment. The message data 210 shown in the figure is the fundamental data format for information circulation within the system and is optimized specifically for handling text data output by AI.

The message data 210 is stored as the final message (last message 212) of the chest 211 and is aggregated as the execution result of the group within a project, namely the flow process. These messages are stored as elements of a message data array 213 and are passed on to the next processing stage.

Each piece of data 216 included in the message data 210 is managed as an array of two types of containers: message carriers 214 (containers for storing text-type information in plain or structured formats) and file carriers 215 (containers for handling file information on storage). The type of information handled by the message carrier 214 is strictly defined by the data type 217, enabling the safe interoperation of AI response data with other APIs. Each data 216 is appropriately handled based on authentication of this data type 217. The file carrier 215 is a container for handling file information on storage and includes metadata for retrieving data from file index information and file storage 218.

The message format 219 conforms to the chest form of the user interface 220 in the chest flow configuration GUI processor and has a bidirectional conversion (convert) function with the message data 210. Through this format, it becomes possible to appropriately display and edit user query inputs or API response information in a UI-friendly manner.

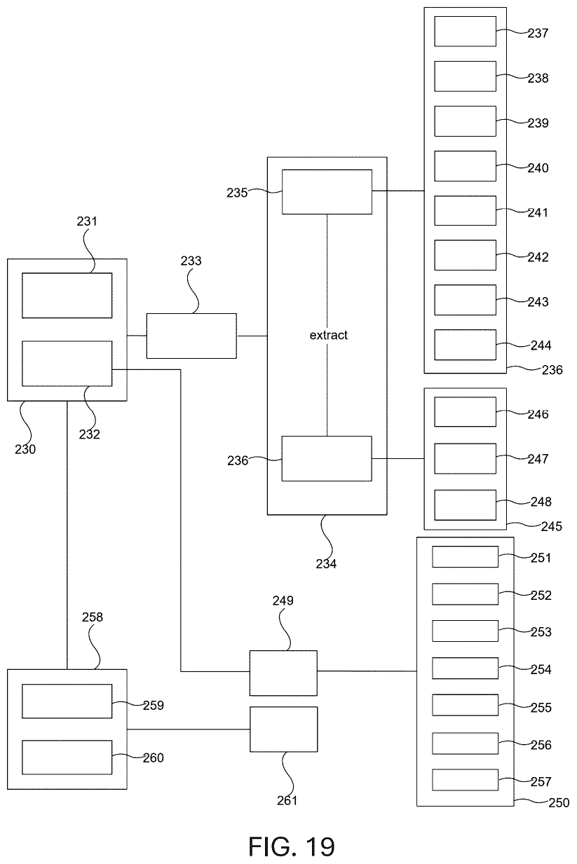

FIG. 19 is a block diagram showing the configuration of function processing information, messages, and properties according to the present embodiment. The function processing information 230 shown in the figure is centered around message 231 and property 232, visually indicating what elements are integrated into each item.

Text 233 shows the configuration of text information integrated into the function processing information 230, and the lower-level text structure 234 consists of structured text 235 and plain text 236. Structured text 235 is composed based on extracted code blocks or stylistic patterns from AI responses. Information types classified as structured text include URL 237, keyword 238, CSV 239, HTML 240, notebook execution data (noteExecutionData 241), JSON-format text 242, embedding 243, and list 244. Plain text 236 is general textual data and includes type 245 such as AI response 246, user query 247, and file content 248.

Asset 249 refers to persistent data stored in a database, which is integrated with message 231 via properties. The types of information that can be registered as assets 250 include prompt 251, fine-tuned model 252, embedding 253, file 254, API setup information 255, message helper 256, and parent argument 257.

Other data formats 257 include those requiring special handling, such as argument information 258 and file 259. These require special mechanisms 261 for argument or file processing. Finally, non-text data 260 is explicitly stated to be usable within the system only in its dedicated format.

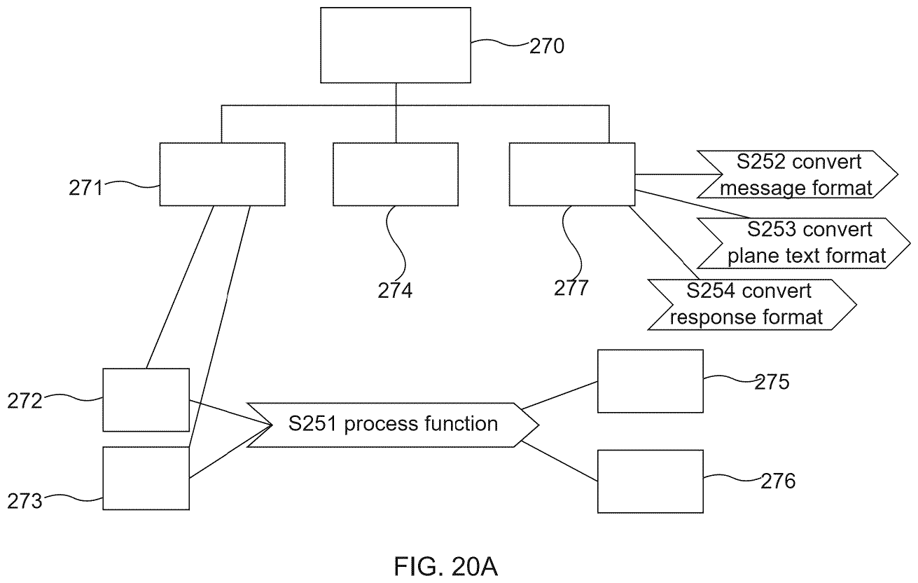

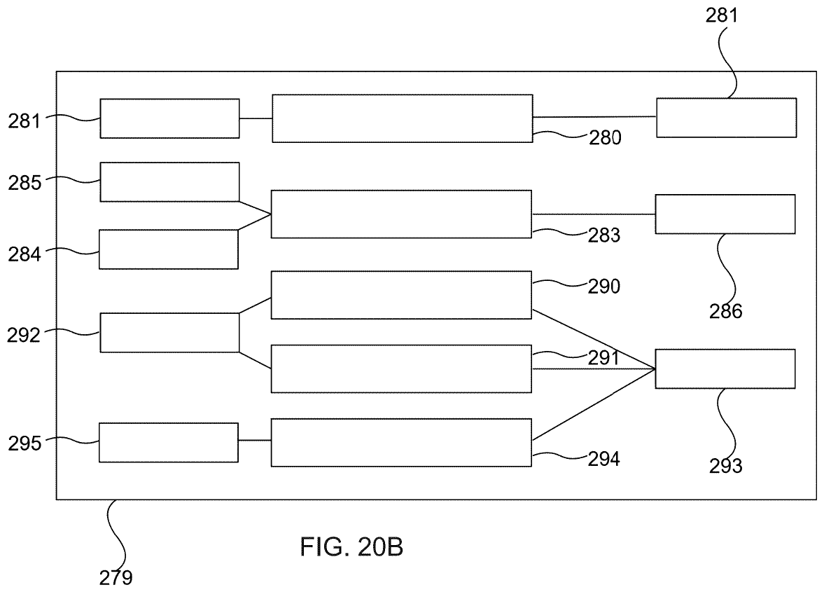

FIG. 20A is a block diagram showing the configuration of REST API type query functions according to the present embodiment. In FIG. 20A, a typical REST API processing data format 270 is extracted as structured text 272 or data 273 conforming to query JSON type 271, and based on that, function processing is executed (S251). The API access information required for function processing includes URL, HTTP method, parameters, body, and API key held as access data 274 in properties. Output formats for functions include JSON text format 275, structured data 276 (expected to be retained for argumentation or file generation processing). These outputs are processed by the response conversion unit 277 into one of the formats: message format (S252), plain text conversion (S253), or user-facing response format conversion (S254).

FIG. 20B is a block diagram showing examples of REST API queries according to the present embodiment. The main query function in this figure is the API request query function 279, which is configured to issue queries to various external services and functions. The notebook execution query 280 sends queries using the notebook execution data format (Notebook Execution Data) 281 as input and receives responses in the same format 281. This corresponds to processing in notebook-type execution environments such as Jupyter Notebook.

The embedding similarity query 283 receives query string 284 and OpenAI message data array 285 (such as past interaction history) as input. Based on these, chunk arrays close in vector space and their scored text 286 are returned. This function is used for similarity searches and information reuse. Google search and scraping type queries are also supported, including Google search query 290 and Google search scraping query 291 (receiving keyword 292 as input and returning results in Google data format 293), and Google scraping query 294 (receiving URL type 295 as input and returning scraping results in Google search data format 293). These query groups are used for extracting information from external web resources and obtaining search results.

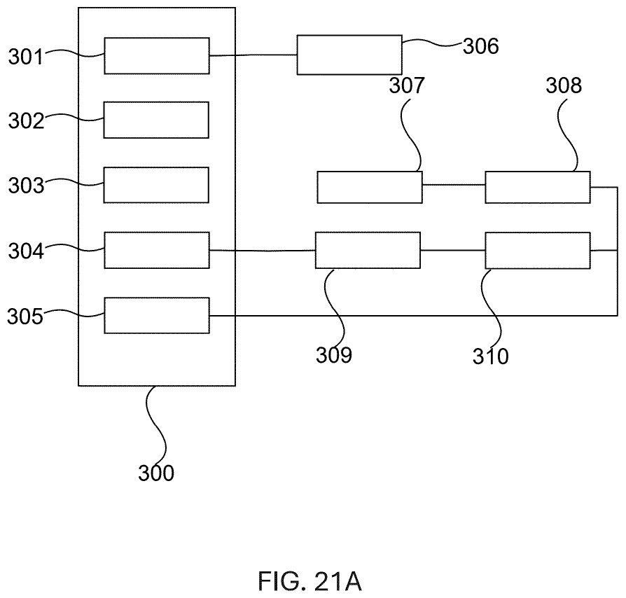

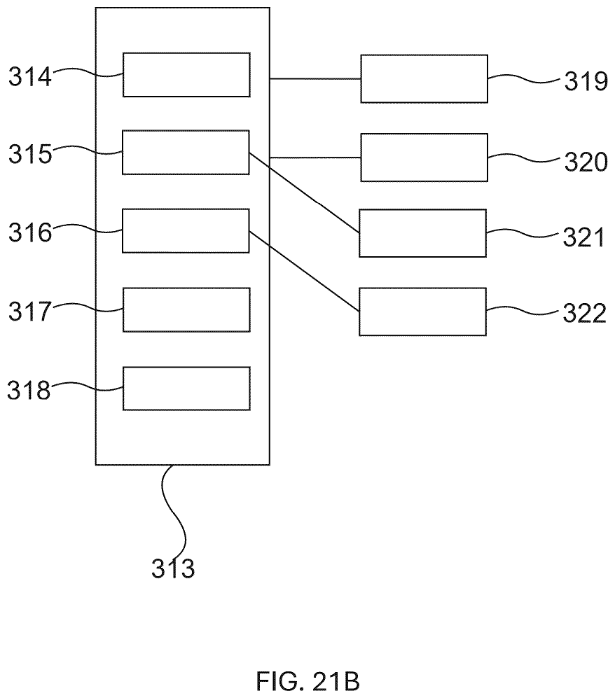

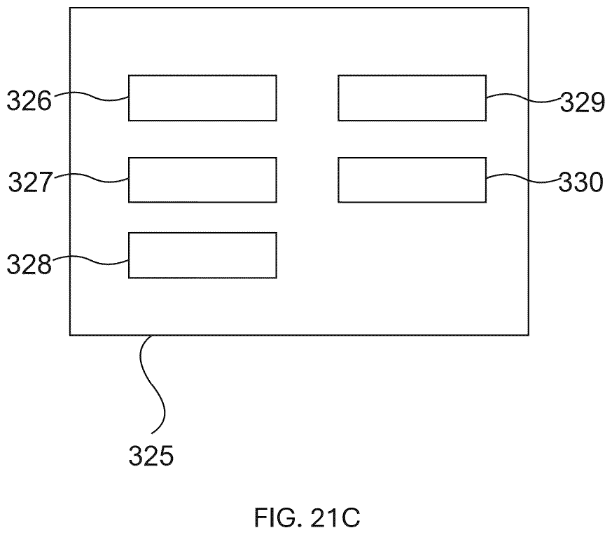

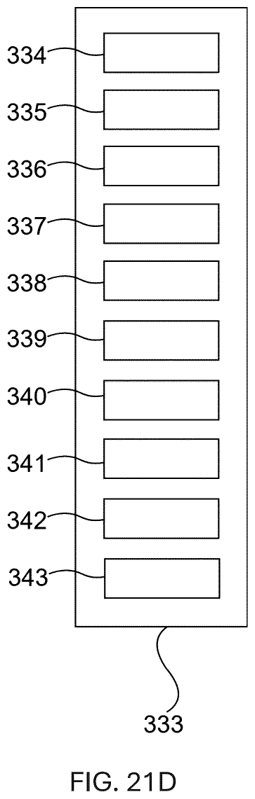

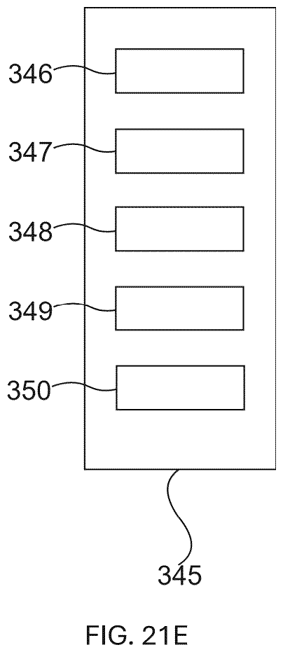

FIG. 21A is a block diagram showing the configuration of message preprocessing according to the present embodiment. Here, the flow of various preprocessing steps executed prior to AI message generation is explained. The message generation function 300 performs processing to extract necessary information from the input message. OpenAI format conversion 301 converts the extracted information into OpenAI format message data. OpenAI extraction tool 302 extracts information in JSON format conforming to OpenAI tool specifications. Keyword/URL integration 303 extracts keywords and URLs from the message and, if multiple, integrates and formats them into a single string. Execution data generation 304 generates information for notebook execution from the extracted JSON data. Argument matching 305 matches and extracts data that meet defined conditions from the parameterized information.

To format the data into the standard format, the following processing is performed. First, Standard AIQ Conversion/R Message 306 converts the extracted and transformed data into standard AI query (AIQ) format and formats it into R message (reference message) format as necessary. Then, Conforming Standard APIQ Filter/R Message 307 filters and extracts only the data that matches the standard API query format.

The following processing is performed for argument conversion and execution data output. First, conforming arguments 308: argument processing is applied to the filtered information. Then, execution data generation 309: execution data usable in notebooks or APIs is ultimately generated. Further, conforming arguments 310: necessary argument formatting and conversion are performed again.

FIG. 21B is a block diagram showing the configuration of API output processing according to the present embodiment. This shows the flow of converting and processing the results of various query functions into formats usable within the system as message data.

The generation function 313 is a core processing unit that extracts and converts necessary information from the output results of query functions and performs integrated output conversion processing. Conversion units corresponding to the query types appropriately convert data according to the type of data being processed. The OpenAI message conversion unit 314 converts responses in OpenAI format to the system standard message format. The search result conversion unit 315 formats and converts web query search results. The execution data conversion unit 316 formats execution results obtained from notebook queries into data formats such as JSON. The OpenAI function call conversion unit 317 converts function call or JSON inquiry results via OpenAI API into the system format.

Storage processing into message format includes: data passthrough processing 318: unconverted output data is stored directly as message data; standard AIQ conversion/R-message generation 319: information to be output as an AI query (AIQ) is generated as a standard response message; and standard APIQ/R generation 320: outputs that conform to the API query format are generated in the standard API response format.

In the specialized processing units, search result generation 321: search results to be presented to the user are formatted and generated from the output of search-type queries, and execution data generation processing 322: execution data applicable to API integration or the next step is generated from processing results such as notebooks.

FIG. 21C is a block diagram showing the configuration of common properties for message processing according to the present embodiment. This figure shows the system of common properties that define which message data is used or referenced in flow processing between chests and API response processing.

Message data range 325 is a property that defines the applicable range among the output (message data) from the previous process. This may include the immediately preceding chest, prior stage outputs, or selected outputs among multiple flows. A representative message selection property is function message selection 326 (a property for selecting a message obtained from a function already executed within the chest). This property can be accompanied by detailed index information 329 such as function index, message data index, and message index.

Prompt message selection 327 specifies the response obtained from the most recent query process. This property allows for the selection of retrieval modes (330) such as “all: all messages,” “first: first message,” or “last: last message” from the message sequence.

Result message selection 328 specifies the final output obtained from the function execution. Typically, this is used as a message passed to subsequent processing or the next chest.

FIG. 21D is a block diagram illustrating the configuration of data extraction processing from AI-generated text according to the present embodiment. This figure shows the processing flow and functional modules for extracting data with specific formats or structures from text output by an LLM (Large Language Model). The response text extraction unit 333 is the central processing module that analyzes natural language text output from the LLM and detects and extracts various data structures.

The following lists the main functions for extraction processing:
(1) Code extraction determination 334: detects code blocks (e.g., Python) within the text and extracts them as code snippets.
(2) CSV/Main CSV extraction determination 335: identifies tabular data structured based on delimiters (commas, tabs, etc.) and extracts them as CSV or primary matrix information.
(3) JSON extraction determination 336: detects and extracts JSON format strings from text in a parsable state.
(4) URL extraction determination 337: detects URLs using regular expressions and extracts them as link information.
(5) Notebook-related JSON extraction determination 338: identifies and extracts data with schemas related to Jupyter Notebooks among the extracted JSON information.
(6) Keyword extraction determination 339: collectively identifies keywords in the text and extracts them as tags or classification information.
(7) List structure extraction determination 340: detects patterns of numbered lists, bullet points, or repetitive structures and extracts them as array-form data.
(8) Meta list format extraction determination 341: surveys the entire document and extracts headers, lead sentences, and similar meta structures as list formats.
(9) OpenAI tool schema extraction determination 342: identifies and extracts structured formats (such as JSON) corresponding to OpenAI's function call schema.
(10) Notebook argument schema extraction determination 343: identifies and extracts schemas (in JSON format) that describe the arguments needed for notebook execution.

FIG. 21E is a block diagram showing the configuration of the process for extracting text information from files according to the present embodiment. This figure illustrates the flow of processing for extracting usable text information by format from files uploaded or specified by the user.

The file text extraction unit 345 refers collectively to the processes intended to retrieve internal text information from all types of file formats. Depending on the file type and contents, text extraction is performed using the following methods:
(1) Plain text extraction 346: extracts character data directly as plain text. Applied to files with no special structure (e.g., .txt).
(2) JSON format extraction 347: when the file content conforms to JSON format, structural parsing and extraction are performed. Extracted JSON can be directly handled as properties or messages.
(3) CSV format extraction 348: when the structure includes comma- or tab-separated data, it is parsed as CSV and extracted as tabular data.
(4) Markdown format extraction 349: applied when markdown structure is identified (headings, lists, code blocks, etc.). Extracted text maintains structural integrity.
(5) Binary file conversion 350: for binary file formats like Word, Excel, or PDF, the corresponding conversion methods are applied to extract and format the internal text data.

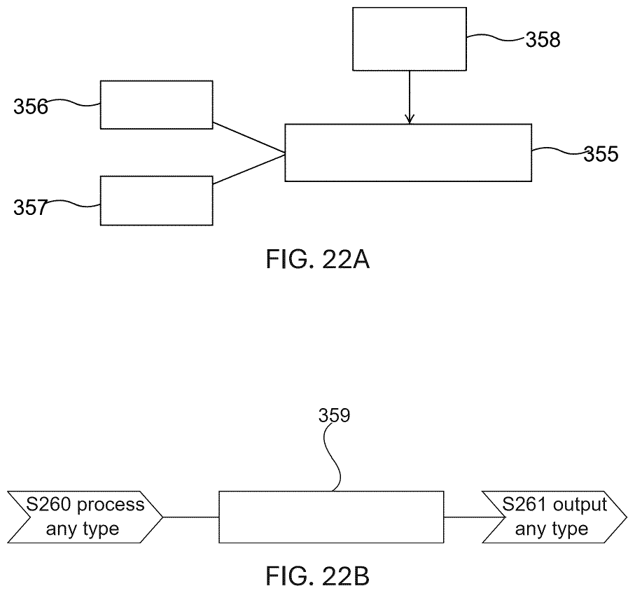

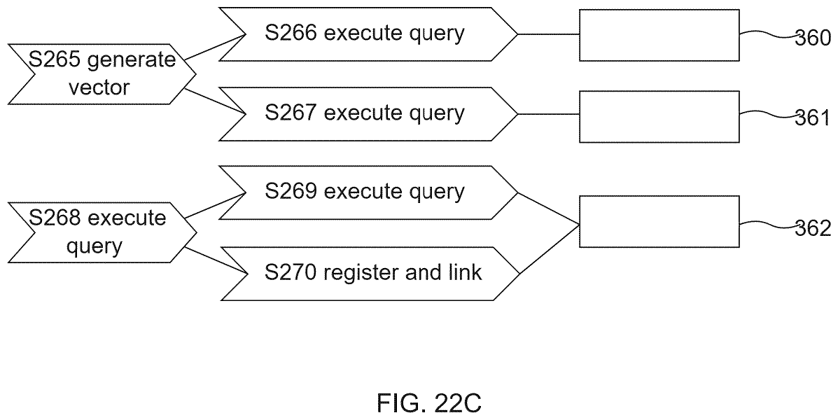

FIG. 22A is a block diagram showing the configuration of query processing using a message helper list according to the present embodiment. The helper yield type 355 shown in the figure refers to a processing method that utilizes an array of message helpers sequentially (yield processing). The data 356 or text 357 to be processed is sequentially passed to the specified message helper list 358 via property definitions, and individual processing is performed. This format is used when reusing multiple message components in a pattern or for repeat processing (map/yield).

FIG. 22B is a flowchart showing the flow of system query processing according to the present embodiment. The system 359 executes ANY type (generic type) processing (S260). Then, the output of the ANY type is generated and passed to another process (S261). The ANY type is designed to allow flexible processing not limited to predefined types and functions as a common interface when connecting with other data formats or external queries.

FIG. 22C is a flowchart describing the roles of system query processing step by step: (1) Embedding vectors are generated from the OpenAI message array (S265). (2) An embedding data file format generation query is executed (S266) to obtain embedding-type data 360. (3) A fine-tune query is executed (S267) to retrieve invocation information of the tuned model 361. (4) The currently executing properties and tags are obtained (S268), a query for a different project is executed (S269), and the other project's process is invoked via ANY 362. (5) By executing a result query of another chest, the result information is registered/linked to the chest of another project (S270). This series of processes forms an important infrastructure for saving, sharing, and utilizing LLM inference and fine-tuning results in reusable formats.

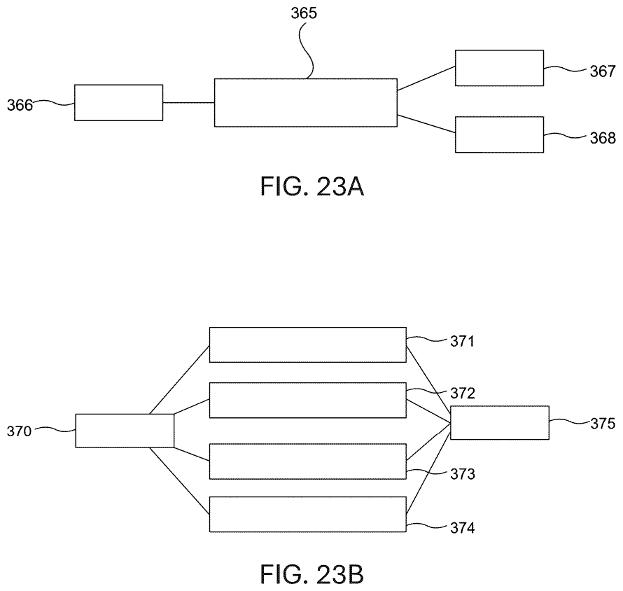

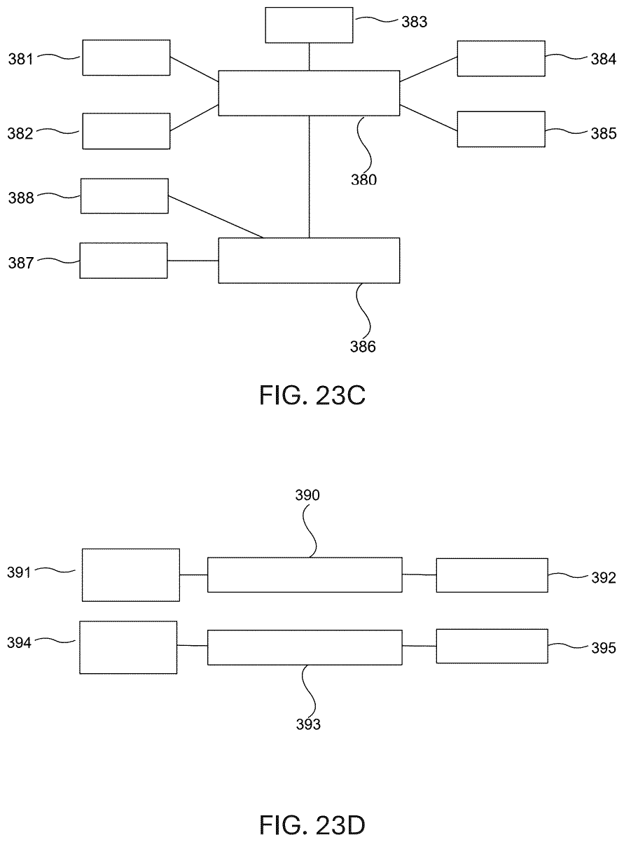

FIG. 23A is a block diagram explaining the basic functions of LLM (Large Language Model) query processing according to the present embodiment. In this figure, the LLM query 365 receives a message in plain text format 366 as input and returns the output in JSON text 367 or standard text format as AI response 368.

FIG. 23B is a block diagram explaining the specific execution formats of LLM query processing. The OpenAI message data array 370 is message information formatted for queries and is supplied to various LLM queries. The standard OpenAI chat query 371 makes a standard request to the OpenAI chat API. The continuous OpenAI chat query 372 operates in a mode that retrieves all LLM output. The OpenAI mini query 373 is a lightweight query for simplified requests. The OpenAI function API query 374 makes requests based on function data or JSON structures. The result of each query is obtained as OpenAI response data 375.

FIG. 23C is a block diagram explaining the functional structure of query processing for data. The data-processing-type function 380 receives messages entered as data 381 or text 382 and acquires property information such as asset information 383 to perform processing. The output is returned in the form of text 384 or data 385. In the splitter-type 386 data processing, a list-form message 387 or asset list 388 is received and individually processed by splitting.

FIG. 23D is a block diagram explaining a specific implementation example of data query processing. The passer 390 has a simple relay function that forwards the input message data 391 directly as output message data 392. Meanwhile, the file data query 393 receives ANY-type information 394, saves it as a file, and outputs the information as ANY call information 395. In this way, LLM response processing and data processing/storage are closely integrated to support flexible information utilization.

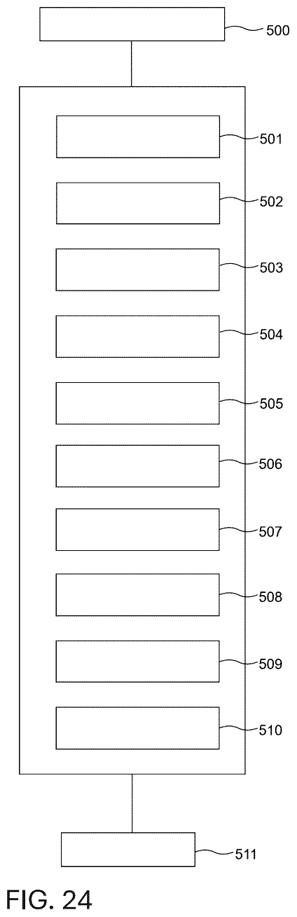

FIG. 24 is a flowchart showing the flow of LLM (Large Language Model) output text transformation processing according to the present embodiment. In this figure, the response text conversion module 500 first receives output text from the LLM. Then, the following series of extraction and classification processes are sequentially executed:
(1) Code block extraction 501 (extracts code segments in the output text)
(2) CSV format table data extraction 502 (detects and extracts data that can be formatted as tables)
(3) Automatic detection and extraction of JSON structure 503 (extracts JSON format data that can be parsed)
(4) URL format extraction 504 (extracts URLs based on regular expressions)
(5) Notebook-related JSON structure extraction 505 (detects JSON with schema information required for notebook execution)
(6) Keyword structure extraction 506 (extracts semantic keywords from the LLM output in blocks)
(7) List structure extraction 507 (extracts data in list format from repetitive structures)
(8) Classification extraction based on overall structure 508 (analyses entire sentences to classify meta-structures)
(9) Extraction of OpenAI tool call information 509 (extracts function call and tool information)
(10) Extraction of notebook argument structures 510 (extracts necessary argument structure information for notebook execution) Structured data obtained through these processes is stored and integrated as message data 511 and reused in subsequent processing units.

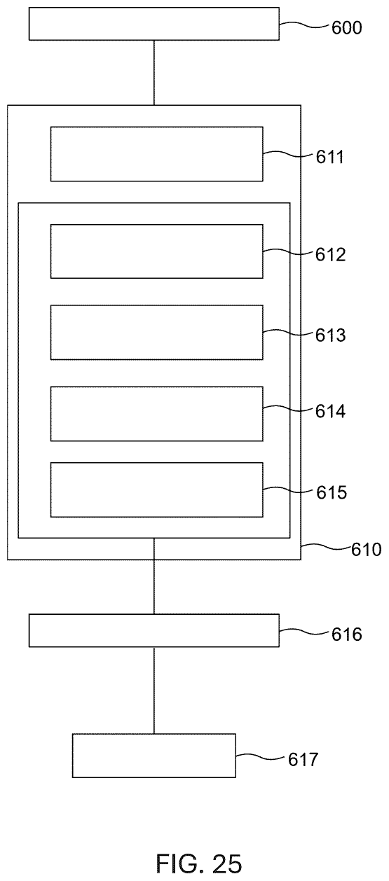

FIG. 25 is a block diagram showing the functional configuration of message conversion processing for file information according to the present embodiment. As shown in the figure, file information 610 retrieved from storage by file carrier processing 600 is subjected to different processing depending on its structure. Specifically, if the file information is not of binary structure type 611, processing branches according to structural types such as plain text structure 612, JSON structure 613, CSV structure 614, or Markdown structure 615. For files matching these structures, text content extraction processing 616 appropriate to each format is executed, and the extracted data is stored as message data 617. With this configuration, various file formats on storage can be efficiently converted into unified-format message data usable for AI processing or API calls.

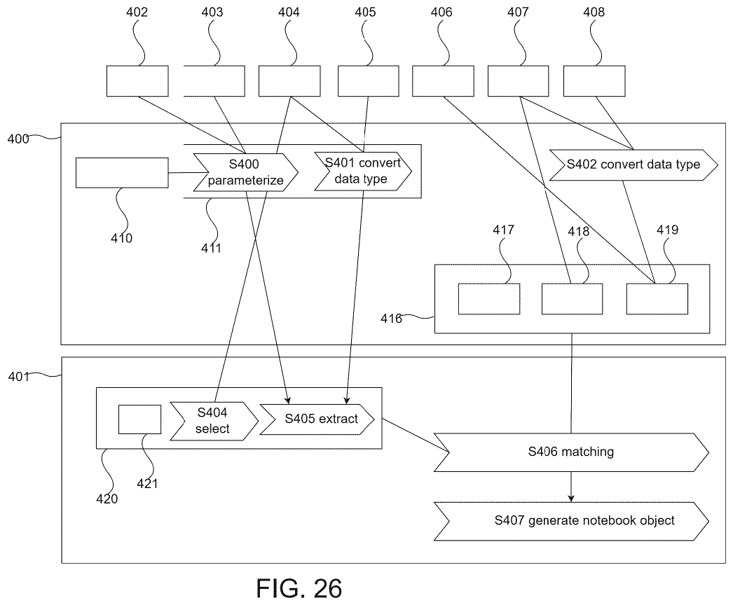

FIG. 26 is a block diagram showing the configuration of argument processing functions according to the present embodiment and describes an example of various argument processing and notebook information message extraction processes performed by message execution unit 400. The argument processing mechanism shown in this figure originates from notebook processing but is also extensible to general API processing, which is a distinctive feature.

When notebook argument definition 410 is applied, information 402 from registered files or message data 403 with a data type matching the relevant argument definition is parameterized (S400). AI-generated text 404 and AI-generated data 405 that can be converted into suitable data types are also typed (data-typed) (S401), and argument definition information is provided, then supplied as arguments 411 to subsequent processing.

On the other hand, when AI-generated text 407 and AI-generated data 408 conform to the notebook execution data format, they are typed (S402), and through query registration 406 of selected messages, direct extraction from AI-generated text 407, or query registration 417 in the corresponding format, they are sent as notebook data 416 to subsequent processing.

The message generation process 401 represents the argument processing and notebook matching process. When argument definition 420 exists, registered information 421 from queries or existing arguments 411 that match the definition are selected (S404), and if matching, extraction is performed according to the definition (S405). Subsequently, notebook definition information and argument information are matched (S406), and a notebook object with the necessary properties is generated (S407). This notebook generation mechanism is not limited to notebook objects but is also usable for APIs that have defined property information as arguments via the matching enhancement function 424.

### Detailed Description of Functions and Components

The following describes in detail each function and component used in the API utilization support system of the present invention.

The project page provides users with a visual and intuitive interface for constructing and managing data flows through the cooperative operation of multiple components. Each component has a clear role, enabling users to effectively manipulate chests and flows on the field. The project page is the main page for managing projects and operating chests on the field. It consists of multiple components, each responsible for specific functions. The following describes the structure and functions of each component in detail.

Projects.js is the main component of the project page and provides functions such as listing, selecting, creating, updating, and deleting user projects. It also fetches and displays field data of the selected project. Major functions include: retrieving and displaying a list of projects obtained from the chest flow execution controller for the user; project selection function, where selecting a project fetches its data and displays chests on the field; creating, updating, and deleting projects via forms; retrieving field data related to the selected project from the chest flow execution controller; displaying messages according to operation results (success/failure); and managing a drawer that displays the ChestStream component beside the field.

ChestField.js is a component that visually displays chests and flows on the field and allows users to manipulate chests. Its main functions include: displaying chests by placing them on the field and reflecting their position and status; drag-and-drop function for users to reposition chests; displaying flows (data flows) between chests with lines or arrows; chest selection and editing by clicking to display or edit details; and expanding/collapsing sequence chests (chests with multiple processes).

ChestStream.js is a component that displays a list of messages and data generated from chests, allowing users to review the content. Its main functions include: displaying each message as a card, allowing users to check the content and title; showing detailed information when a message card is clicked; and a download function that allows users to download displayed messages in Markdown format.

ChestBox.js is a component that represents individual chests, responsible for their display and interaction on the field. Its main functions include: displaying the chest's title, status, and group state; providing icon buttons for group selection, partial execution designation, sequence expansion/collapse, and chest deletion, allowing user interaction; and enabling chests to be moved via drag-and-drop using react-dnd.

Chest flow.js is a component that visually displays the flow (data flow) between chests. Its main functions include: drawing lines between source and target chests to indicate data flow; and providing flow buttons placed on the flows that allow users to view and edit flow details when clicked.

ExpandingChestBox.js is a component that manages the expansion and collapse of sequence chests and displays child chests when expanded. Its main functions include: displaying parent chests and their child chests together; managing the display area of child chests using scrollable containers when many child chests exist; and providing sequence execution buttons for partial or full execution.

The following describes the main components and their functions related to field processing by the chest flow execution controller. ChestFieldController receives requests from the chest flow configuration GUI processor and provides API endpoints related to operations on chests and flows. ChestFieldService implements business logic and provides functions such as chest creation, recalculation management, and sequence execution. FieldObjectService handles detailed operations on objects (chests and flows) on the field.

The overall flow of the project page is as follows: users select or create a project via Projects.js; the selected project's data is fetched; ChestField.js displays chests and flows on the field; users interact with chests via drag-and-drop or icon buttons; through ChestStream.js, users can view messages and data generated from chests; sequence chests can be expanded or partially executed using ExpandingChestBox.js; and user operations send requests to the chest flow execution controller, which are handled by ChestFieldController and related services.

The following describes the main component files of the chest flow configuration GUI processor and the functional details of each page. Account.js handles the user account management page. It provides functions for user login, logout, registration, password changes, and account deletion. Main functions include: (1) login form for users to enter username and password; (2) registration form for new users to create an account; (3) password change function for logged-in users; and (4) account deletion function for users to delete their accounts.

FileManager.js provides a file management page for uploading, downloading, and deleting files. Main functions include: (1) displaying a list of uploaded files; (2) uploading files from the local environment; (3) downloading uploaded files; and (4) deleting unnecessary files.

Help.js is a help page that provides usage instructions and FAQs for the application. Main functions include: (1) displaying frequently asked questions and their answers in list format; (2) step-by-step usage guide for the application; and (3) contact information for additional support if needed.

MessageHelperList.js is a message helper management page that allows operations such as listing, creating, editing, and deleting message helpers. Main functions include: (1) displaying a list of message helpers owned by the user; (2) creating new message helpers; (3) displaying an edit modal window (a small window restricting interaction with the original screen) to edit details of selected message helpers; and (4) deleting unnecessary message helpers.

NotebookManager.js is a management page for creating, editing, executing, and deleting notebooks. Main functions include: (1) displaying a list of existing notebooks; (2) creating new notebooks; (3) editing selected notebooks in an editor; (4) executing notebook code on the server; and (5) deleting notebooks that are no longer needed.

Projects.js is the main project management page for listing, selecting, creating, deleting, and updating projects. It also includes functions for displaying and editing details of selected projects. Main functions include: (1) displaying a list of user projects; (2) creating new projects; (3) displaying, editing, and deleting selected projects; (4) deleting unnecessary projects; and (5) displaying detailed fields of selected projects with interaction capabilities.

TemplateManager.js is a template management page that provides functions for creating templates from projects and creating projects from templates. It also allows importing and exporting templates. Main functions include: (1) displaying a list of user-owned templates; (2) creating templates from existing projects; (3) creating new projects from templates; (4) deleting unnecessary templates; and (5) importing/exporting templates from/to files.

AlModelHelperManager.js is a page for managing AI model helpers, allowing users to tune, register, and manage models based on their own data. Main functions include: (1) displaying a list of user-created AI model helpers; (2) tuning existing AI models with user-specific data using datasets processed by the message creator, and registering the new models; (3) generating embedding vectors from datasets for use in information retrieval or similarity calculations; (4) editing properties of registered AI model helpers and deleting unwanted models; and (5) displaying usage status of registered models so users can identify which models are used in which chests.

Users prepare and process datasets through the message creator to collect and format data for model training. Preprocessing steps (cleaning, tokenization, tagging, etc.) are performed to format the data suitably for model tuning. For model tuning and registration, the processed dataset is used by a query function in the chest flow execution controller to tune the model. The tuned model is registered in the database as an AI Model Helper, with model name, identifier, related properties, and owner information set at the time of registration.

Users can view and manage a list of AI model helpers they have registered. Each model's details (name, creation date, usage status, etc.) are displayed. Users can edit or delete models as needed. Registered models can be called and used from other chests or query functions. By specifying a model's name or identifier, users can execute processing that applies a specific model. Model parameters and properties can be dynamically set to adjust processing content. When a model is registered or updated, its name or identifier is returned to the user as a response. This allows the user to confirm that the model generated from their data has been successfully registered and is available for use.

The characteristics of AlModelHelperManager.js are as follows:
(1) Support for building custom AI models: Users can build and manage more suitable AI models using their own data.
(2) Improved model reusability: Once registered, models can be used by other features, enabling efficient data processing.
(3) Intuitive management interface: Users can visually confirm the status and usage of models, making management easier.
(4) Integrated data management: Centralized management of models and related datasets or properties ensures system-wide consistency.

AppContext.js manages shared state throughout the app using React context. Its main functions are:
(1) Authentication token management: Manages tokens that retain user authentication status.
(2) CSRF token management: Manages CSRF tokens as a security measure.
(3) Current context and mode: Manages the current page and context mode to control navigation and display.

UtilityFrame.js is a component that provides a common framework for utility pages. Main functions include:
(1) Navigation drawer function that provides a side drawer always visible to facilitate navigation between utility pages.
(2) Responsive design function that adjusts drawer visibility and content layout depending on screen size.

Navbar.js is a component that provides the top navigation bar for the entire application. It displays links to the main pages in the app and shows the current page and context. This application is designed around the navigation bar provided by Navbar.js so users can efficiently access various functions. With the addition of AlModelHelperManager.js, users can now build custom AI models from their own data and utilize them within the system. Each page focuses on a specific function and contributes to enhancing the user experience. Main functions include: (1) page title display function showing the current page or context name in uppercase; (2) navigation link function providing links to Projects, Utilities, Account, and Help; (3) page highlight function that changes the style of the relevant navigation button depending on the current page; and (4) context mode display function showing context information when the user is in a specific context mode.

The following describes detailed functions and processes. The OpenAI Standard Chat Message Creator within the message creator has the following functions:
(1) Message preparation function that receives message data containing queries from chests and formats it for the OpenAI API.
(2) Property usage function: Filtering conditions and conversion settings are obtained from properties, allowing flexible control over message selection and processing methods.
(3) Message extraction and filtering function that extracts necessary messages based on specified conditions (role, tag, text content, etc.).
(4) Message conversion function that converts extracted messages into the OpenAI format (e.g., list of role-content pairs).

The flow consists of the following four steps:
(1) Retrieve properties: Obtain filtering conditions (e.g., roleFilter, filterText) and conversion options from properties.
(2) Extract messages: Select necessary messages from all messages in the chest based on properties.
(3) Process messages: Convert selected messages into a format required by the OpenAI API. Query helpers and other tools are used to format text and remove unnecessary information.
(4) Store results: Store processed messages in Function Results and pass them to the next query function.

The Standard OpenAI Chat Query query function provides the following three functions:
(1) API request construction function that constructs request data for the OpenAI API based on messages received from the message creator.
(2) API inquiry function that sends the constructed request to the OpenAI chat model. By specifying the model and inputting a format in the query, FUNCTIONCALL is also possible.
(3) Response acquisition and parsing function that receives the API response and extracts necessary information.

The flow consists of the following six steps:
(1) Message preparation: Flatten the message list and format it according to API requirements.
(2) Add system message: Add system messages (context or instructions for the conversation) to the message list if necessary.
(3) Set API parameters: Obtain parameters such as model name, temperature (a parameter that adjusts creativity and unpredictability of generated text), and token count from properties and set them in the request.
(4) Send request to API: Send the request to the OpenAI endpoint.
(5) Extract response content.
(6) Store results: Store extracted data in Function Results and pass it to the generator. The OpenAI Chat Response Standard Generator within the generator has the following three functions: (1) Response message generation function that generates the final message based on data received from the query function. (2) Message processing and tagging function that processes the message content and adds specific tags as needed. (3) Storage in executor function that stores the generated message in the executor for system state management.

The flow consists of the following six steps:
(1) Response data acquisition: The response from the query function is obtained from the Function Results.
(2) Extraction of message content: When multiple candidates exist, the content of each message is extracted.
(3) Message generation: A new message object is created using the extracted content.
(4) Tag application: Specific tags are added to the message based on properties and conditions.
(5) Message storage: The generated message is stored in the executor in preparation for subsequent processing or response return.
(6) Response return: The executor state is updated and returned to the user as the final response.

The characteristics of the series of processes are detailed in the following five aspects:
(1) Clear responsibility allocation among modules: Each component functions independently with a clear role, improving overall system readability and maintainability.
(2) Flexible property settings: Behavior can be finely controlled through properties, enabling adaptation to various use cases and requirements. (3) Use of helper classes: Utilities such as Query Helpers enable concise implementation of common or complex transformation processing.
(4) Thorough error handling: Errors that may occur in each processing step are appropriately captured and handled to maintain system stability. (5) Use of tags and metadata: Tags are added to messages to flexibly control subsequent processing and conditional branching.

The overall process can be summarized into the following four steps:
(1) Message preparation and processing (Message Creator): Messages in the chest are extracted and processed into a format suitable for the OpenAI API.
(2) API inquiry (Query Function): The OpenAI chat model is queried using the processed message.
(3) Response processing and message generation (Generator): The response from the API is analyzed, and a message to be returned to the user is generated and processed.
(4) Storage in executor and response return: The generated message is stored in the executor and returned as the final response. This series of processes enables efficient generation and provision of appropriate responses using OpenAI functions based on user input.

The AI Model Helper builds query functions that tune models using datasets processed by the Message Creator based on the code of the AI Model Helper and AI Model Helper Repository, and also query functions using embedding models. These are registered in the AI Model Helper and become usable for matching with chests (data containers) afterward. In addition, by returning the registered model name as a response, the system clearly informs the user about the model usage status. This function enables users to customize AI models using their own data and improve overall system performance and response accuracy. Facilitating model registration and reuse is expected to enhance development efficiency and simplify maintenance. Also, by reinforcing feedback to users, a better user experience is provided.

The detailed functions of the AI Model Helper are as follows:
(1) Dataset processing by Message Creator: User inputs or messages in chests are collected and formatted into a format suitable for model tuning. Preprocessing such as text data cleaning, tokenization, and filtering is performed.
(2) Building query functions for model tuning: Using the processed dataset, existing AI models are tuned for specific tasks or domains. The model tuning process is asynchronously executed in the chest flow execution controller.
(3) Building query functions using embedding models: Embedding vectors are generated from datasets and used for advanced information retrieval or similarity calculation. The embedding model expresses semantic relationships of words or sentences as numerical vectors.
(4) Registration in AI Model Helper: Tuned models and embedding data are stored in the database as AI Model Helpers. They are managed with model identifiers, related properties, owner information, etc.
(5) Model use and response generation in chests: Registered models become callable from query functions in chests. Model names or identifiers are returned as responses to clarify processing results.

The detailed flow of the AI Model Helper follows the six steps below:
(1) Dataset preparation: Message Creator collects user input and information from existing chests as messages and creates a dataset. If necessary, tagging and classification are added to format it for model learning.
(2) Model tuning: A query function receives the dataset and starts model training. Model parameters and hyperparameters are dynamically set through properties.
(3) Embedding vector generation: Another query function generates embedding vectors from the dataset. Generated vectors are stored in the database and used for similarity search and others.
(4) Model registration: Tuned models and generated embeddings are registered as AI Model Helpers. Metadata and related information are stored together.
(5) Model application in chests: Registered models are invoked from other chests or AI query functions. By specifying model names or identifiers, processing using specific models is enabled. Registration information in the AI Model Helper is also used for model selection in AI queries. Model behavior is adjusted by specifying parameters and properties.
(6) Response to user: After model registration is completed, the model name or ID is returned to the user. This allows the user to confirm that the model based on their data is available for use.

The features are as follows:
(1) Custom model building: By tuning models with user-specific datasets, more appropriate responses and results can be obtained.
(2) Model reusability: Once registered, models can be reused by other chests or functions, enabling efficient system operation.
(3) Dynamic property setting: Model settings can be flexibly changed through properties to accommodate diverse needs.
(4) Enhanced user experience: Returning model names as responses helps users intuitively understand system behavior.
(5) Integrated data management: Centralized management of models and related data ensures data consistency and integrity.

<Detail of flow incorporating Google search>

### <Message Creator>

Extract Google Search Message Creator extracts keywords or URLs from messages in chests and processes them into a format usable in subsequent query functions. The detailed flow consists of the following four steps:
(1) Property acquisition: The type of data to be extracted (keywords or URLs) and other conditions are obtained from properties. Specifically, properties like isSelectKeywords and isMergeContent are used.
(2) Message extraction and filtering: According to specified conditions, messages containing keywords or URLs are selected from messages in chests. For example, if isSelectKeywords is true, messages with the data type “keyword” are filtered.
(3) Message integration and processing: If isMergeContent is true, the content of multiple extracted messages is integrated into a single text data. The result is stored in MessageCarrier for use in subsequent processing.
(4) Storage of results: The processed data is stored in Function Results and passed to the query function.

In the query function, Google Search Query performs Google searches using the received keywords, retrieves results, specifies URLs, and analyzes the target web pages. The detailed flow consists of the following four steps:
(1) Keyword acquisition: Keywords and URLs are extracted from Function Results passed from the Message Creator.
(2) Search parameter setting: Settings such as the maximum number of search results are obtained from properties like maxResults.
(3) Execution of Google search: Google API is used to perform the search with the obtained keywords. Required information such as links and snippets is extracted from the results.
(4) Result formatting: Search results are formatted into a specified structure and stored in queryResult of Function Results.

In the generator, Extract Google Search Message Generator generates response messages based on search results from the query function. The detailed flow consists of the following five steps:
(1) Search result acquisition: Search results are retrieved from Function Results passed from the query function.
(2) Message generation: Individual messages are generated based on each search result. Each message includes information such as title, link, and content.
(3) Message processing and tagging: If necessary, message content is processed and specific tags are added. Messages are formatted for appropriate display to the user.
(4) Message data creation: The generated messages are created as Message Data objects and stored in the executor.
(5) Response return: The executor's state is updated, and the messages are returned to the client as the final response.

The features of the flow incorporating Google search are as follows:
(1) Flexible data extraction: Keywords and URLs can be dynamically extracted by the Message Creator to support various search queries.
(2) Real-time information acquisition: Using Google search enables provision of the latest information to users.
(3) Customizable search: Number of search results and information to extract can be controlled via properties to meet user requirements.
(4) Structured data management: Search results are handled in a unified data structure, facilitating subsequent processing and display.
(5) Thorough error handling: Potential errors in each step are appropriately captured and handled to improve system reliability.

The overall flow incorporating Google search is summarized in the following four steps:
(1) Extraction of keywords or URLs (Message Creator): Keywords or URLs required for search are extracted from user input or messages in chests.
(2) Execution of Google search (Query Function): Search is performed using the extracted keywords, and results are obtained.
(3) Message generation from search results (Generator): Messages for user presentation are generated and processed based on the search results.
(4) Storage in executor and response return: The generated messages are stored in the executor and returned to the client as the final response. This series of processes enables effective information provision based on user input by utilizing real-time search results.

Regarding query processing, the provided code shows that the four main files for query processing and their relationships are as follows:
(1) QueryFunctions.scala: Defines main query functions and calls other query-related functions.
(2) OpenAIMessageHelper.scala: Handles message processing and formatting, and links to the OpenAI API.
(3) OpenAIService.scala: Manages communication with the OpenAI API, executes queries, and retrieves results.
(4) SystemMessages.scala: Defines templates for system messages and manages instructions for models.

The functions of QueryFunctions.scala are as follows:
(1) Definition and implementation of query functions: Defines the abstract class Query Function as the core of query processing, and implements concrete query functions inheriting it.
(2) Coordination with other functions: Possesses query functions that link to external services such as the OpenAI API and Google Search, and calls other service classes and helper classes in the process.
(3) Management of query execution flow: Manages the input, processing, and output steps of queries in an integrated manner to enhance reusability and extensibility.

The flow of QueryFunctions. scala consists of four steps. The first step is the definition of the abstract class for the Query Function. This class serves as the base for all query functions and contains four common properties and one method. The four properties are:
(1) properties: defines parameters required for query execution;
(2) messageTags: defines tags to be applied to messages;
(3) typeName: a name identifying the type of the query function;
(4) creatorResultType and queryResultType: indicate the data types of the input and output of the query, respectively.
   The common method is query: an abstract method in which each query function implements its specific processing.

The second step is the implementation of specific query functions. These are classes that inherit from Query Function and implement various query processing. Standard OpenAI Chat Query generates responses to user messages using OpenAI's chat API by assembling messages and setting parameters, and then calling the API via OpenAI Service. Google Search Query uses Google's search API to retrieve search results based on specified keywords and formats the results for use in subsequent processing.

The third step is the invocation of external services. As needed within a query function, other services and helper classes are called. OpenAI Service is used when communicating with OpenAI's API. OpenAI Message Helper performs message formatting and tagging. Query Helpers assist in message extraction and transformation processing.

The fourth step is execution of the query and retrieval of results. In the query method of a query function, processing is performed using necessary properties and messages, and the response or result from the external API is received and returned as FunctionResults. The result is then used in the next processing step or for response generation.

The features of QueryFunctions. scala are as follows:
(1) Extensibility and reusability: New query functions can be easily added by using Query Function as the base class.
(2) Modular design: Each query function is implemented independently, enabling clear coordination with other functions or services.
(3) Seamless integration with external services: External APIs such as OpenAI and Google are effectively used to provide advanced query processing capabilities.

The functions of OpenAIMessageHelper.scala are as follows: (1) Message processing and tagging: Applies necessary tags to messages and formats the content. (2) Message format generation for OpenAI API: Converts messages into the format required by OpenAI's API. (3) Addition of system messages: Retrieves system messages from SystemMessages and adds them to the beginning of the message sequence.

The flow of OpenAIMessageHelper. scala consists of five steps: (1) Message collection and integration: Messages are collected from multiple Message Data and combined into a single list. (2) Message filtering: Only the required role types (e.g., System Message, user, assistant) are extracted. (3) Tag application and content formatting: Tags are applied to each message, and the content is formatted. (4) Conversion to OpenAI format: Role types are converted to conform to OpenAI API specifications, and JSON-format message objects are generated. (5) Addition of system messages: System messages obtained from SystemMessages are added to the beginning.

The features of OpenAIMessageHelper.scala are:
(1) Flexible message processing: Through tagging and filtering, the content and format of messages can be flexibly controlled.
(2) Output of debugging information: Debug information is output at each processing step, facilitating development and troubleshooting.
(3) Enhanced integration with OpenAI API: Messages are formatted in accordance with OpenAI's expected format to ensure smooth integration.

The functions of OpenAIService.scala are as follows:
(1) Communication with OpenAI API: Communicates with OpenAI's chat API and function call API to execute queries.
(2) Construction of API requests: Constructs HTTP requests including necessary headers and body.
(3) Response processing: Receives and appropriately parses responses from the API.

The flow of OpenAIService.scala consists of five steps:
(1) Retrieval of API key: Obtains the OpenAI API key from the configuration file.
(2) Construction of HTTP request: Constructs a request including the specified model, parameters, and message.
(3) Sending request to API: Asynchronously sends the request and awaits the response.
(4) Error handling: Appropriately handles errors occurring during the request or response.
(5) Parsing and returning the response: Parses the response body and extracts necessary information.

The features of OpenAIService.scala are as follows:
(1) Asynchronous processing: Requests and responses are handled asynchronously to optimize performance.
(2) Versatility: Supports multiple endpoints including not only the chat API but also function calls and file uploads.
(3) Secure data storage: Stores requests and responses in databases or logs for later analysis or tracing.

The function supporting function output in AI processing of OpenAIService.scala is to detect proposed function calls in model responses, invoke the function, obtain the result, define available functions, and allow the model to recognize them. First, function call detection is performed by parsing the OpenAI API response to detect the function_call field. Then, based on the specified function name and arguments, the corresponding function is executed. After that, the execution result is provided to the model to continue generating a response, and finally, the final response is obtained from the model and provided to the user. OpenAIService.scala allows for more precise and dynamic responses through function calling by the model and enables expansion of the model's capabilities by adding new functions.

SystemMessages.scala provides templates for system messages and defines guidelines for instructions to the model and output format. It manages messages to enable consistent communication with the model. To regulate output format, it clearly instructs the output format expected by the model to prevent unexpected output. It also offers flexibility to expand or modify system messages as needed to accommodate new requirements. The flow of SystemMessages.scala consists of two steps: (1) Definition of constants: Defines basic chat query message and response message templates as strings. (2) Usage from other classes: These system messages are referenced from classes such as OpenAI Message Helper and incorporated into the message sequence.

The query processing system centered on QueryFunctions. scala achieves high extensibility and reusability through abstraction and modularization. By using Query Function as the base class and implementing specific query functions individually, linkage with external services and addition of new functions becomes easier. Through coordination with OpenAI Service and OpenAI Message Helper, OpenAI's API is effectively utilized to provide advanced AI capabilities. Communication with the model is optimized via system messages and message tagging, providing high-quality responses to users. Including support for function output, the system is designed with flexibility and extensibility to accommodate future requirements and technological advancements.

In this system, data exchange and state management between chests and between functions are performed by utilizing tags and properties. In particular, the MessageData.scala file implements a series of processes such as definition, storage, propagation, evaluation, and application of tags and properties. Definition and management of tags and properties include: Definition of message tags: Specifies name, data type, default value, and value range of each tag, determining the specifications of tags shared among messages and functions. Definition of properties:

Specifies name, data type, default value, value range, and display control, which are settings used to control the behavior of functions and generators.

The roles of GlobalIdentifier are as follows:
(1) Global Identifier Definitions Mapping (Definition and Management): The Global Identifier Definitions Mapping maps tags and properties to global identifiers. This prevents tags or properties with the same identifier from having different definitions. (Consistency Maintenance): Global identifiers are used to manage tags and properties to maintain consistency across multiple functions and messages, ensuring data integrity across different components.
(2) Integration and Validation of Definition Information (Definition Integration): Definition information with the same identifier is integrated for consistent management, preventing discrepancies. (Conflict Validation): Validates whether there are contradictions between definition information and global identifiers, particularly requiring that message types and value ranges be consistent.
(3) Management of Tag and Property Values (Value Retention and Propagation): Global MessageTags retain values of tags shared across the application, enabling data sharing between chests. (Value Conversion and Application): Values of tags and properties are converted and applied using the Global Identifier Definitions Mapping, enabling dynamic control during message and function execution.

The characteristics of GlobalIdentifier are as follows:
(1) Flexibility and extensibility: Using global identifiers allows for flexible control of processing and easy expansion of functionality.
(2) Consistency maintenance: Using global identifiers ensures overall consistency while enabling appropriate operation of individual functions and messages.
(3) Dynamic control: Processing can be dynamically altered based on the values of tags and properties, enabling flexible responses to user input or results of other functions.
(4) Data sharing and propagation: Through Global Message Tags, data sharing and state propagation between chests can be seamlessly performed.
(5) Global Identifier Definition Mapping: Tags and properties are mapped to global identifiers to maintain consistency across multiple functions and messages. For properties, the mapping is referred to as Global Property Definition Mapping, used for integrating properties within the same message helper.

Details on the retention and propagation of tag and property values are as follows:
(1) Value Items: Retain values of tags and properties associated with each function. These hold function IDs and value maps, and propagate values during execution.
(2) Value Tag List: Aggregates multiple Value Items With Function Data Id and manages tag and property values uniformly during processing. Used in relation to function execution conditions and processing tags.
(3) Message Tags: Tags stored in a Message's tags describe processing details of the corresponding message for a function. When a function modifies a tag value during processing, the modified value is stored in this updated tag list.
(4) Global Message Tags: Retain values of tags shared across the application, managed as key-value maps, enabling data sharing between chests. When a message with global tags is received by a receiving chest, if a corresponding Global Identifier Definition Mapping exists, the tag values are distributed and applied to each tag. This allows detailed argument correlation between functions in chests connected in the flow.
(5) Global Properties: Retain values of properties applied uniformly via user input on the front end. Managed as key-value maps, they allow data sharing between chests. When a message with global properties is received and a corresponding Global Identifier Definition Mapping exists for the receiving property definition, the values are distributed and applied to each property. For example, if multiple AI inquiry functions in a function list share the same response limit, that property can be defined as a global property and unified via user input.

During execution of messages and functions, specific processing needs to be performed based on current tag and property values. This includes processing executed when tag values satisfy specific conditions, or dynamically changing message content based on tag values.

In the Chest Executor Services class, tag processing is responsible for evaluating tags included in message data and converting them into appropriate formats to prepare necessary data for chest execution. In particular, the convert Message Tag To Index Sequence method and the evaluate Message Tags method play central roles.

The purpose of the Convert Message Tag To Index Sequence method is to receive a list of message data, evaluate the tags of each message, and classify and convert them into modification tags and value tags. The final result is a return of the transformed message data and tag list. The processing flow consists of five steps:
(1) Tag Definition Integration: Common tag definitions are added to the passed tag definition argument to create a merged tag definition, ensuring that all tags are evaluated based on consistent definitions.
(2) Tag Evaluation for Each Message: The evaluate Message Tags method is called for each message to evaluate tags. The result includes modification tags and value tags.
(3) Message Update: The message data is updated using the evaluated modification tags.
(4) Tag List Generation: All value tags are aggregated to generate a Value Tag List for unified management.
(5) Return of Result: The updated message data list and generated Value Tag List are returned.

The purpose of the Evaluate Message Tags method is to evaluate the tags included in message data and classify them into modification tags and value tags. The processing flow consists of five steps:
(1) Tag Evaluation: If message tags are Global Message Tags, tag key-value pairs are evaluated based on tag definitions, and classified into respective lists as either modification tags or value tags.
(2) Extraction of Modification Tags: Based on the tag definition, modification tags are extracted.
(3) Extraction of Value Tags: Similarly, value tags are extracted.
(4) Return of Result: The extracted lists of modification tags and value tags are returned.
(5) Distribution of Existing Tags: If message tags are Seq [Value Items With Function DataId], all tags are classified into both modification and value tag lists.

Evaluated tag values are applied to message data and function properties, enabling dynamic control of message content and function behavior. Use of tags and properties in functions and generators constitutes function data, holding necessary information for definition and execution of each function. This includes definitions and types of tags and properties, function types, and execution order. Additionally, in message creators or generators, tag and property values are used to generate messages or process data. Message content and format can be altered based on property values, and processing branches based on tag values.

The integration and update of tags and properties are characterized as follows:
(1) Integration of Definitions: Definitions of multiple tags and properties are integrated for consistent management, preventing different definitions for the same identifier.
(2) Update and Propagation of Values: During function execution and message processing, tag and property values are updated. These updated values are propagated to other related functions or messages, affecting overall behavior. The characteristics of tag and property processing are as follows:
(1) Flexibility and extensibility: The mechanisms of tags and properties allow flexible control of processing and easy expansion of functionality.
(2) Consistency maintenance: Using global identifiers and definition mappings ensures overall consistency while enabling appropriate operation of individual functions and messages.
(3) Dynamic control: Processing can be dynamically changed based on the values of tags and properties, enabling flexible responses to user input or results of other functions.
(4) Data sharing and propagation: Through Global Message Tags and Value Tag Lists, data sharing and state propagation between chests can be seamlessly performed.

In conclusion, the tag and property processing mechanisms centered on MessageData.scala serve as the core of data flow and processing logic in the application. These mechanisms enable complex processing and dynamic behavior, providing advanced functionality.

The functional descriptions and processing flow of tag and property processing are as follows. The relevant code in the specified files is analyzed to clarify their functions and overall flow. Tags and properties play a critical role in the flow of data and dynamic control of processing in the system. The main functions are as follows:
(1) Definition and management of tags and properties: Message Tag Definition and Property Item Definition are classes for defining message tags and properties. They specify names, data types, default values, value ranges, etc. Global Identifier Definitions Mapping maps multiple tags and properties to global identifiers and manages them centrally, enabling shared use across different functions and generators.
(2) Retention and propagation of tag and property values: Value Items With Function Data Id retain values of tags and properties associated with each function. They have function IDs and value maps and propagate values during execution. Value Tag List aggregates multiple Value Items With Function Data Id and manages tag and property values uniformly. It maintains change histories and supports merging and updating.
(3) Tag evaluation and application functions: evaluate Message Tags evaluates changes or new values to be applied to messages based on tag definitions and current values. Processing is performed depending on the tag type (e.g., value replacement or message change). Convert Message Tag To Index Sequence applies evaluated tags to message data and generates the last message sequence.
(4) Use of tags and properties in functions and generators: FunctionData holds information about each function, including definitions of tags and properties needed at execution. QueryFunction and Generator generate or transform data using tags and properties. Dynamic behavior is controlled through properties, and tag-based results propagation or branching is performed.
(5) Integration and update of tags and properties: FunctionData.combinePropertyDefinition and FunctionData.combine TagDefinition integrate definitions of multiple properties or tags, enabling a single function to have multiple properties or tags.

Message Helper Service integrates new function definitions with existing tag and property definitions to maintain consistency. The processing flow consists of the following four steps:
(1) Addition of functions and integration of definitions: When a new function is added, Message Helper Service integrates its property and tag definitions with the existing ones. Function Data definitions are added to the message Helper Properties or tag Inventory of the helper.
(2) Evaluation of tags and application to messages: Within Chest Executor Services, evaluate Message Tags is called to evaluate message tags. Based on the evaluation results, convert Message Tag To Index Sequence generates message data.
(3) Update and propagation of tag and property values: During function execution, tag and property values are updated. These updated values are propagated to other functions or generators through the Value Tag List.
(4) Integration of results and generation of last messages: Results from functions or generators are integrated with tag and property information, and last message data is generated reflecting all tag evaluations and property settings.

The processing of chest groups, particularly in selecting and executing chests and transitioning to chest flows, is analyzed and summarized with their functions and processing flow. The relevant files and classes include:
(1) ChestGroups.scala
(2) Chest flows.scala
(3) MessageData.scala
(4) ChestExecutionService.scala
(5) FieldObjectService.scala

The role of ChestGroups.scala is to group multiple chests to share a sequence of processing and message tags. The main attributes are as follows:
(1) groupChestId: ID of the chests in the group.
(2) currentIndex: Index indicating the order within the group.
(3) baseChestSequence: Flag indicating whether it is a base chest sequence.
(4) messageTags: Message tags shared by the group.
(5) messageTagDefinition: Definition information of the message tags.

Chest flows.scala manages data flow and dependencies between chests. The main attributes are as follows:
(1) instructionType: Flow instruction type (e.g., “normal,” “base,” “precede”).
(2) expressionType: Expression type of the flow (e.g., “expression,” “hidden”).
(3) isReference: Flag indicating whether it is a reference flow.
(4) sourceId: ID of the source chest of the data flow.
(5) targetId: ID of the target chest of the data flow.
(6) messageTags: Message tags associated with the flow.

MessageData.scala is a data structure for storing messages and data exchanged between chests, and its main attributes are two: messages (a list of messages) and message tags (tag information associated with the messages).

The main methods of ChestExecutionService.scala are as follows:
(1) map Group To Flow, the purpose of which is to generate a chest flow based on chest group information; the processing content is to configure the flow according to the chest type (e.g., “map,” “yield,” “split,” “reduce”), set the instruction type of the flow, message tags, and message indexes for each chest group, and, if there are additional source chests, to generate the flow including those;
(2) set Flows To Messages, the purpose of which is to prepare message data based on the given chest flow; the processing content is to obtain the latest message from the source chest of each flow, apply the message tag of the flow, update the tag if necessary, and collect it as message data only when the message is not empty.

The main method of FieldObjectService.scala is update Group Message Tags, the purpose of which is to update the message tags of the specified group; the purpose of update Flow Message Tags is to update the message tags of the specified flow; and the purpose of Select Chest is to select a chest and add it to or update it in the chest group, with the processing content being to check whether the specified chest already exists in the group, create a new chest group if it does not, and group the source chest as well if necessary.

The detailed processing flow is described below: first, chest selection processing is performed; when a chest is selected by the user, the select Chest method is called, and it is checked whether the target chest is included in an existing group; if it is not included, a new chest group is created and the chest is added; then, if the apply To Source Chests flag is enabled, the related source chests are also subject to grouping.

Next, conversion to a chest flow is performed; using the map Group To Flow method, a chest flow is generated from the chest group information, and according to the chest type, the instruction Type of the flow and the isReference flag are set; if additional source chests are specified, flows are also generated for them.

Next, message preparation for chest execution is performed; using the set Flows To Messages method, message data necessary for execution is prepared based on the chest flow, messages are obtained from the source chests of each flow, and necessary tag information is applied; only flows whose isReference flag is false are targeted for messages.

Next, chest execution is performed, and the flow is as follows:
(1) Execution of sequence: using the execute Sequence method, the specified sequence chest and its child chests are executed sequentially; unfinished child chests are identified and individually executed using the execute Sequence Child method;
(2) Execution of individual chests: using the execute Sequence Child method, individual chests are executed; the necessary message data is prepared and execution is performed using the execute Chest method; the execution result is saved in the chest and the state is updated.

Finally, message tag updating is performed; using the update Group Message Tags and update Flow Message Tags methods, the message tags of the chest group and chest flow are updated, and the tag updates are reflected at the time of message preparation and chest execution.

To summarize the overall processing flow, it is as follows:
(1) Chest selection: the user selects a chest, and if necessary, a chest group is created or updated;
(2) Chest flow generation: based on the chest group information, a chest flow is generated using the map Group To Flow method;
(3) Message data preparation: message data is prepared according to the chest flow using the set Flows To Messages method;
(4) Chest execution: the sequence chest and its child chests are executed sequentially using the execute Sequence method;
(5) Result saving and state update: the execution result of the chest is saved and the state is updated to “completed.”

In this system, chest groups and chest flows are utilized to manage data flows and dependencies between chests, and the series of processes from chest selection to execution is implemented by various services and model classes, enabling flexible processing using message tags and definition information.

The following describes a detailed analysis of the processing flow from the selection of chest groups to the execution of chests, where the main related elements are three model classes-Chest Group, Chest Flow, and Message Data—and two service classes-Chest Execution Service and FieldObject Service—and this section explains in detail how these classes and methods interact to realize the process from chest selection to execution.

First, chest selection and chest group updating are explained; here, the user selects a specific chest via the chest flow configuration GUI processor, and this action invokes the select Chest method of the Field Object Service in the chest flow execution controller; in the processing of the select Chest method, the specified chest is retrieved from the database using the given chestId:
(1) Confirmation of group information: it is confirmed whether the chest is already included in a chest group;
(2) If it does not exist: a new Chest Group object is created, the Group ChestId is set to the selected chest's ID, the Current Index is set based on the maximum index value in the project (e.g., max+1), and the new chest group is saved to the database using the Chest Group Repository;
(3) If it does exist: the current group information is updated and base designation is performed—if it is already designated as base, the chest group is deleted and de-grouped—and the baseChestSequence flag is updated, etc.;
(4) Application to source chests: if the applyToSourceChests flag is true, source chests related to the selected chest are also grouped, which includes retrieving chests that provide input to the selected chest (preceding chests) and adding them to the chest group.

Next, chest flow generation is explained; here, to generate a chest flow, all chest group information in the project is retrieved using a method of the chestGroupRepository, and then, in the processing of the mapGroup ToFlow method, the mapGroupToFlow method of the ChestExecutionService generates a chest flow from the chest group information:
(1) Initialization of flow: for each chest group, a Chest flow object is created, and the attributes of the flow are set based on the chest type and group information;
(2) Attribute setting: instructionType: if the chest type is “map,” “base” or “normal” is set depending on whether it is a base sequence; for other types, appropriate values are set; expressionType: normally set as “expression”; isReference: set to true if the chest type is “map,” “split,” or “yield,” otherwise set to false; messageTags and messageTagDefinition: use those of the chest group;
(2) Additional flow processing: if additional source chests are specified, flows for them are also generated, and message indexes and tag information are appropriately set;
(3) Filtering and formatting of flows: unnecessary flows (e.g., those with instructionType “delete”) are removed, and message indexes are adjusted for consistency;
(4) Setting of message tag definitions: a unified message tag definition is set for the flow using a method of the unifiedChestRepositoryService.

Next, preparation of message data is explained; the setFlows ToMessages method of the ChestExecutionService prepares the message data necessary for chest execution based on the generated chest flows, and for each flow, the following processing is performed:
(1) Retrieval of source chest: the source chest is retrieved using the sourceId of the flow;
(2) Generation of message data: this is processed only when the isReference flag of the flow is false; the latest message of the source chest is retrieved, the message tag is updated or added based on the messageTags of the flow—for example, the value of the instructionType of the flow is set to the tag “sourceMessage”—and a MessageData object is created using the retrieved message and updated tag;
(3) Collection of message data: message data generated in each flow is collected to form an overall message data list;
(4) Filtering: only non-empty messages are retained in the list.

The following explains chest execution; in the execution of a sequence, the following processing is performed:
(1) Identification of sequence chest: the chest to be executed is retrieved using the sequence chest ID;
(2) Identification of child chests: child chests related to the sequence chest are retrieved, and unfinished child chests (those not in “completed” state) are identified;
(3) Partial execution: all unfinished child chests are sequentially executed using the executeSequenceChild method.

In the execution of individual chests, the following processing is performed:
(1) Retrieval of chest and related flows: the chest and its targeted flows are retrieved based on the specified chest ID;
(2) Preparation of message data: message data based on the flow is obtained using the setFlows ToMessages method;
(3) Execution of chest: the chest is executed using the executeChest method, in which queries are processed using a message helper and responses are obtained;
(4) Result saving and state update: the execution result is saved to the chest, and the state is updated as necessary (e.g., changed to “completed”).

In the execution of chests, the following processing is performed:
(1) Retrieval of message helper: the message helper associated with the chest is retrieved;
(2) Creation and execution of executor: a chest executor is created using the chestExecutorService and the process is executed;
(3) Retrieval of execution result: the execution result (lastMessage) of the executor is retrieved and, if necessary, converted into a response format;
(4) Error handling: if an error occurs during execution, appropriate logs are output and the error is handled.

In the message tag update stage, the following two updates are performed:
(1) Update of message tags of the group: the message tags of the specified group are updated using the updateGroupMessageTags method of the FieldObjectService, and the updated message tags are used in subsequent message data preparation and chest execution;
(2) Update of message tags of the flow: similarly, the message tags of the flow are updated using the updateFlowMessage Tags method.

Next, the relationships and interactions between classes are explained; among ChestGroup and Chest flow, ChestGroup is used to group chests and assign common message tags and definitions, and Chest flow is generated based on chest group information using the mapGroupToFlow method, where information from the chest group (chest IDs, message tags, etc.) serves as input at the time of flow generation, and the flow defines the data flow between chests within the group.

Among Chest flow and MessageData, Chest flow defines the data flow and dependencies between chests, and message data is prepared based on the chest flow using the setFlows ToMessages method; also, messages are retrieved from the source chest using the sourceId of the flow, and the message tags of the flow are applied to the message data.

In MessageData and chest execution, MessageData is used as the input data required at the time of chest execution; it is processed by the message helper and executor, and the execution result is obtained; in the executeChest method, a query is executed using MessageData, and the result is saved again to the chest as message data.

Finally, the overall processing flow is explained:
(1) Chest selection: the user selects a chest, and the chest is added to or updated in the chest group;
(2) Retrieval of chest group information: chest group information in the project is retrieved;
(3) Chest flow generation: chest flows are generated from the chest group information using the mapGroupToFlow method;
(4) Message data preparation: message data is prepared based on the chest flow using the setFlows ToMessages method;
(5) Chest execution: sequence chests and their child chests are executed sequentially, and each chest is processed using the executeChest method;
(6) Result saving and state update: the execution result is saved to the chest, and the chest state is updated (e.g., to “completed”);
(7) Update of message tags as needed: message tags of chest groups and flows are updated.

This detailed analysis has examined each step from chest selection to execution; a chest group is a collection of chests with shared message tags and definitions, a chest flow defines data flows and dependencies between chests, and message data is the input data required for executing a chest, prepared based on the flow; chest execution is performed using message helpers and executors, and the result is saved; by linking these elements, a flexible and highly extensible chest processing flow is realized.

The following explains the analysis and details of the chest stream function; the chest stream function is called from the field screen and allows the user to view summary information of the selected chest object in stream format; the user can confirm important information of multiple chests on a single screen, enabling efficient information organization and access, and summary information of AI chests and related chests can be viewed in stream format through a chat-like interface; the displayed information can also be collectively downloaded as a file.

The functions are as follows:
(1) Chest summary display function: major information such as the title, query, response, creation date, update date, and message tags of the chest is displayed in a list;
(2) Stream-format interface function: information is provided in a scrollable list format, allowing intuitive user operation;
(3) Access to detailed information: quick access to detailed information or editing screens is possible from each chest summary;
(4) Filtering and sorting: information can be narrowed down based on message tags or chest types, allowing the user to quickly find necessary information.

The system flow is explained below: first, data retrieval is performed; the user launches the chest stream on the field screen, and the ChestStreamController of the chest flow execution controller receives the request and checks the current project ID; then, related chest group and chest data are retrieved from the database via the ChestStream RepositoryService.

Next, data processing is performed; for each retrieved chest, the chest type (e.g., reduce, map, split) is identified, and data is constructed along with appropriate display control information according to the chest type; the data is formatted into a ChestStream Display object so that it can be easily handled by the chest flow configuration GUI processor.

Next, display in the chest flow configuration GUI processor is performed; the ChestStream.js component of the chest flow configuration GUI processor receives the data and renders it in stream format; each chest is displayed in a card format, and the user can scroll to browse the information; if necessary, the user can click on a chest to access detailed information or editing functions, and detailed information is displayed in a modal window (a small window that restricts operation of the original screen); the summary information of the chest stream can also be downloaded as a file.

Finally, responses to user operations are performed; when the user edits or views the details of a chest, a modal window is displayed; the edited contents are sent to the chest flow execution controller via handlers within Projects.js, and the database is updated; the update results are reflected in real time in the stream.

The characteristics of the chest stream function are as follows:
(1) Intuitive user interface: information between chests can be browsed seamlessly through stream-style display;
(2) Efficient information management: important chest information can be centrally checked, making it easier to understand the overall project structure;
(3) Dynamic data updating: additions, updates, and deletions of data are reflected in real time, always keeping the latest information;
(4) Flexible extensibility: the design supports the addition of new chest types and display elements.

The following three points should be considered regarding the chest stream function:
(1) Performance optimization: when handling a large amount of chest data, appropriate data retrieval and rendering optimization is necessary;
(2) User experience: enhancing filtering and sorting functions is important so that the user can quickly access needed information;
(3) Data consistency: accurate synchronization of data between the chest flow configuration GUI processor and the chest flow execution controller is required to prevent display inconsistencies.

The chest stream function is a powerful tool that allows users to efficiently browse and manage chest information within a project; the flexible data retrieval in the chest flow execution controller and the intuitive display in the chest flow configuration GUI processor enhance the user experience, and future feature expansions and optimizations are expected to achieve a more convenient system.

The following describes the component structure and functions of the chest form; the chest form is a main component for displaying and editing details of a chest (a unit of data processing), and it is used when a user inputs or edits chest information and incorporates it into a data flow; below, the structure and functions of the chest form and its related components are described in detail.

ChestForm.js is a form component for displaying and editing detailed information of a chest, through which the user can edit the title, type, message helper selection, query, response, and other attributes of the chest.

The main functions of ChestForm.js are as follows:
(1) A chest basic information input function that allows the user to enter or select the title and chest type (reduce, map, yield, split, etc.);
(2) A message helper selection function to choose an appropriate one from available message helpers and set the message format;
(3) A query message editing function to edit the content of a query in detail using the MessageEditor component;
(4) A function to display and edit the response content also using the MessageEditor;
(5) A file association function to select and manage files related to queries or responses using the FileCarrierSelectorContainer if necessary;
(6) A global property setting function to configure properties and identifiers used across the chest via GlobalValueForms;
(7) A function to display, edit, and set the chest state and test number;
(8) A save/cancel function to either save the user's input or cancel the editing in progress.

The following explains MessageEditor.js; MessageEditor.js is a component used to edit message content, and it is used when editing queries and responses and supports various input formats.

The main functions of MessageEditor.js include the following:
(1) A dynamic field rendering function that renders appropriate input components according to the field type of the message;
(2) Input support functions for text, numeric, and Boolean values, providing suitable input forms for simple data type fields;
(3) An editor integration function that supports editing of complex data formats by integrating editors such as TextEditor, NotebookEditor, and CSVEditor;
(4) A code editor support function that provides a rich editor using CodeMirror for editing code, markdown, JSON, HTML, and more;
(5) A hierarchical field structure management function that allows appropriate display and editing of nested data structures such as objects and arrays;
(6) A field visibility function that can hide or show specific fields based on user operations and settings.

The following explains the functions of TextEditor.js; TextEditor.js is a component for editing simple text or markdown-formatted text and is used within MessageEditor to support text data input.

The main functions of TextEditor.js are as follows:
(1) A markdown preview function that displays markdown-formatted text in real time;
(2) An editor and preview toggle function that allows easy switching between edit mode and preview mode via buttons;
(3) An integrated prompt holder function that supports the insertion of templates or snippets by invoking the PromptHolderManager via context menu during text editing.

The following explains NotebookEditor.js; NotebookEditor.js is a component for editing notebook-style data, which handles data in JupyterNotebook format and allows adding and editing cells, as well as setting execution ranges and arguments.

The main functions of NotebookEditor.js include the following:
(1) Cell management function that allows adding, editing, deleting, and rearranging code cells and markdown cells;
(2) Notebook metadata editing function that allows setting identifier tags and execution modes (e.g., execute all cells, execute specific ranges);
(3) Execution range setting function that supports partial execution by specifying the range of cells to be executed;
(4) Argument setting function that allows arguments to be configured for use during notebook execution to support dynamic data changes;
(5) Integration of a code editor using CodeMirror to provide syntax highlighting and code completion when editing code cells.

CSVEditor.js is a component for editing data in CSV format; it displays and edits data in table format and is invoked from MessageEditor; its main functions include: displaying data in a table format by loading CSV data and displaying it in rows and columns; editing individual cell values directly; and supporting row addition and deletion to accommodate increases or decreases in data.

FileCarrierSelector.js is a component for selecting and managing files associated with messages, allowing users to upload or select files according to specified file types; its main functions include:
(1) A file selection function that allows the user to select the necessary file from the available files;
(2) A file upload function that allows the user to upload a new file and associate it with a message;
(3) A file download function that allows the selected file to be downloaded locally;
(4) A file removal function that allows disassociating the file from the message.

FileCarrierSelectorContainer.js is a container component for managing multiple FileCarrierSelectors and is used when handling multiple file carriers within a message; its main functions are: receiving multiple file carriers as an array and supporting individual selection and editing; and reflecting batch changes by aggregating changes made in each file carrier and transmitting them to the parent component.

ConditionEditor.js is a component for editing conditional expressions and is used when controlling message processing or flow branching based on conditions; its main functions include:
(1) A function to add new conditions and edit existing ones;
(2) A function to delete unnecessary conditions from the list;
(3) A condition input support function that provides input forms to set tags, value ranges, negation conditions, and so on;
(4) A condition list display function that displays the currently set conditions in list format.

The following explains CreateNotebookForm.js; CreateNotebookForm.js is a form component for creating new notebooks, where the user can enter an identifier tag for the notebook and perform the creation.

The main functions of CreateNotebookForm.js include the following:
(1) A notebook identifier tag input function that allows the user to enter a tag for the new notebook, with automatic generation if not entered;
(2) A draggable window function that allows the form to be repositioned by dragging to improve user operability;
(3) A function to create a new notebook based on the entered content.

The chest form and its related components support the detailed configuration and editing of chests, which are the core of the data processing flow, and each component is clearly separated by role and supports various data formats and functions including text data, code, files, and conditional expressions, enabling users to intuitively construct and manage complex data processing flows.

The following explains the functions of ChestExecutorServices; the ChestExecutorServices class is a service of the chest flow execution controller that manages and controls the execution of chest objects and comprehensively supports the entire execution process of chests, operating particularly based on the controlExecutorProcess method, which serves as the main entry point for controlling the chest execution process.

The main functions of the controlExecutorProcess method are as follows:
(1) A function to convert messages and tags provided by the user into internal formats and adjust them to forms suitable for chest execution;
(2) A function to merge properties from the chest and message helper to consolidate the settings necessary for execution;
(3) A function to create a new executor (execution instance) based on the chest information and prepared data;
(4) A function to obtain a function list from the message helper and execute each function in the defined order;
(5) A function to save the execution results to the database and appropriately handle errors if they occur.

The following explains functionList; functionList is a list of a series of functions (FunctionData) used in chest execution, and complex processing flows are realized by sequentially executing each function.

The execution flow of functionList is as follows:
(1) Initialization: the message provided by the user is received, tags are converted, properties are prepared, and based on the initial data, a new ChestExecutor instance is generated;
(2) Retrieval and sorting of functionList: the functionList associated with the chest is retrieved, and each function data has an index indicating the execution order, based on which the list is sorted;
(3) Execution of each function (loop processing): each function in the sorted functionList is sequentially executed in a loop.

The execution flow of each function described above (loop processing) is as follows:
(1) The condition set for the function is evaluated, and the function is executed only if the current tag value satisfies the condition;
(2) The mergeProperties method is used to merge the function-specific properties with the executor's properties;
(3) The unified properties are divided using the divideTagPropertyValues method into query properties, message creator properties, and generator properties;
(4) Properties are updated based on the current execution environment, such as user ID and project ID;
(5) The convertMessageTagToIndexSequence method is used to parse the message tags and convert them into internal formats;
(6) A message list necessary for function execution is prepared;
(7) A FunctionResults object is initialized to retain the function execution results and state;
(8) The specified message creator is retrieved, and its create method is executed to generate the necessary message;
(9) The specified query function is retrieved, and its query method is executed to perform data retrieval or computation;
(10) The specified generator is retrieved, and its generate method is executed to generate the last message or response;
(11) The execution result, generated message, and updated tag values are reflected in the executor's state, updating functionMessageList, lastMessage, value TagList, and so on;
(12) If an error occurs during execution, it is caught, the executor's isError flag is set, and the error message is retained.

At the end of the execution flow of the functionList, the execution result is saved; the state of the executor is saved to the database and returned as a response if necessary.

The following three auxiliary methods are provided:
(1) convertMessage TagToIndexSequence: this method analyzes message tags and classifies and converts them into modification tags and value tags based on the chest's tag definitions, organizing the message tags into an appropriate format to prepare them for use in chest execution;
(2) mergeProperties: this method integrates the default properties of the function and the properties of the executor, merging default values with user-specified values to prepare the necessary configuration for function execution;
(3) executeFunction: this method executes the specified function and reflects the result in the executor, updating properties and tags, invoking and executing the message creator, query function, and generator, and performing result integration and error handling.

The ChestExecutorServices class oversees the series of processes necessary for chest execution, and its functions are as follows:
(1) a data preparation and transformation function that prepares the data required for chest execution, including messages, tags, and properties;
(2) an execution flow management function that retrieves the functionList and executes each function in the appropriate order and under the correct conditions;
(3) a result integration and saving function that reflects the execution results and updated state in the executor and database;
(4) an error detection and handling function that detects errors occurring during execution and handles them appropriately.

The characteristics of the ChestExecutorServices class are as follows:
(1) Flexible function execution: with functionList, multiple functions can be executed in a flexible order, allowing for complex processing flows and conditional branching;
(2) Control through condition evaluation: by setting a condition for each function, dynamic execution control based on tag values becomes possible;
(3) Utilization of properties and tags: by using properties and tags, data can be shared between functions, and execution settings and state management can be handled;
(4) Modular design: components such as message creators, query functions, and generators are clearly separated, making it easy to add or modify new functions;
(5) Thorough error handling: errors that occur during execution are properly captured and reflected in the executor's state, ensuring a highly reliable system;
(6) Consistency and integrity of data: integrated management of tags and properties maintains the consistency of data.

ChestExecutorServices is an important class that centrally manages the chest execution process, and starting from the controlExecutorProcess method, it efficiently and reliably performs a series of processes including data preparation, integration of tags and properties, execution of each function in the functionList, and saving of results, thereby integrating the data flow and processing logic between chests and improving the overall reliability and scalability of the system.

The executeFunction method plays a key role in the chest execution process by sequentially executing each function data and reflecting the results in the state of the executor, and it integrally manages the series of processes including message generation, query execution, and result generation.

The overall flow of the executeFunction method is explained below:
(1) Merging and splitting of properties: mergeProperties is used to integrate the properties of the function data and the current properties of the executor, and divide TagPropertyValues is used to divide the unified properties into query properties, message creator properties, and generator properties;
(2) Updating properties: each property is updated using current information such as user ID and project ID, using the update TagValuesWithCurrentData method;
(3) Conversion of message tags: convertMessageTagToIndexSequence is used to convert message tags based on the chest's tag definitions, and the converted tags are used to generate a Value TagList;
(4) Arrangement of messages: from the executor's message list, messages and tags related to the current function are extracted and prepared as an arrangedMessageList, and a functionArrangedMessageList is created by organizing the message list for each function;
(5) Preparation of FunctionResults object: a FunctionResults object is initialized to hold the execution result and state of the function;
(6) Execution of message creator: the specified message creator defined in messageCreators is retrieved, and its create method is executed to generate the necessary message data for function execution;
(7) Execution of query function: the specified query function defined in queryFunctions is retrieved, and its query method is executed to perform necessary data acquisition or computation such as calling external APIs or database queries;
(8) Execution of generator: the specified generator defined in generators is retrieved, and its generate method is executed to generate last message data or responses based on the result of the query function;
(9) Updating executor: the generated messages, tags, and function execution results are reflected in the state of the executor, updating functionMessageList, lastMessage, value TagList, and so on;
(10) Error handling: if an exception occurs during execution, it is caught, the isError flag of the executor is set, and the error message is retained.

The relationships with related classes are explained below:
(1) Functions.scala: the FunctionData class retains the definitions and attributes of functions, and within executeFunction, this data is used for merging properties and retrieving function IDs;
(2) MessageCreators.scala: this file defines abstract classes and concrete implementation classes that contain message generation logic, and each message creator has a create method which is called within executeFunction;
(3) QueryFunctions.scala: this file defines abstract classes and concrete implementation classes containing logic for data acquisition or communication with external services, and each query function has a query method which is called within executeFunction;
(4) Generators.scala: this file defines abstract classes and concrete implementation classes containing logic to generate last messages or responses, and each generator has a generate method which is called within executeFunction.

The executeFunction method plays a central role in integrally managing the sequential execution of functions in a chest, performing complex processing step-by-step, including property merging, message preparation, execution of various functions, and integration of results, and by linking with related classes and methods, it realizes a flexible and highly extensible chest execution flow.

The following explains the analysis and functions of the chest generation process; this section analyzes the generation and execution process of objects called “chests,” which are managed and executed by the chest flow execution controller service, and explains their functions; chests have types such as “map,” “yield,” “reduce,” and “split,” each with its own specific processing flow.

First, the chest creation process is explained:
(1) Reception of request and data preparation: a request is received from the client, the initial data in JSON format is parsed, numeric fields are validated, necessary data is deserialized, the message format is retrieved, and the query and response structures are configured;
(2) Project retrieval and state setting: the project associated with the request is retrieved from the database, and the state of the chest is appropriately set based on the mode of the project (e.g., “recalculation”);
(3) Chest creation: different processes are performed depending on the chest type; for “map,” “yield,” and “split” types, the chest is treated as a sequence chest and created using the createChest method, and if necessary, the createSequenceChests method is called to generate multiple child chests of the “reduce” type; for the “reduce” type, the chest is directly created and executed if necessary, the flow is configured, and the chest is registered in the database.

Next, the chest execution process is explained:
(1) Retrieval of flow and preparation of messages: flows associated with the target chest are retrieved from the database, and based on the flow information, messages necessary for chest execution are prepared;
(2) Chest execution: the executeReduce method is used to execute chests of the “reduce” type, the query of the chest is processed using the message helper, results are obtained, execution results are saved as the response of the chest, and the state is updated to “completed”; the executeSplit method is used to execute chests of the “split” type, and if the execution results include multiple responses, new chests are generated for each response, necessary information is set for each generated chest, and the state is updated to “completed.”

Next, the details of specific processes are explained:
(1) createSequenceChests method: for “map” or “yield” type chests, multiple child chests are generated; the process includes retrieving chest groups in the project, retrieving base chests, determining the number of chests to generate, generating child chests corresponding to the number of base chests for “map” or a specified number for “yield,” creating each child chest as a “reduce” type, and configuring the necessary flows.
(2) executeReduce method: executes a chest of the “reduce” type and processes the results; the process includes retrieving the chest and related flow, preparing messages based on the flow information, executing the query of the chest using the executeChest method, obtaining the response, saving the response to the chest, and updating the state to “completed.”
(3) executeSplit method: executes a chest of the “split” type and processes multiple results; the process includes retrieving the chest and related flow, preparing messages based on the flow information, executing the query of the chest using the executeChest method, obtaining multiple responses, generating a new chest for each response, setting the necessary information, and updating the state of the generated chests to “completed.”
(4) executeChest method: the executeChest method executes the specified chest (UnifiedChest) and generates a sequence of responses as a result; the main role of this method is to evaluate the query held by the chest and obtain its result.

The following explains the processing flow of the executeChest method:
(1) Retrieval of message helper: the message helper associated with the chest is retrieved from the database, and the message helper provides the logic necessary for evaluating queries and processing messages;
(2) Creation and execution of executor: the controlExecutorProcess method is called to create a new executor, and this executor performs processing using the query of the chest, the message helper, and the provided messages, and the ID of the executor is generated and used in subsequent processing;
(3) Retrieval of execution results: after execution of the executor, its latest state is retrieved from the database, the last message held by the executor is retrieved, converted into an appropriate format based on the chest's response format, and the converted responses are compiled into a sequence and returned as the final result;
(4) Error handling: if an exception occurs during processing, the error message is output to the log, and an empty response sequence is returned to handle the error.

The executeChest method may perform dummy processing depending on the type and settings of the chest, but it is normally executed according to the above flow, and its main purpose is to correctly evaluate the chest's query and provide the result in a form usable in subsequent processes.

This system manages the entire series of processes from chest creation to execution, and to generation of new chests based on results, and processing by chest type is as follows:
(1) “map”/“yield” types: multiple child chests are generated and processed individually;
(2) “reduce” type: a single chest is executed and its result is processed;
(3) “split” type: when multiple results are obtained, new chests are generated;
(4) State management: depending on the project mode and processing status, the state of the chest is appropriately set and updated, with states such as “wait” or “completed” affecting the chest's processing flow;
(5) Management of flows and messages: flows define the data and processing paths between chests, and messages are prepared based on the flows and used to execute the chest's query.

This chest management system provides a framework for efficiently performing complex data processing and computation, performs appropriate processing based on the chest type, and controls data flow through flows and messages, thereby enabling flexible and scalable processing expected to be applicable to various applications.

The sequence execution process is described below: in the sequence execution process, a sequence of chests is executed and, if necessary, each child chest is processed; this process is performed in coordination among three files: ChestFieldController.scala, ChestFieldService.scala, and ChestExecutionService.scala.

The following explains request reception at the controller: requests from the the controlSequenceExecution method of client are received by ChestFieldController.scala, and this request includes sequenceId (the ID of the sequence chest) and isAll (whether to execute all child chests).

The following explains delegation to the service: the controller calls the controlSequenceExecution method of ChestFieldService.scala, and in this method, the partial execution state (PartialExecutionState) associated with the project is first retrieved, and if the isAll flag is true, the partial execution state is reset; then, the executeSequence method of ChestExecutionService.scala is called to initiate sequence execution.

In the executeSequence method of ChestExecutionService.scala, the sequence is executed in the following steps:
(1) Retrieval of sequence chest and child chests: the sequence chest having the specified sequenceId retrieved from the database, all child chests (ChestSequenceChest) belonging to the sequence are retrieved, and among them, chests that are not yet completed (state not “completed”) are identified;
(2) Selection of partial execution chests: based on the isAll flag, a list of IDs of child chests to be executed (selectedChestIds) is determined, and if isAll is true, all unfinished child chests are included;
(3) Execution of child chests: depending on the type of the sequence chest (e.g., “map” or “yield”), each child chest is executed in order, and execution of child chests is performed using the executeSequenceChild method;
(4) State update of the sequence chest: after all child chests have been executed, the state of the sequence chest is updated to “completed.”

In the processing of the executeSequenceChild method, first the target child chest and related flow are retrieved, then messages are prepared based on the flow, the executeChest method is called to execute the chest, and finally the execution result is saved as the response of the chest, and if necessary, the state of the chest is updated.

The executeChest method plays the role of actually executing the chest; in this method, the message helper associated with the chest is first retrieved, then the controlExecutorProcess method of ChestExecutorServices is called to create and execute a new executor, and finally the execution result (the last message of the executor) is retrieved and returned after conversion to the chest's response format.

As described above, the sequence execution process begins at the controller and proceeds through the service layer to sequentially execute the sequence and child chests, and the controlSequenceExecution method plays a central role in overseeing this entire process, handling both sequence execution and state management.

The following explains the flows and characteristics of each type of sequence execution; in this system, there are three types of sequence execution for chests: “map,” “yield,” and “split,” and each type has its own specific processing flow and characteristics, which are explained below based on code analysis.

The characteristics of “map” type sequence execution are as follows:
(1) Parallel processing of data is possible, contributing to reduction of processing time and enabling independent results per base chest;
(2) One child chest (of “reduce” type) is generated for each base chest;
(3) Each child chest receives data from its corresponding base chest and processes it independently;
(4) Parallel processing is possible, making it effective when applying the same processing to large datasets.

The following explains the procedural steps of “map” type sequence execution:
(1) Retrieval of base chests: base chests are retrieved from the chest group;
(2) Generation of child chests: one child chest is generated for each base chest, and the child chests are created as “reduce” types;
(3) Configuration of chest flow: the instructionType of the flow is set to “base” for base chests and to “normal” for others, and in the flow of the child chest, the ID of the corresponding base chest is set to sourceId;
(4) Execution of child chests: the generated child chests are sequentially executed, and each child chest performs processing using the data from its corresponding base chest.

The characteristics of “yield” type sequence execution are that it is suitable for repeatedly executing the same process multiple times, it is useful for repeated execution of simulations or test cases, it generates the number of child chests specified by the user and performs continuous processing, and it is mainly used for repeating the same process with varying trial counts (each child chest may not be independent).

The procedure of the processing flow of the “yield” type sequence will be explained.
(1) Determination of the number of child chests: The number of child chests to be generated is determined based on the testNumber specified by the user (a default value may be set).
(2) Generation of child chests: The specified number of child chests are generated. The child chests are created as “reduce” type.
(3) Setting of chest flow: In the first child chest, a flow that does not depend on the result of the previous execution is set. From the second child chest onward, a flow using the result of the previous child chest as the source can be set. The instruction Type of the flow is set to “precede” for the first one and “normal” for the others.
(4) Execution of child chests: The child chests are executed sequentially. The result of the previous child chest is used as needed.

The “split” type sequence execution enables dynamic processing based on the content of the data and is suitable for branching of flows and processing distribution based on conditions. Its features are as follows:
(1) Dynamically generating child chests based on the execution result of the sequence chest
(2) Generating and processing each child chest from multiple results obtained at execution
(3) Suitability for data branching processing and conditional branching The processing flow of the “split” type sequence will be explained.
(1) Execution of the sequence chest: The “split” type sequence chest is executed, and multiple responses are obtained.
(2) Generation of child chests: Child chests are generated in a number equal to the obtained responses. The child chests are created as “reduce” type.
(3) Setting of chest flow: For each child chest, a flow using the result of the sequence chest as the source is set. The instructionType of the flow is set to “normal”.
(4) Execution of child chests: The child chests are executed sequentially. Each child chest processes using the corresponding response data.

The three types of sequence executions—“map”, “yield”, and “split”—each have different purposes and characteristics. The “map” type executes individual processing for each base chest and is suitable for parallel processing of large datasets. The “yield” type performs repeated processing for a specified number of times and is suitable for repeated execution of the same process such as tests or simulations. The “split” type performs dynamic branching based on execution results and is suitable for processing distribution and conditional branching depending on data content. By appropriately utilizing these sequence execution types, it is possible to construct a flexible and efficient data processing flow.

The following describes the role and flow of the recalculation function in the chest generation/editing feature. The recalculation function is an important feature that recalculates the result of a chest to reflect changes or updates in the data. Mode management is essential for realizing this feature, and the editChest method and the controlCreateChest method play a central role. Here, how these methods are linked to the recalculation function will be explained.

The controlCreateChest method performs control when creating a new chest. This method appropriately sets the state of the chest and the subsequent processing flow depending on the current mode of the project (normal mode or recalculation mode).

The flow and features of the controlCreateChest method are explained below.
(1) Determination of the project mode: The project is acquired based on the specified project ID, and it is checked whether the mode is “recalculation”.
(2) Setting of chest state: In recalculation mode, the new chest is set to a “wait” state. In normal mode, the chest is created in the default state based on initial data.
(3) Creation of chest: The chest with the set state is created in the database. Additional processing is performed according to the chest type (e.g., “map”, “yield”, “reduce”, etc.) and the auto sequence item generation flag.
(4) Control of additional processing: In normal mode, if the chest type is “map” or “yield”, the createSequenceChests method is called to generate sequence chests. In recalculation mode, the chest remains in the “wait” state and is not executed immediately.

The relation between the controlCreateChest method and the recalculation function is explained below.
(1) Mode management: In recalculation mode, the newly created chest enters a waiting state and is executed at the appropriate timing within the recalculation process that considers dependencies. This allows recalculation to be performed while maintaining data consistency.
(2) Execution delay: In recalculation mode, chest execution is delayed and is managed by the recalculation process.

The editChest method provides a function to edit the information of an existing chest. This method controls the editable fields and processing content depending on whether the mode is recalculation mode.

The flow and features of the editChest method are explained below.
(1) Acquisition of chest: The chest to be edited is acquired by ID.
(2) Determination of mode and editable fields: It is determined whether the mode is recalculation or normal. In recalculation mode, the editable fields are restricted and some attributes cannot be changed.
(3) Update of chest: Only permitted fields are updated. According to the chest type and the auto sequence item generation flag, related child chests and flows are deleted or regenerated.
(4) Reconstruction of flow (if needed): If flow changes are needed, the existing flow is deleted and a new flow is created. Along with the flow update, the states and dependencies of related chests are also appropriately adjusted.

The relation between the editChest method and the recalculation function is explained below.
(1) Control by mode management: In recalculation mode, the content and timing of edits are carefully managed so that the edits do not affect the recalculation process. Restriction of changes to important attributes maintains the integrity of the recalculation process.
(2) Management of dependencies: When editing changes dependencies between chests, flows and related chests are appropriately updated so that the recalculation process functions correctly.

The controlCreateChest method and the editChest method play important roles in the recalculation function through mode management. These methods take the project mode into account when creating or editing chests, and control the recalculation process so that it is executed accurately and efficiently.
(1) Mode management function: Controls chest state transitions and execution timing, and appropriately manages data consistency and dependencies during recalculation.
(2) Integration with the recalculation process: In cooperation with the RecalculationService, recalculation of chests is executed at the necessary timing, ensuring the consistency and integrity of the entire system. A correct understanding and operation of these methods enables effective use of the recalculation function and allows for the delivery of high-quality data processing and results.

The following explains the overview, flow, and features of the template function. The template function is a feature that allows saving and reusing the configuration, data, and structure of a project as a template. Users can create templates from existing projects and reuse them in other projects or generate new projects from templates. Templates include information such as integrated chests, chest flows, chest sequence chests, and message helpers.

The template function allows generating templates from existing projects. It is possible to include the entire project or only specific components, and an option is provided for whether to include the message helper. Templates that are no longer needed can be deleted to facilitate data organization and management. Additionally, the following functions are included:
(1) Creating a new project based on a template: This saves the trouble of configuring data and settings from scratch and allows for an efficient project start.
(2) Import/export of templates: Templates can be exported in JSON format and shared with other users or systems. Templates provided externally can be imported and used in the user's system.
(3) List display of templates: A list of templates owned by the user can be retrieved and displayed to facilitate management and selection.

The following explains the flow of the template function.
(1) Template creation: The user sends a request to create a template. The server extracts the data of the specified project and generates the template content. The template is saved in the database along with its metadata.
(2) Project generation from template: The user sends a request to create a project from a template. The server analyzes the content of the template and generates a new project and related data. If necessary, the message helper is also included in the project.
(3) Template import and export: The user selects an external file and uploads the template data. The server verifies the data and saves it as a template. Furthermore, the user selects a template to be exported and performs the export operation. The server returns the template data in JSON format, which the user can download as a file.

The following explains the features of the template function.
(1) Improved reusability: The template function allows project structures and settings used repeatedly to be easily reused.
(2) Efficient project start: New projects can be launched quickly, improving productivity.
(3) Sharing and collaboration: The export/import function of templates makes it easy to share and collaborate with other users.
(4) Flexible customization: Templates can be created according to needs, such as including or excluding message helpers, or templating only part of a project's components.

The following explains the technical details of the template function. First, the configuration of the chest flow execution controller is summarized.
(1) Model layer: The Template model defines the data structure of the template. It includes fields such as name, content, owner ID, and tags.
(2) Repository layer: The TemplateRepository handles interaction with the database and performs creation, retrieval, update, and deletion of templates.
(3) Service layer: The TemplateService implements business logic and provides functions such as template creation, project generation, and import/export.
(4) Utility layer: The TemplateCreator has the role of generating and analyzing the template content.

Next, the configuration of the chest flow configuration GUI processor will be explained.
(1) Template management screen: The TemplateManager component provides the UI for displaying the list of templates, creating, deleting, importing/exporting templates, etc.
(2) API communication: The chest flow configuration GUI processor calls the API endpoints of the chest flow execution controller to send and receive necessary data.
(3) API endpoints
(4) Template list acquisition: The templates endpoint retrieves the list of templates owned by the user.
(5) Template creation: The/template/createFrom Project and/template/createFrom Components endpoints create templates.
(6) Project generation: The/project/createFromTemplate endpoint creates a project from a template.
(7) Template deletion: The/templates/{templateld} endpoint deletes a template.
(8) Template import/export: The/template/import and/template/export endpoints perform import and export.

Use cases of the template function are as follows.
(1) Project standardization: When using a common project structure across an organization or team, consistency can be achieved by utilizing templates.
(2) Rapid development start: Frequently used settings and configurations can be saved as templates and immediately used when starting a new project.
(3) Knowledge sharing: By templating the structure of successful projects and sharing them with other team members, the overall skill level can be improved.

The following explains error handling and validation of the template function. During template import, data validation is performed to prevent invalid data and format errors. In the event of an operation failure, an appropriate error message is displayed to the user to assist in resolving the issue.

The template function is a powerful tool for enhancing project management and reusability. Users can save project settings and data as templates and easily apply them to new projects. This facilitates efficiency in development processes, standardization, and collaboration. Technically, it is designed with robustness, offering excellent extensibility and maintainability.

Details of notebook processing are analyzed below. The message creator, ExecuteNotebookMessageCreator, extracts data necessary for notebook execution from messages within a chest and performs argument acquisition and retrieval via identifiers for existing notebooks. The flow is as follows:
(1) Property acquisition: Properties such as the method of extracting notebook arguments and whether merge processing is enabled are acquired, specifically using properties like isMergeNotebookExecution and motherNotebookArgument.
(2) Message extraction and processing: messageExtractor is used to extract relevant messages from within the chest. From the extracted messages, notebook arguments and notebook execution data are obtained.
(3) Argument assignment and notebook data completion: Arguments extracted from messages are assigned to the arguments held in the notebook execution data. If the notebook data is empty and an identifier exists, the notebook is retrieved from the database using the identifier and completed.
(4) Merging of notebook execution data: If isMergeNotebookExecution is enabled, multiple notebook execution data objects are merged and treated as a single notebook. Arguments and cells are consolidated, and the execution range and mode are appropriately set.
(5) Result generation: The processed notebook execution data is returned as FunctionResults and becomes available for subsequent query functions.

The query function, NotebookExecutionQuery, actually executes the received notebook execution data and acquires and processes the results. The flow is as follows:
(1) Property acquisition: Properties such as whether the notebook needs to be uploaded are acquired, specifically using isUploadNotebook.
(2) Notebook execution: QueryNotebookExecutor is used to execute the notebook. Before execution, arguments are inserted into the notebook as cells, and only the necessary range is executed.
(3) Processing of execution results: The post-execution notebook data is obtained and parsed or processed as necessary. The results are updated as NotebookExecutionData.
(4) Notebook upload: If isUploadNotebook is enabled and an identifier exists, the notebook is saved and updated in the database.
(5) Return of results: The FunctionResults containing the execution results are returned and become available for use by the subsequent generator.

The generator, NotebookGenerator, generates messages to be presented to the user from the results of the query function. The flow is as follows:
(1) Property acquisition: Properties such as how messages are split and the type of query replacement are acquired.
(2) Message generation: The notebook execution data from the query function is obtained and converted into message format. Queries are replaced or processed as needed.
(3) Return of message: The generated message is returned to the executor and ultimately delivered to the user as the final response.

The following explains auxiliary classes and utilities.
(1) QueryNotebookExecutor: A utility class that performs notebook execution, argument insertion, and import validation. Arguments are inserted into the notebook as cells, and only a specific cell range can be executed. It detects invalid import statements and performs validation on notebook data.
(2) NotebookService: A service class that creates, updates, deletes, and searches notebooks. It supports the persistence of notebooks by interacting with the database based on notebook execution data. It provides functionality for generating notebooks from files and dumping notebooks as files.

The features of notebook processing are summarized as follows.
(1) Argument acceptance function: Arguments necessary for notebook execution are extracted from user inputs or messages and dynamically reflected in the notebook. Arguments are inserted as cells within the notebook and used at the time of execution.
(2) Notebook invocation using identifier tags: Existing notebooks are managed by unique identifier tags, and notebooks can be retrieved and executed by specifying the tag. Even if the notebook is empty, the notebook data can be supplemented from the database using the identifier tag.
(3) Flexible message processing and data extraction: Using message creators and query helpers, various types of data can be extracted from messages. It supports various data formats including code blocks, CSV, JSON, URLs, and keywords.
(4) Advanced error handling and validation: Prior to notebook execution, import statements are validated and notebook data is verified to ensure safe execution. In the event of an error, appropriate exception handling and messages are provided.

Through this series of notebook processing steps, users can dynamically specify arguments and flexibly perform data analysis and processing by reusing existing notebooks. The system efficiently manages everything from message analysis to notebook execution and result return, thereby providing high-quality responses.

The functions and flow of the notebook processing microservice are explained below. This microservice is an API service for processing and executing Jupyter Notebooks. Its main purpose is to execute notebook data provided by the client on the server side and obtain and return the results. The details of the functions and processing flow are described below.

The main functions of the notebook processing microservice are as follows:
(1) Whole-notebook execution function to execute all cells at once by specifying the entire notebook.
(2) Cell range execution function to execute only a specific range of cells by specifying the start and end cell indices.
(3) Execution result acquisition function to obtain the executed notebook data and return it to the client (including cell outputs and error information).
(4) Error handling function to catch errors that occur during execution and return appropriate error messages to the client.
(5) Dependency management function that installs essential libraries such as NumPy and Pandas in advance, making them available within the notebook.

The processing flow of the notebook processing microservice is explained below.
(1) Receiving request: The service receives a request from the client containing the following data:
notebook_json: Notebook data in JSON format (compliant with nbformat)
mode: Execution mode (all or range)
start_cell: Start index of the cell range (for range mode)
end_cell: End index of the cell range (for range mode)
(2) Loading notebook: The received notebook_json is parsed and loaded as a Notebook object.
(3) Execution mode determination and preparation
(4) Whole-notebook execution (all mode): The entire notebook is executed as is.
(5) Cell range execution (range mode): A partial notebook is created from the specified start to end cell and only that part is executed.
(6) Executing notebook: The notebook is executed using ExecutePreprocessor. The kernel used is Python 3. Timeout is set to 600 seconds. The kernel is restarted as needed before execution.
(7) Acquiring execution results: The executed Notebook object is converted to JSON format, and the execution results (including output and error information) are returned to the client.
(8) Error handling: If an error occurs during execution or if an invalid parameter or mode is specified in the request, an error message is returned with HTTP status 400. If a syntax or runtime error occurs in the code during execution, detailed error information is returned to the client.

The environment and dependencies are explained below.
(1) Execution environment: Operates on a Python virtual environment and uses uvicorn to start the API server. Major libraries include nbformat, nbconvert, jupyter_client, numpy, pandas, and matplotlib.
(2) Library installation: Libraries listed in requirements.txt are installed using pip.

In testing, the test framework pytest is used. The tests cover a wide range of cases including full-cell execution, cell range execution, error handling, and dependency verification.

There are three limitations in testing. First is timeout: execution exceeding 600 seconds will time out. Second, the supported language is Python only (using the Python 3 kernel). Third is security: as arbitrary code execution from users is involved, appropriate security measures are required.

Testing precautions are as follows:
(1) Cell index: start_cell and end_cell must be specified as zero-based indices.
(2) Dependencies: If there are additional libraries used in the notebook, they must be installed in the environment in advance.
(3) Kernel state: The kernel is restarted as needed before execution, but kernel state management must be handled carefully.

This notebook processing microservice can flexibly execute notebook data provided by the client and return the results. It supports a wide range of needs, including batch execution of all cells, execution of specific cell ranges, and provision of detailed error messages. It can be utilized in various applications such as data analysis, machine learning model testing, and automated report generation.

In this system, files uploaded by users are effectively managed and utilized to perform diverse data processing through the execution of chests (data processing pipelines). The detailed mechanisms of file and storage processing and their linkage with the chest execution service are described below.

The following explains file upload and storage.
(1) Receiving files: Files are received from the chest flow configuration GUI processor and processed by the chest flow execution controller. Users upload files through the web interface. Uploaded files are received by the chest flow execution controller server and processing begins.
(2) Filename validation and uniqueness assurance: Duplicate checks, unique filename generation, and error handling are performed. The database is checked to determine whether a file with the same name already exists. If a duplicate exists, a suffix is added to generate a unique filename. In strict mode, an error is returned if duplication occurs.
(3) File storage: Storage directory verification, file writing, and error handling are performed. If the storage directory does not exist, it is newly created. The received file is saved to the specified path. If an error occurs during saving, it is appropriately handled and the user is notified.
(4) Metadata registration in the database: File information and tag management are performed. Metadata such as filename, path, user ID, and creation date is saved in the database. Tags associated with the file are saved and used for later search or classification.

The following explains file retrieval and download.
(1) Searching file information: The database is queried using the user ID and filename to retrieve information on the target file.
(2) Confirming file existence: The storage is accessed to check whether the specified file exists. If the file does not exist, an error message is generated and the user is notified through error handling.
(3) Providing the file: The file is read on the server side and a downloadable response containing the file data is generated for the user.

The following explains file deletion.
(1) Retrieving file information from the database: Information on the file to be deleted is obtained.
(2) Physically deleting the file from storage: The file is deleted from the file system. If deletion fails, a log is recorded, and if necessary, retry attempts, user notification, and error handling are performed.
(3) Updating the database: The file's metadata is deleted from the database.

The following explains linkage with the chest execution service. File contents are utilized in the chest execution process.
(1) Message generation: File contents are incorporated as messages, and messages are created. MessageCarrier is used to store data in a MessageCarrier object for use within the chest.
(2) Use of FileCarrier: FileCarrier objects manage file metadata such as filename, file type, and structure type. Through FileCarrier, necessary file data is utilized in each processing step of the chest.

The following explains the integration with the chest execution service. The content of the file is utilized in the chest execution process.
(1) Message generation: The content of the file is imported as a message and used to create a message. A MessageCarrier object is used to store the data, which is then utilized within the chest.
(2) Use of file carrier: A FileCarrier object manages the file metadata such as file name, file type, and structure type. Through the file carrier, the necessary file data is utilized at each processing step of the chest.

The following explains file processing in query functions.
(1) File retrieval and content reading: The file specified in the query function is retrieved from storage. Then, depending on the file's structure type, its contents are read using an appropriate method.
(2) Use of data: The read data is analyzed and processed, then returned as a query result. Furthermore, the analysis result is generated as a message and utilized in subsequent processing.

The following explains error handling and logging.
(1) Error handling: Exceptions that occur during file processing are captured, and appropriate error messages are generated. Additionally, the error details are communicated clearly to the user, and suggestions for retrying or alternatives are provided.
(1) Logging: Errors that occur are recorded in log files or monitoring systems. Based on the log information, system issues are analyzed (for auditing and debugging) and used to support improvements.

The following explains security and access control.
(1) User authentication and permission management: Access to files is permitted only for authenticated users. Accessible files are restricted per user to prevent unauthorized access to others' files.
(2) Secure file handling: Input validation is performed to verify that the file name and path do not contain invalid values. Furthermore, relative paths and special characters are appropriately handled during file path manipulation to prevent unauthorized file access (e.g., directory traversal).

The following explains performance and scalability.
(1) Asynchronous processing: File read/write operations are performed asynchronously to improve system responsiveness, i.e., asynchronous file I/O.
(2) Caching: Frequently accessed files, analysis results, and other data are cached to enhance processing speed.

The following explains the role of file processing within the overall system.
(1) Files as part of the data flow: Files provided by users are used as input data for the chest. Files generated during the process (intermediate outputs) are also managed and used in subsequent processing steps.
(2) Flexible data processing: The system supports various file formats to flexibly meet user needs and is designed to be extensible, making it easy to add new file formats or processing methods.

File and storage processing are essential components that support the foundation of this system. From file uploads by users to saving, retrieving, analyzing files, and integrating with the chest execution service, the system enables advanced data processing throughout the entire sequence. This allows users to effectively utilize diverse data and achieve efficient business processes and data analysis.

The following provides a detailed analysis of message processing during the execution of the function list. Executing a function list is a process in which a sequence of functions defined within a chest is executed in order. In this process, message processing-including generation, manipulation, extraction, and tagging-plays a central role. This analysis particularly details how the message creator and generator process messages in terms of their functions, flow, and characteristics.

The overall flow of message processing is described below.
(1) Retrieval and preparation of the function list: The function list associated with the chest is retrieved. Each function defines properties such as the execution order index, conditions, and properties.
(2) Sequential execution of functions: Each function in the function list is executed in the defined order. Each function consists of a message creator, query function, and generator.
(3) Execution of the message creator: Necessary messages are generated and processed, including message selection, extraction, filtering, and tagging.
(4) Execution of the query function: Queries to external services or databases are executed to obtain results, including AI API calls and data retrieval.
(5) Execution of the generator: Based on the query results and existing messages, new messages are generated, including response message generation and data formatting.
(6) Updating of messages and tags: The generated messages and tags are added to or updated in the message list within the chest. Tags are used in subsequent functions for conditional branching and message selection.

The following explains the functions of the message creator.
(1) Message generation function to newly generate necessary messages: for example, setting the role (e.g., user, assistant), content, and message carrier.
(2) Extraction of messages that meet specific conditions from the existing message list: using criteria such as role, tag, and content type.
(3) Editing and transformation of extracted messages: for example, formatting text, removing unnecessary information, and converting to specific formats—i.e., the message processing function.
(4) Tag application function to assign or update specific tags to messages: tags indicate the attributes or states of messages.

The following explains the flow of the message creator.
(1) Retrieval and setting of properties: Properties defined in the function are retrieved, which include extraction conditions, processing methods, and tag information.
(2) Selection and extraction of messages: Based on the properties, messages are extracted from the message list. Conditions include role, tag, index, etc.
(3) Message processing: Necessary processing is performed on the extracted messages. The processing details vary depending on the properties.
(4) Generation of new messages: New messages are generated if needed. The generated messages include settings for content, role, tags, etc. Argument information is matched through argument definition information and used to provide parameters required for query function execution.
(5) Application and updating of tags: Tags are assigned or updated for messages, enabling appropriate identification of messages in subsequent processing.
(6) Return of results: The processed and generated messages are returned as the execution result of the function.

The following describes the characteristics of the message creator.
(1) Flexible message manipulation: The system consistently supports the generation, processing, and extraction of messages. The behavior can be finely controlled via properties.
(2) Condition-based processing: Messages are selected and processed based on conditions such as role, tag, and content. Flexible processing through conditional branching is possible.
(3) Use of tags: Tags are used to manage the state and attributes of messages. Tags are effective for selecting messages and evaluating conditions.

The following explains the functions of the generator.
(1) Message generation: New messages are generated based on the results of query functions or existing messages. Messages including response content and data are created.
(2) Data parsing and transformation: Query results are analyzed and transformed into required formats. Examples include parsing JSON data and formatting text data.
(3) Information extraction: Specific information is extracted from query results or messages. This includes code blocks, URLs, keywords, etc.
(4) Message splitting and integration: Messages may be split into multiple parts or integrated as needed. Multiple responses can be generated as individual messages.

The following explains the flow of the generator.
(1) Retrieval and setting of properties: The properties defined in the function are retrieved, including extraction methods and the format of the messages to be generated.
(2) Retrieval of query results: The results from the query function are retrieved, and the results may be in the form of data objects or text.
(3) Data analysis and transformation: The query results are analyzed, and the necessary information is extracted; data is transformed and formatted as needed.
(4) Message generation: A new message is generated based on the extracted and transformed data, with appropriate roles, content, and tags assigned to the message.
(5) Message splitting and integration: According to the properties, the message is either split or integrated, and it is determined whether to return the messages individually or in an aggregated form.
(6) Tag application and update: Tags are assigned or updated for the generated messages to enable appropriate handling in subsequent processing.
(7) Return of results: The generated messages are returned as the execution result of the function.

The following explains the characteristics of the generator.
(1) Data-driven message generation: Messages are dynamically generated based on the query results, making it suitable for generating responses that incorporate AI outputs or external data.
(2) Advanced information extraction: Data is analyzed and specific information is extracted and converted into messages; specific elements such as code, data, and URLs can be extracted.
(3) Message control: The properties allow control over message splitting, integration, and the level of detail in content, enabling flexible modification of the format and number of responses.

The following explains the characteristics and advantages of message processing.
(1) Modular function execution: The message creator, query function, and generator operate as independent modules, with a design that offers high extensibility and maintainability.
(2) Flexible control via properties: Each function allows detailed behavioral configuration through properties, enabling behavior adjustment according to user requirements and scenarios.
(3) State management using tags: Tags are used to manage the state of messages and data; utilizing tags for conditional branching and message selection enables flexible processing flows.
(4) Data reuse and integration: Messages and data are shared and reused among functions, allowing for efficient processing while maintaining data consistency and coherence.
(5) Error handling and logging: Exceptions and errors within functions are appropriately handled and logged, improving system reliability and debugging efficiency.

Message processing during function list execution plays a central role through the message creator and the generator; the message creator performs extraction, generation, and processing of messages, while the generator generates new messages based on query results; both components utilize properties and tags to control their operations, realizing flexible and extensible message processing; this enables the system to handle complex processing flows and diverse user scenarios, providing high-quality responses and functionalities.

The following provides a detailed analysis of the functions and flow of the QueryHelpers. The QueryHelpers class plays a central role in message processing during the execution of a chest. This class provides a wide range of functions, including extraction and transformation of messages, data extraction from files, and information extraction from AI output results. This analysis focuses on the functions, flow, and features of message processing during the execution of a function list, centering on the methods of QueryHelpers. In particular, the analysis focuses on file extraction and information extraction from AI output texts.

The overall flow of message processing is described below.
(1) Selection and extraction of messages: Messages that meet specified conditions are extracted from the message list within a chest. Extraction conditions are based on the role of the message (e.g., userQuery, response), tags, or content type.
(2) Processing of file data: When a message contains file data (FileCarrier), the file is read in an appropriate format, and text data is extracted. Different extraction methods are applied depending on the file type (e.g., PDF, Word, Excel, CSV).
(3) Extraction of information from AI output: Specific information such as code blocks, JSON data, CSV data, and URLs is extracted from AI response messages. The extracted information is analyzed and transformed, and, if necessary, converted into a MessageCarrier.
(4) Processing and generation of messages: New messages are generated based on the extracted and processed data. Appropriate roles and tags are assigned to the generated messages for use in subsequent processing.
(5) Application and management of tags: Tags are applied to the messages or extracted data to indicate message attributes and are used in conditional branching or filtering.

The details of the main functions are described below. QueryHelpers has a file extraction function that processes file data included in messages and extracts textual information.
(1) Identification of file type: The file type in the FileCarrier is identified, and the appropriate extraction method is selected. Supported file types include PDF, Word, Excel, CSV, HTML, and Markdown.
(2) Text extraction methods:
PDF: Text is extracted from PDF documents using OCR or a text extraction library. Word/Excel: Text or data is obtained from documents or spreadsheets using Office file parsers.
CSV: Data is read in a structured format using a CSV parser.
(3) Integration of extracted data: Data extracted from multiple files is integrated and compiled into a single MessageCarrier. Preprocessing or cleansing of the data is performed as needed.

The function of extracting and analyzing specific information from AI responses is also important.
(1) Extraction of code blocks: Code blocks (sections using specific programming language syntax) within the response are detected and extracted. The extracted code is used for subsequent analysis or execution.
(2) Parsing of JSON data: JSON-formatted text is detected in the response and parsed to obtain data objects. Data is validated, and required keys are extracted to retrieve necessary information.
(3) Parsing of CSV data: CSV-formatted text is detected in the response and parsed to obtain a two-dimensional array. The data is used for formatting or aggregation processing.
(4) Extraction of URLs: URLs are detected from text using regular expressions and are listed for accessing external resources or referencing.
(5) Extraction of keywords: Important keywords or phrases are extracted from text using natural language processing. The extracted keywords are used for tagging, classification, or query generation in search engines.
(6) Message splitting: The text is analyzed to extract list structures, and each item is treated as an individual message. Multiple lists can be extracted and stored in metadata.
(7) Extraction of notebook execution data: Notebook execution results are extracted and transformed into a format suitable for re-execution. Data such as cells or npFormat can also be extracted and transformed.
(8) Extraction of argument information: Argument information for functions is extracted from messages. Additionally, data contained in messages is analyzed and labeled with variable names to be converted into arguments. Argument information is provided to query functions as parameters via variable definition information.

The specific flow of message processing is described below.
(1) Collection of messages: All message data in the chest is obtained. If necessary, messages generated as results of function execution are also included.
(2) Filtering of messages: Messages that meet specified conditions (e.g., role, tag, index) are selected. For example, only the latest user input or messages with specific tags may be targeted.
(3) Processing of file data: Among the selected messages, those containing FileCarriers are identified. File extraction functions are used to extract text data from files.
(4) Extraction of information from AI output: AI response messages are analyzed to extract necessary information such as code, JSON, CSV, URLs, or keywords. Regular expressions, parsers, and natural language processing techniques are used for the extraction.
(5) Organization of data and message generation: The extracted data is organized and stored in a MessageCarrier. Necessary metadata and tags are assigned, and new messages are generated.
(6) Application and updating of tags: Appropriate tags are applied to the extracted data and generated messages. Tags are used in subsequent processing such as conditional branching and filtering.
(7) Integration into the message list: Generated messages are added and integrated into the message list of the chest. Index adjustments are made to maintain the order and correlation of messages.

The characteristics and advantages are described below.
(1) High versatility in data extraction: A wide variety of file and data formats are supported, allowing information to be retrieved from various sources.
(2) Advanced information analysis: Required information can be accurately extracted from AI outputs, which is highly advantageous for response generation and data analysis.
(3) Seamless message integration: Extracted and generated messages can be naturally integrated into the existing message flow.
(4) Flexible tag management: Detailed control is possible using tags, making it easy to implement complex conditional branching or customization.
(5) Modular design: Each function is modularized, providing high maintainability and extensibility.

QueryHelpers is a core class in message processing during the execution of function lists, equipped with advanced data processing functions such as file extraction and information extraction from AI outputs. This enables the system to utilize information from various data sources and provide sophisticated responses and functions to users.

The following describes the detailed analysis and functionality of field processing. First, ChestFieldController is explained. ChestFieldController is a controller class that receives requests from the chest flow configuration GUI processor and invokes appropriate service methods. It provides API endpoints related to the manipulation of chests and flows on the field.

The main functions of ChestFieldController are as follows (10 items):
(1) Retrieval, creation, update, and deletion of chests;
(2) Management of chest data on the field;
(3) Movement of chests;
(4) Updating of chest position information;
(5) Expansion of sequences;
(6) Control of expansion and collapse of sequence chests;
(7) Updating of message tags;
(8) Updating of message tags related to groups or flows;
(9) Control of recalculation mode;
(10) Transition to, cancellation of, and execution in recalculation mode.

Next, ChestFieldService is described. ChestFieldService is a service class that receives requests from the controller and implements business logic. It provides functionalities such as creation of chests, management of recalculation, and execution of sequences.

The main functions of ChestFieldService are as follows (6 items):
(1) Creation of chests;
(2) Creation of new chests based on the project state;
(3) Execution of sequences;
(4) Management of sequence chest execution;
(5) Management of recalculation mode;
(6) Transition to, cancellation of, and execution of recalculation flow.

Next, FieldObjectService is described. FieldObjectService is a service class responsible for detailed operations of objects on the field. It provides functionalities such as editing, deleting, moving, and selecting chests.

The main functions of FieldObjectService are as follows:
(1) Editing of chests;
(2) Updating chest properties or message formats;
(3) Deletion of chests;
(4) Deletion of specified chests from the database;
(5) Movement of chests;
(6) Updating of chest position and adjustment of the positions of related child chests;
(7) Expansion/collapse of sequences;
(8) Changing the display state of sequence chests;
(9) Selection of chests;
(10) Addition to chest groups and specification of target chests for partial execution;
(11) Updating of message tags;
(12) Updating of message tags related to groups or flows.

The following describes details of chest operations on the field.
(1) Chest creation:
User operation: A new chest is placed on the field and the required settings are entered. Chest flow execution controller processing: The ChestFieldController receives the request and calls the controlCreateChest method of the ChestFieldService. The state of the chest is set according to the project mode (e.g., normal mode, recalculation mode). Appropriate processing is performed according to the chest type (e.g., “map”, “yield”, “reduce”, “split”). Sequence chests or child chests are generated as needed.
(2) Chest editing:
User operation: The settings, message format, or properties of an existing chest are modified.
Chest flow execution controller processing: The editChest method of the ChestFieldController receives the request and calls the editChest method of the FieldObjectService. The chest data is validated and updatable fields are updated. Related flows or child chests are reconstructed as necessary.
(3) Chest deletion:
User operation: A chest on the field is deleted.
Chest flow execution controller processing: The deleteChest method of the ChestFieldController receives the request and calls the deleteChest method of the FieldObjectService. The specified chest is deleted from the database, and associated flows and child chests are also handled appropriately.
(4) Chest movement:
User operation: A chest is dragged on the field to change its position.
Chest flow execution controller processing: The moveChest method of the ChestFieldController receives the request and calls the moveChest method of the FieldObjectService. The new position of the chest is saved, and in the case of a sequence chest, the positions of child chests are also adjusted relatively.
(5) Sequence expansion/collapse:
User operation: A sequence chest is clicked to toggle the visibility of its child chests. Chest flow execution controller processing: The expandSequence method of the ChestFieldController receives the request and calls the expandSequence method of the FieldObjectService. The expansion state of the sequence chest is updated.
(6) Chest selection and partial execution designation:
User operation: A specific chest on the field is selected and designated as a target for partial execution.
Chest flow execution controller processing: The selectChest method of the ChestFieldController receives the request and calls the selectChest method of the FieldObjectService. The chest group and partial execution state are updated, and existing groups are adjusted as necessary.
(7) Message tag update:
User operation: Message tags associated with a group or flow are edited.
Chest flow execution controller processing: The updateGroupMessageTags or updateFlowMessage Tags method of the ChestFieldController receives the request and calls the corresponding method of the FieldObjectService. The message tag information for the group or flow on the database is updated.
The following describes details of the recalculation function.
(1) Transition to recalculation mode:
User operation: Recalculation mode is initiated in order to perform recalculation.
Chest flow execution controller processing: The enterRecalculationMode method of the ChestFieldController receives the request and calls the method of the same name in the ChestFieldService. The project mode is set to “recalculation”, the states of the related chests are updated to “wait”, and the chest groups are organized.
(2) Execution of recalculation:
User operation: Recalculation is started.
Chest flow execution controller processing: The executeRecalculation method of the ChestFieldController receives the request and calls the manageRecalculation method of the ChestFieldService. The recalculation service identifies the target chests and executes recalculation considering their dependencies. Upon completion of the recalculation, the chest states are updated and, if necessary, the project mode is reverted to normal.
(3) Cancellation of recalculation mode:
User operation: Recalculation mode is canceled.
(4) Chest flow execution controller processing: The cancelRecalculationMode method of the ChestFieldController receives the request and calls the method of the same name in the ChestFieldService. The project mode is reverted to normal, and the chests in the “wait” state are properly updated.

The following describes flow management.
(1) Creation, update, and deletion of flows:
User operation: A flow connecting chests is created, edited, or deleted.
Chest flow execution controller processing: Through the relevant endpoints for flows, the corresponding service methods are invoked. The flow information is managed on the database, and data flows between chests are appropriately configured.
(2) Message tag update for flows:
User operation: Message tags associated with a flow are edited.
Chest flow execution controller processing: The updateFlowMessageTags method of the ChestFieldController receives the request and calls the method of the same name in the FieldObjectService. The message tag information of the flow is updated, and tag management during data propagation is performed.

The following describes chest types and their processing.
(1) “map” type
Characteristic: Used when the same process is to be applied to multiple datasets. Processing flow: A child chest is generated for each base chest. The child chests are processed in parallel.
(2) “yield” type
Characteristic: Used when the same process is to be repeated multiple times.
Processing flow: The specified number of child chests are generated. The child chests are processed sequentially or in parallel.
(3) “reduce” type
Characteristic: Used for data aggregation or consolidation.
Processing flow: Data from multiple sources is aggregated to produce a result.
(4) “split” type

Characteristic: Used when data is to be divided and different processes are applied. Processing flow: Based on execution results, the required number of child chests is dynamically generated.

The following describes the overall processing flow.
(1) Reception of user operation: A user action on the chest flow configuration GUI processor is sent as a request to the chest flow execution controller.
(2) Controller: The ChestFieldController receives the request and invokes the appropriate service method.
(3) Execution of business logic: The ChestFieldService and FieldObjectService execute the business logic.
(4) Database operations: The chest, flow, or project data is updated as needed.
(5) Response return: The processing result is returned to the chest flow configuration GUI processor and the GUI state is updated.

The field processing is an important function that enables users to visually construct and manage data processing flows via the GUI. A wide range of functions such as the creation, editing, and deletion of chests and flows, and the provision of recalculation functionality, are supported by the chest flow execution controller service. By appropriately linking these components and functions, a flexible and extensible system is realized.

This project is designed around the following major object models to efficiently perform complex data processing and message exchange. This section explains the primary object models of the project, along with detailed descriptions and relationships. The main object models are UnifiedChest, Chest flow, ChestGroup, ChestSequenceChest, and MessageHelper.

The UnifiedChest represents the basic data processing unit referred to as a “chest” within the system. This chest possesses a wide range of functionalities, including data storage, processing, display, message generation, and response. It is a comprehensive model with many attributes, such as positional information on the user interface, linkage with the associated message helper, and state management. The UnifiedChest functions as the fundamental unit within the data flow and cooperates with other chests and flows to implement complex processing. Users can place chests and configure queries or message helpers for each chest to perform the desired data processing or message generation.

The main attributes of the UnifiedChest are as follows:
(1) id: A unique identifier for the chest.
(2) title: The name or title of the chest, set for easy identification by the user.
(3) positionX/positionY: The coordinates of the chest on the chest flow configuration GUI processor, visually representing the spatial relationship between chests.
(4) chestType: The type of the chest, such as “reduce”, “map”, “split”, or “yield”.
(5) query: The query information processed by the chest, executed through the message helper.
(6) response: The response data obtained as the result of executing the query.
(7) messageHelperld: The ID of the message helper linked to this chest, used for message generation and transformation.
(8) messageHelperProperties: Property information related to the message helper, maintaining detailed settings.
(9) tagInventory: A list of message tags, representing tag information shared among chests or between messages.
(10) state: The current state of the chest, such as “wait”, “inprogress”, or “completed”.
(11) createdAt/updatedAt: The creation and last update timestamps of the chest, used for data management and historical tracking.
(12) isExpanding: A flag indicating whether the chest is in an expanded state.
(13) autoSequenceltemGeneration: A setting indicating whether items within a sequence are automatically generated.
(14) displayControl: Detailed settings related to the display control of the chest.

The Chest flow is a model that defines the flow of data and dependencies between chests. It manages the transmission of information from a specific chest to another, the processing order, the type of flow, and other aspects. The Chest flow manages the relationships between chests and defines how data or messages flow, thereby enabling the construction of complex processing flows or pipelines by combining multiple chests. Its main attributes are as follows:
(1) id: A unique identifier for the flow.
(2) instructionType: The instruction type of the flow, such as “normal” (standard flow), “base” (base flow), or “precede” (preceding flow).
(3) expressionType: The expression type of the flow, indicating the type of processing or characteristics of the flow.
(4) isReference: A boolean value indicating whether this flow is a reference flow; reference flows are treated as references rather than copies of data.
(5) sourceId: The ID of the chest that serves as the source of the data.
(6) targetId: The ID of the chest that serves as the recipient of the data.
(7) messageTags: Message tags associated with the flow, used for filtering or conditional branching of data between flows.
(8) message TagDefinition: Definition information of the message tags, describing the structure and attributes of the tags in detail.
(9) messageIndex: An index indicating the order or position of the messages.
(10) displayControl: Control settings related to the display of the flow.
(11) ownerProjectId: The ID of the project to which this flow belongs.

The ChestGroup is a model for grouping multiple related chests as a single unit. Chests within a group share common properties and message tags, enabling unified management. By using ChestGroup, it becomes possible to apply settings or perform operations collectively on multiple chests. For example, chests with specific tags can be grouped together to update message tags all at once or execute processing targeting the entire group. The main attributes are as follows:
(1) id: A unique identifier for the group.
(2) groupChestId: The ID of the representative chest of the group, typically indicating the primary chest of the group.
(3) currentIndex: The current index or position within the group, used during sequence processing.
(4) baseChestSequence: A flag indicating whether this group serves as the base chest sequence.
(5) messageTags: Message tags shared across the entire group.
(6) messageTagDefinition: Definition information of the message tags.
(7) ownerProjectId: The ID of the project to which the group belongs.

The ChestSequenceChest is a model that manages each chest within a sequence of chests, defining the order and execution sequence of the chests within the sequence. ChestSequenceChest manages the execution order of chests and controls sequence processing; for example, it is used when constructing a data processing pipeline and executing chests in order. Chests within the sequence operate with a flow in which each chest receives the result of the previous one and passes it on to the next. The main attributes are as follows:
(1) id: A unique identifier for the sequence chest.
(2) sequenceId: The ID of the sequence to which this chest belongs.
(3) chestId: The ID of the individual chest.
(4) ownerProjectId: The ID of the project to which the sequence chest belongs.
(5) sequenceIndex: An index indicating the order of the chest within the sequence.

The MessageHelper is a model for generating, processing, managing tags, and integrating properties of messages. It supports chest message processing and enables complex message flows and conditional handling. MessageHelper serves as a tool to highly customize message processing within a chest. By selecting or configuring a message helper, users can flexibly control how messages are generated, the transformation logic, tag application, and conditional branching. This enables precise design of message flows between chests and the realization of complex processing. The main attributes are as follows:
(1) id: A unique identifier for the message helper.
(2) name: The name of the message helper, set to be easily identifiable by the user.
(3) processType: The message processing type, such as “chat,” “function,” or “data.”
(4) resultType: The result type of processing, such as “reduce,” “map,” “yield,” or “split.”
(5) queryFormat: The query message format, defining the structure and format of the message.
(6) responseFormat: The response message format.
(7) functionList: A list of functions used for message processing, each having specific processing logic.
(8) messageHelperProperties: Properties related to the message helper, maintaining detailed processing settings.
(9) tagInventory: An inventory of message tags, containing a list and definitions of usable tags.
(10) ownerLd: The ID of the owner of the message helper.

The detailed relationships between the models are described below:
(1) In the relationship between UnifiedChest and MessageHelper, UnifiedChest holds a messageHelperld and is associated with the MessageHelper through that ID. How the chest generates and processes messages is determined by the linked MessageHelper, which provides the message processing logic for the chest.
(2) In the relationship between UnifiedChest and Chest flow, Chest flow defines the data flow between chests using sourceId and targetId, each of which corresponds to the ID of a UnifiedChest. The role of Chest flow is to define how data and messages are exchanged between chests and to determine the processing order and conditions.
(3) In the relationship between UnifiedChest and ChestGroup, a chest can belong to a ChestGroup. ChestGroup groups multiple chests and applies shared settings and tags. Grouped chests can be collectively controlled and reconfigured, enabling unified management of chests with common processing.
(4) In the relationship between ChestGroup and Chest flow, Chest flow can be defined among chests within the group or between the group and other chests. It is used to provide a unified flow for the entire group or to control data flows under specific conditions.
(5) In the relationship between ChestSequenceChest and UnifiedChest, ChestSequenceChest is associated with UnifiedChest via the chestId, indicating each chest within a sequence. It manages the execution order and relationships of chests in sequence processing.
(6) In the relationship between MessageHelper and the message processing flow, MessageHelper provides the core logic and settings for the chest's message processing flow. Through function lists, properties, and tag management, it enables message generation, transformation, conditional branching, and controls complex message flows between chests.

The overall data flow and processing flow are described below:
(1) Placement and configuration of chests: The user places UnifiedChest on the chest flow configuration GUI processor and configures MessageHelper and queries for each chest.
(2) Definition of chest flows: If necessary, the relationships between chests are defined as Chest flow, which determines the flow of data and the processing order.
(3) Creation of chest groups: Chests with common settings or tags are grouped together as a ChestGroup.
(4) Sequence configuration: When sequence processing is needed, the execution order of chests is defined using ChestSequenceChest.
(5) Message generation and processing: Each chest generates and processes messages using the associated MessageHelper, which executes message logic using its function list and properties.
(6) Execution of data flow: Based on Chest flow, data and messages flow between chests, and conditional branching or filtering via tags is applied.
(7) Acquisition and display of results: Processing results are stored in the response of each chest and presented to the user.

The following explains additional related information:

(1) Utilization of message tags: Message tags add metadata to messages and chests, and are used for data filtering and conditional branching. By using tags, it becomes possible to control flows flexibly, such as executing processing only under specific conditions.
(2) Conditional processing and function list: Within the function list of a MessageHelper, it is possible to control whether a function should be executed under certain conditions by using a condition object. This allows the message processing flow to be changed dynamically.
(3) Integration and management of properties: The properties possessed by message helpers and chests are integrated at the time of execution. By merging properties and applying default values, consistent configuration management becomes possible.
(4) System-wide extensibility and flexibility: Owing to these models and their interrelationships, the system possesses high extensibility and flexibility. New processing logic or data flows can be easily added or modified, and the system can accommodate large-scale data processing and complex business logic.

The major object models of this project—UnifiedChest, Chest flow, ChestGroup, ChestSequenceChest, and MessageHelper—each fulfill important roles and collaborate with each other to realize complex data processing and message flows. By understanding their detailed attributes and functions, as well as the relationships between the models, one can deeply understand the operation of the overall system.

The functions, flows, and features of project processing are explained below. In this system, the user is provided with functions to create, update, delete, and select projects. The chest flow execution controller and the chest flow configuration GUI processor work in conjunction. On the execution controller side, the logic is implemented across: ProjectController.scala, Projects.scala, ProjectRepository.scala, and ProjectService.scala. On the GUI processor side, the implementation files are: projectAPI.js, Projects.js, ProjectList.js, and ChestField.js.
(1) Project retrieval
Execution controller processing: The getProjects method of ProjectController.scala retrieves the user ID based on authentication information and then obtains the projects related to that user. It calls the getProjectsByUserld method of ProjectService.scala, which in turn retrieves projects from the database via findByUserld in ProjectRepository.scala.
GUI processor processing: The getProjects function in projectAPI.js sends a request to the API endpoint to retrieve the project list. Projects.js manages the retrieved projects in state, and ProjectList.js displays them as a list.
(2) Project creation
Execution controller processing: The createProject method of ProjectController.scala obtains ProjectData from the request body and creates a new project. It passes through the createProject method of ProjectService.scala, which inserts the new project into the database via the create method in ProjectRepository.scala.
GUI processor processing: The createProject function of projectAPI.js sends the new project data to the API. In ProjectList.js, an input form is displayed, and the user inputs the project name, memo, and tags to create the project.
(3) Project update
Execution controller processing: The updateProject method of ProjectController.scala updates the project with the specified project ID. It passes through the updateProject method of ProjectService.scala, which updates the database via the update method in ProjectRepository.scala.
GUI processor processing: The updateProject function of projectAPI.js sends the updated project data to the API. ProjectList.js provides an edit button, allowing the user to update the project information.
(4) Project deletion
Execution controller processing: The deleteProject method of ProjectController.scala deletes the project with the specified project ID. It passes through the deleteProject method of ProjectService.scala, which deletes the project from the database via the delete method in ProjectRepository.scala.
GUI processor processing: The deleteProject function in projectAPI.js sends a delete request for the specified project to the API. In ProjectList.js, a delete button is provided to allow the user to delete the project.
(5) Setting the current project
Execution controller processing: The setCurrentProject method of ProjectController.scala sets the current project for the user. It passes through the setCurrentProject method of ProjectService.scala, which updates the database using the setCurrentProject method in ProjectRepository.scala.
GUI processor processing: The setCurrentProject function in projectAPI.js sends a request to the API to set the selected project as the current project. When the user selects a project in Projects.js, that project is set as the current project.

The following is an explanation of the flow:
(1) User authentication: The user possesses an authentication token, and all requests require this token.
(2) Data retrieval and display: The chest flow configuration GUI processor uses the getProjects function to retrieve the list of the user's projects. The retrieved data is displayed using the ProjectList component.
(3) Project operations: For creation, when the new creation button is clicked, a dialog appears where project information can be entered to create the project. For updates, clicking the edit button of a project opens a dialog where the information can be updated. For deletion, clicking the delete button deletes the project. When selecting a project, clicking on the project name sets it as the current project and transitions to the detail screen.
(3) Operations on the detail screen: The ChestField.js component is displayed, allowing detailed operations related to the project.

The following explains the features of the project processing:
(1) MVC architecture: The chest flow execution controller is divided into Controller, Service, Repository, and Model, with clearly separated responsibilities.
(2) Asynchronous processing: Communication between the chest flow configuration GUI processor and the chest flow execution controller is performed asynchronously, improving user experience.
(3) Authentication and security: All API requests require an authentication token and CSRF token, enhancing security.
(4) User-friendly UI: Projects can be filtered, and narrowed down using tags. An intuitive project creation/edit interface using dialogs is provided.
(5) Reusability and extensibility: The component-based design of the chest flow configuration GUI processor facilitates easy reuse and extension of functions. As the service layer consolidates business logic, adding or modifying functions is simple.
(6) Error handling: In the chest flow configuration GUI processor, error messages are displayed to the user upon operation failure so that the user can recognize the issue.

This system operates through the cooperation of the chest flow execution controller and the chest flow configuration GUI processor to enable user-centric project management. It possesses a robust architecture and a user-friendly UI, with a design that considers extensibility and maintainability.

The following explains the functions, flows, and features of the prompt holder. The prompt holder provides functionality that allows users to save, manage, and utilize various content types such as text, JSON, Markdown, code, CSV, keywords, and URLs. It is designed to enable efficient reuse of frequently used templates, code snippets, document fragments, etc.

First, the main functions of the prompt holder are explained:
(1) Save function: Users can create prompt holders containing information such as a title, content type, actual content, and tags, thereby saving information in a structured manner.
(2) Edit function: Users can edit existing prompt holders to update their contents and related information, thus maintaining the recency and accuracy of the information.
(3) Delete function: Unnecessary prompt holders can be deleted, facilitating data organization and management.
(4) Search function: Prompt holders can be searched using tags or titles. Tag-based filtering, in particular, is useful for quickly locating relevant information.
(5) Insert function: The contents of a saved prompt holder can be inserted directly at the cursor position in an editor or input field, enabling efficient text input or code writing.

### Flow of Prompt Holder:

(1) Prompt holder creation: The user selects text or code and opens the prompt holder management screen. The user inputs a title, content type, content, and tags and saves the data. The server receives the data and stores it as a new prompt holder in the database.
(2) Prompt holder editing: The user selects an existing prompt holder, enters edit mode, updates the necessary information, and saves it. The server receives the changes and updates the corresponding entry in the database.
(3) Prompt holder deletion: The user selects the prompt holder to be deleted and executes a delete action. The server processes the delete request and removes the corresponding entry from the database.
(4) Prompt holder search: The user enters a tag or keyword in the search bar. The server processes the query and returns a list of prompt holders matching the condition. The user can view the results and select the desired prompt holder.
(5) Content insertion: The user selects a prompt holder to insert and executes the insert action. The selected content is inserted at the cursor position.

The following explains the features of the prompt holder:
(1) Support for various content types: In addition to text, it can handle various formats such as JSON, Markdown, code, CSV, keywords, and URLs.
(2) Organization and search using tags: By using tags, prompt holders can be effectively categorized and searched.
(3) User-friendly UI: Intuitive operations are possible using modal windows and forms, reducing the learning cost.
(4) Improved reusability: Frequently used text or code snippets can be saved, greatly improving work efficiency.
(5) Real-time updates: Operations such as creation, editing, and deletion are reflected immediately, providing a smooth user experience.

The following explains technical details of the prompt holder:
(1) Chest flow configuration GUI processor: Built with React, it adopts a component-oriented design. It performs state management and API communication appropriately, and responds quickly to user interactions. The PromptHolderManager component integrates the functions for creating, editing, deleting, searching, and inserting prompt holders.
(2) Chest flow execution controller: Built with Scala and the Play framework. The PromptHolder class is defined as the data model, which interacts with the database. It adopts the repository pattern and aggregates data access logic in PromptHolderRepository. The PromptHolderService serves as the service layer handling business logic.
(3) API endpoint: Provides RESTful APIs supporting CRUD (Create, Read, Update, Delete) operations for prompt holders. Equipped with authentication and authorization functions, it ensures data security per user.

The following explains use cases of the prompt holder:
(1) Saving code snippets: Frequently used code fragments can be saved and inserted quickly during development.
(2) Template management: Standard phrases for emails or documents can be saved and used as needed.
(3) Accumulation of learning notes: Learned content or important points can be saved as notes and later referenced.
(4) Organization of keywords and tags: Keywords and tags related to a project can be managed to enhance information searchability.

The prompt holder is a powerful tool to enhance user productivity. It facilitates the storage, management, and reuse of information, contributing to work efficiency and time saving. It is also technically robust, with excellent extensibility and maintainability.

The MessageHelper prepares essential functions in advance in the chest flow, including message generation, transformation, tag management, and property integration. This allows the user to implement diverse functions in a chest simply by selecting an appropriate MessageHelper at the time of chest creation. Detailed settings can also be changed when registering the chest. During chest execution, the MessageHelper supports the message processing of each chest.

In the chest flow, the MessageHelper fulfills the following four roles:
(1) Message generation and transformation: The MessageHelper generates the messages necessary for chest execution. Based on the function list, it creates and transforms messages using message creators or generators.
(2) Tag management: It manages tag information shared among chests and controls the flow of messages. Using the tag inventory, it appropriately processes tags within messages.
(3) Integration and management of properties: It integrates the properties required by each chest and centrally manages the settings needed at runtime, performing operations such as merging properties and applying default values.
(4) Conditional branching processing: The MessageHelper dynamically controls the message processing flow using condition objects or tag conditions, switching the functions to be executed and the messages to be generated depending on the conditions.

The MessageHelper serves as the core of message processing in the chest flow. It provides a wide range of functions, including message generation and transformation, tag management, property integration, and conditional processing, thereby supporting the overall flexibility and extensibility of the chest flow. This enables the efficient realization of complex data processing and business logic.

The specific roles of the MessageHelper within the flow are as follows:
(1) Start of chest execution process: When a chest is executed, the relevant MessageHelper is first retrieved. The MessageHelper provides message formats and processing logic suited to the type and settings of the chest.
(2) Preparation and transformation of messages: The executor obtains the message format and tag information from the MessageHelper. It sequentially executes the functions in the MessageHelper's function list, generating and transforming messages and tags in each function.
(3) Execution of functions and integration of results: The function list held by the MessageHelper defines the steps of message processing. Each function combines query functions, message creators, and generators to perform message modification and external data retrieval. The results of function execution are integrated by the executor and used in the next step.
(4) Conditional processing and flow control: The condition objects within the MessageHelper enable control such as executing functions only under specific conditions. This achieves a flexible message processing flow and enables dynamic control of the overall chest flow.
(5) Generation of chest results: Finally, based on the messages and tag information obtained from the MessageHelper, the response of the chest is generated. This optimizes the flow of data within the chest flow and collects and generates the necessary information.

The following describes the detailed functions and flow of the MessageHelper. The MessageHelper is an important component of the chest flow execution controller service, responsible for message processing and generation, tag management, property integration, and more. It mainly consists of the following four classes and files:
(1) MessageHelperServices: A service class that provides the core business logic of the MessageHelper.
(2) MessageHelperController: A controller class that provides API endpoints related to the MessageHelper.
(3) MessageHelper: A model class that defines the data structure of a MessageHelper object.
(4) MessageHelperRepository: A repository class that handles interaction with the database.

The details of each component are as follows:
(1) The role of MessageHelperServices is to provide business logic such as creation, update, deletion, and retrieval of MessageHelper instances; manage the function list; perform addition, update, and deletion of conditions; and manipulate the internal data structures of the MessageHelper, such as property merging and tag management. Its main functions are the following six:
(1) create method: Creates a new MessageHelper.
(2) findById method: Retrieves a MessageHelper with the specified ID.
(3) update method: Updates an existing MessageHelper.
(4) delete method: Deletes a MessageHelper with the specified ID.
(5) Methods related to adding, inserting, updating, and deleting function lists.
(6) Methods for adding, updating, deleting, and retrieving conditions.
(2) The role of MessageHelperController is to receive requests from the client and invoke the appropriate service methods, provide API endpoints related to MessageHelper, and perform request validation and response formatting. The main endpoints are the following six:
(1) findById: Retrieves the details of a MessageHelper.
(2) create: Creates a new MessageHelper.
(3) update: Updates an existing MessageHelper.
(4) delete: Deletes a MessageHelper.
(5) Endpoints related to adding, updating, and deleting functions.
(6) Endpoints related to adding, updating, deleting, and retrieving conditions.
(3) MessageHelper is a model class, and its role is to define the data structure of the MessageHelper, and to store the properties, function list, and tag inventory that the MessageHelper possesses. The main fields are the following seven:
(1) id: Identifier of the MessageHelper.
(2) name: Name of the MessageHelper.
(3) processType: Type of processing (chat, function, data, etc.).
(4) resultType: Result type (reduce, map, yield, split, etc.).
(5) functionList: List of function data.
(6) messageHelperProperties: Properties of the MessageHelper.
(7) tagInventory: Inventory of tags.
(4) The role of MessageHelperRepository is to interact with the database and implement CRUD (create, read, update, delete) operations for the MessageHelper. The main methods are the following five:
(1) findById: Retrieves a MessageHelper with the specified ID from the database.
(2) create: Inserts a new MessageHelper into the database.
(3) update: Updates an existing MessageHelper.
(4) delete: Deletes a MessageHelper from the database.
(5) Method to retrieve MessageHelper instances based on user ID.

The MessageHelper realizes complex message processing flows defined by the user through message generation and transformation, and management of tags and properties.

The following explains the creation and updating of the MessageHelper:
(1) Creation flow: The client sends the MessageHelper data, the create endpoint of the MessageHelperController receives the request, validates the request data, calls the create method of MessageHelperServices, performs necessary initialization in the service class, and saves the data into the database via MessageHelperRepository.
(2) Update flow: The client sends the update data, the update endpoint of the MessageHelperController receives the request, validates the request data, calls the update method of MessageHelperServices, performs data merging and validation in the service class, and updates the database through the repository.

The management of the function list in the MessageHelper enables flexible construction of message processing flows through addition, insertion, updating, and deletion of functions. Each function includes components such as query functions, message creators, and generators, and contains properties and tags.

Regarding the management of conditions, ConditionObject and TagCondition are used to implement complex conditional branching and filtering. By adding, updating, and deleting conditions, the logic of message processing can be dynamically modified.

Regarding the merging of properties and tags, the overall properties of the MessageHelper and the properties of each function are merged to integrate the settings required at runtime. The tag inventory is managed to organize tag information shared across messages.

The documents “Chest Execution Service.md” and “Analysis and Functional Description of Chest Generation and Execution Process.md” describe the execution process of a chest (a collection or processing unit of messages) and the services that control it, focusing on the controlExecutorProcess method. These documents explain the major processing steps involving the Message Helper, including the creation of executors, execution flow of functions, conversion of messages and tags, merging of properties, retrieval and execution of function lists, saving of results, and error handling.

The Message Helper is a core component for message processing and enables user-defined message generation and modification, as well as implementation of complex conditional logic. The service, controller, model, and repository work in coordination to manage and manipulate data, provide APIs, and implement business logic. Understanding these components and their flows is essential for expanding and maintaining the overall system.

The following is an analysis of the functions and characteristics of the message processing-related files.

The message processing-related files construct a message processing system that manages and distributes query information and responses (such as AI responses, API inquiry results, and uploaded files) between chests. Messages are designed as a central concept to uniformly handle data content, metadata, and related properties.

The following is an analysis of each file related to message processing. First, MessageData.scala is explained. Its main roles are as follows:
(1) Definition of the base class for message data: It provides the MessageData class that manages the message ID, execution ID, index, query, message content, and message tags.
(2) Management of messages and tags: Messages are represented by the Message class and hold roles (e.g., “systemMessage,” “query,” “response”), content, and tags. The message content is retained via MessageCarrier or FileCarrier as text data or file data.
(3) Definition of tags and properties: It provides classes that manage global tags and properties, enabling centralized management of metadata associated with messages.

The notable features of MessageData.scala include its ability to handle messages and related data in a unified data structure, thereby facilitating smooth data exchange between chests; the ability to append additional information and settings to messages via tags and properties; and the ability to clearly manage the hierarchical structure and dependencies of messages.

Next, MessageCarrier.scala is explained. Its main roles are as follows:
(1) Definition of a carrier class that holds message content: MessageCarrier holds the specific content of a message (such as text, numbers, JSON data, etc.).
(2) Management and validation of data types: It defines the DataType trait, which represents various data types (such as strings, numbers, booleans, JSON, arrays, and objects). For each data type, it defines the validation of values and the structure of the data to ensure that the message data conforms to the correct format.
(3) Manipulation of message content: It allows for extracting and setting values of a message, as well as getting and setting the textual content. By locking/unlocking the message carrier, it can control whether the content is editable.
(4) Error handling: When an error occurs, it can generate a message carrier containing error messages and detailed information.

The notable features of MessageCarrier.scala are that it strictly manages the content of messages based on data types to maintain data integrity, that its flexible support for data types enables handling of various kinds of message content, and that its error handling functionality makes debugging easier when unexpected problems occur.

Next, FileCarrier.scala is explained. Its main roles are the following three:
(1) Definition of a carrier class that holds file data: FileCarrier manages the name, type, structure, list, maximum number, and other attributes of files.
(2) Definition of file types: It defines the FileType trait (a mechanism for extending class functionality), representing file types such as images, videos, audio, PDF, and text. Each file type has corresponding file extensions used for validation.
(3) Validation and manipulation of files: It verifies whether the list of file names satisfies the specified file type and maximum number restrictions. It is possible to generate new file carriers and assign values to existing ones.

The notable features of FileCarrier.scala are that it handles file data in a unified way and simplifies file operations within the message system, that linking file types and extensions allows for automated file validation, and that it enables the application of file management policies such as limitations on the maximum number of files.

Next, messageFormat.scala is explained. Its main roles are the following three:
(1) Definition of message formats and their behavior: MessageFormatConfig holds the settings of a message format (such as name, whether file use is allowed, file carrier, message carrier, whether queries and responses are allowed, etc.). The MessageFormatBehavior trait defines the behavior of specific message formats, such as transformation and validation of messages.
(2) Implementation of specific message formats: For example, specific formats such as TextTypeMessageFormatBehavior and StandardMessageFormatBehavior are implemented. Each format has its own message structure and transformation logic.
(3) Factory class for message formats: MessageFormatFactory provides the appropriate message format and its behavior based on a given name. It offers a list of available message formats and enhances extensibility.

Finally, the notable features of messageFormat.scala are that it abstracts message formats and is designed to flexibly handle different message structures, that it allows for easy addition of new message formats, providing high extensibility to the system, and that it encapsulates the behavior of each format, improving maintainability.

The relationships and characteristics of the overall system are as follows:
(1) Unified data management: Different types of data, such as messages and files, are handled under the common concept of a carrier, enabling unified operations on the data. Text data and file data are managed consistently through MessageCarrier and FileCarrier.
(2) Extensibility and flexibility: Abstracted data types, file types, and message formats make it easy to add new functions and data formats. By using MessageFormatFactory, new message formats can be dynamically generated and added.
(3) Management of metadata: Tags and properties are used to systematically manage metadata related to messages, allowing centralized handling of supplementary information. By using global tags, it becomes easy to share and identify data between chests.
(4) Validation and integrity of data: Through strict validation based on data types and file types, the reliability and consistency of data in the system are maintained. Mechanisms are built in to exclude invalid data input or unexpected data formats.

Furthermore, error handling and logging are also notable features. The error handling functionality facilitates debugging and log output when problems occur, thereby contributing to improved system reliability. When exceptions arise, detailed stack traces can be obtained, allowing developers to quickly identify the issue.

These files provide the foundation for performing message processing between chests efficiently and flexibly. By handling the data structures, formats, and carriers of messages and files in a unified manner, they facilitate data exchange and processing, thereby enhancing the extensibility and maintainability of the overall system. In addition, features such as data validation and error handling enable reliable system operation.

The linkage and display management with the chest flow configuration GUI processor will now be explained. The coordination between the chest flow configuration GUI processor and the chest flow execution controller is a crucial point when users manipulate messages and files. Here, the specific functions, flows, and features of how the chest flow configuration GUI processor utilizes the data structure of the chest flow execution controller for display management will be described in nine points.
(1) Sharing and synchronization of data structures: The chest flow configuration GUI processor receives data types and format information defined by MessageCarrier and FileCarrier of the chest flow execution controller and dynamically generates the UI based on them (utilization of data definitions from the chest flow execution controller). Using data type information defined in DataType, the chest flow configuration GUI processor renders appropriate input fields (such as text boxes, numeric inputs, checkboxes, file upload fields, etc.) (utilization of data types).
(2) Dynamic form generation: Components of the chest flow configuration GUI processor (e.g., MessageEditor) analyze the message format information provided by the chest flow execution controller and generate dynamic forms that allow users to input and edit messages (construction of message editor). Input components suitable for each data type are displayed—for example, a text area for string type, a number field for numeric type, and a code editor for JSON type (field rendering).
(3) Bidirectional binding of user input and data: The chest flow configuration GUI processor retains user input values as state and allows them to be reflected in real time into the data structure of the chest flow execution controller (state management). User inputs collected by the chest flow configuration GUI processor are converted into the data format expected by the chest flow execution controller and transmitted through an API (data assembly).
(4) Validation and error handling: The chest flow configuration GUI processor performs preliminary input checks and provides immediate feedback to the user (client-side validation), such as detecting missing required fields or invalid formats. The validation result from the chest flow configuration GUI processor is reference information, and the last data validation is performed by the chest flow execution controller. Error messages from the chest flow execution controller are displayed clearly to the user by the chest flow configuration GUI processor (coordination with server-side validation).
(5) Display control and improved user experience: By referencing expType, the expType field in MessageCarrier of the chest flow execution controller is used to control the visibility and editability of specific fields. This allows only necessary information to be presented to the user, keeping the UI concise. Depending on the message type or content, the chest flow configuration GUI processor customizes the display method (custom rendering), such as rendering text in Markdown format as rich text or showing code blocks with syntax highlighting.
(6) Reusability and extensibility of components: Components of the chest flow configuration GUI processor, such as TextEditor, NotebookEditor, and CSVEditor, are designed generically to support various data types. This allows for easy accommodation of new data types and display formats (generic component design). In the chest flow configuration GUI processor, when a user performs a specific action (e.g., right-click) within an input field, a support function (prompt holder) is triggered to provide template insertion or autocomplete (use of prompt holder).
(7) Interface for file operations: Based on the information in FileCarrier, the chest flow configuration GUI processor generates a file upload UI. Restrictions such as permitted file types and the maximum number of uploads are presented to the user in advance (file upload). Uploaded files are displayed in a list, and if supported, preview functionality and download links are also provided (file preview and download).
(8) Optimization of user interaction: Related fields and options are dynamically updated in response to user input, providing real-time feedback. For example, additional configuration items are displayed only when specific data types are selected. Using the state information of UnifiedChest, the current state of each chest (e.g., unset, processing, completed) is visually shown to the user to make the status observable.
(9) Communication with API and data synchronization: The chest flow configuration GUI processor invokes APIs of the chest flow execution controller in response to user operations to save, update, or retrieve data (data transmission and reception). When communication errors or server errors occur, appropriate error messages are displayed to the user, and error-handling mechanisms prompt retry or alternative actions.

In the coordination and display management with the chest flow configuration GUI processor, the processor faithfully reflects the data structures and rules defined by the chest flow execution controller while providing an intuitive and user-friendly interface. By combining features such as dynamic form generation, real-time validation, and prompt holders, the system improves user experience while maintaining data integrity.

User-related processing will now be described. First, AuthController is a controller based on the Play framework and handles HTTP requests for user authentication and account management. Its main functions are as follows:
(1) Login function: Authenticates the user using the username and password received from the client. Upon successful authentication, a JWT (JSON Web Token) is generated and returned in the response. This token is used to identify the user in subsequent requests.
(2) Logout function: Invalidates the token of the authenticated user. This ends the session and requires re-authentication to continue.
(3) User registration function: Creates a new user account using the username and password received from the client. During registration, duplicate usernames are checked to prevent duplicate account creation.
(4) User deletion function: Deletes the user with the specified user ID. This operation is assumed to be permitted only to users with administrator privileges.
(5) Self-deletion function: Allows an authenticated user to delete their own account.
(6) Password change function: Allows an authenticated user to update their password to a new one.
(7) Retrieve user list function: Retrieves information on all registered users. This operation is assumed to require administrator privileges.

Users.scala will now be explained. User is a case class that represents user information. The main fields are as follows:
(1) id: A unique identifier for the user.
(2) username: The user's name.
(3) password: The password. In a real application, password hashing is recommended.
(4) token: An optional JWT token used for authentication.
(5) storageLimit: The maximum storage capacity available to the user.
(6) projectLimit: The maximum number of projects that the user can create.
(7) createdAt: The timestamp when the account was created. The fromResultSet and toPreparedStatement methods are used to convert data to and from the database.

UserRepository.scala will now be described. UserRepository is responsible for database access. It provides the following ten methods:
(1) findById: Searches for a user by ID.
(2) findByUsername: Searches for a user by username.
(3) findByToken: Searches for a user by token.
(4) create: Inserts a new user into the database and returns the generated ID.
(5) updateToken: Updates the user's token, used during login and logout.
(6) delete: Deletes a user.
(7) isUsernameUnique: Checks whether the username is already in use.
(8) updateUser: Updates user information.
(9) updatePassword: Updates the user's password.
(10) listUsers: Retrieves a list of all users.

UserService.scala will now be described. UserService implements business logic and provides the following eight user-related operations using UserRepository:
(1) getUserByld: Retrieves user information by ID.
(2) getUserByUsername: Retrieves user information by username.
(3) createUser: Creates a new user. It ensures the uniqueness of the username.
(4) updateUser: Updates user information.
(5) deleteUser: Deletes a user.
(6) updateToken: Updates the token.
(7) updatePassword: Updates the password.
(8) listUsers: Retrieves a list of all users.

authAPI.js will now be described. authAPI.js is a utility that handles communication from the chest flow configuration GUI processor to the API of the chest flow execution controller. It provides the following six major functions, each of which invokes the corresponding endpoint of the execution controller and handles responses and errors:
(1) getCsrfToken: Obtains a CSRF token, which is required for security.
(2) login: Performs login using username and password and obtains a token and CSRF token.
(3) logout: Logs out the user and invalidates the token on the server side.
(4) register: Registers a new user.
(5) changePassword: Changes the user's password.
(6) deleteMyAccount: Deletes the account of the current user.

Account.js will now be described. Account.js is the account management page of the chest flow configuration GUI processor, implemented using React. It provides the following four functions:
(1) State management: Manages tokens and user information using the useState hook and AppContext.
(2) Form handling: Provides forms for login, registration, and password change, and processes user input.
(3) Navigation: Includes a function to transition to the project page after login.
(4) Message display: Provides feedback to the user regarding the success or failure of operations.

AppContext.js will now be described. AppContext.js uses React's context to manage application-wide shared state. Its features are as follows:
(1) Global state: Maintains authentication information such as token and csrfToken.
(2) Provider: Supplies the context to the entire application, allowing child components to access this information.

The above describes the details of user-related processing in the provided files. Through this structure, the chest flow execution controller and the chest flow configuration GUI processor cooperate to implement functions such as user authentication, registration, and management.

The region function refers to a mechanism for dividing and managing data and settings within a project into specific areas. A region groups related chests together, reducing the complexity of the project and enabling efficient data handling and management.

The main functions of the region feature are as follows:
(1) Creation and deletion of regions: When creating, a new region is created and associated with the current project. During creation, data from existing chest groups can be copied into the region. When deleting, unnecessary regions and the chest data associated with them can be deleted in bulk.
(2) Chest management within a region: Chests can be added to extend the region's dataset, removed to adjust it, or updated to reflect changes in the chest group.
(3) Synchronization with chest groups: The chest data in the region is synchronized with the chest group to maintain overall data consistency. Synchronization in the reverse direction, i.e., reflecting changes from the chest group into the region, is also possible.
(4) Tagging and selection state management: Tags can be assigned to regions to facilitate search and filtering. The selection state indicates whether a region is currently selected and reflects this in the UI.

The region function follows the flow below from steps 1 to 5:
(1) Region creation: The user enters the region name in the chest flow configuration GUI processor and clicks the create button. The server receives the request and creates a new region in the database. Optionally, data from an existing chest group can be copied into the region.
(2) Region deletion: The user selects the region to be deleted and performs the delete operation. The server deletes the region and associated chest data from the database.
(3) Adding/removing chests: The user adds new chests to or removes existing chests from the region. The server reflects these changes in the database and synchronizes with the chest group if necessary.
(4) Synchronization with chest groups: When the user performs a synchronization operation, the chest data in the region is updated in the chest group. The server retrieves the region data and updates the chest group accordingly.
(5) Filtering by tag: The user inputs a tag to search for relevant regions. The server searches for regions based on tag information and returns the results.

The features of the region function are as follows:
(1) Efficient data management: Organizing data by region makes it easier to manage large datasets.
(2) User-centered operability: Regions and chests can be intuitively managed in the chest flow configuration GUI processor, reducing the learning curve.
(3) Flexible scalability: The region function can be customized to meet project needs and is designed to integrate easily with additional functions or services.
(4) Data integrity maintenance: Synchronization with chest groups ensures data consistency across multiple regions.
(5) Advanced search functionality: Tagging enables fast search and access to highly relevant regions.

The region function is implemented in the chest flow configuration GUI processor with the following four UI elements for user interaction:
(1) Region management screen: A list view shows existing regions, allowing users to check key information such as name, tags, and number of chests. A creation/edit modal allows creation or editing of regions via modal windows, enhancing the user experience. Delete buttons are provided on each region item for easy deletion.
(2) Display of chest management functions: A list and detail view displays the chests in a region, allowing users to view detailed information. Buttons allow adding and deleting chests. Chest contents and settings can be edited directly and changes are reflected immediately.
(3) Search and filtering by tags: A tag search bar is placed at the top of the page to display only regions that match the entered tags. AND/OR searches with multiple tags are supported, enabling flexible filtering.
(4) Data synchronization button: A button is provided to synchronize data between the region and the chest group. Explicit synchronization by the user prevents unintended data changes.

The following are three use cases of the region function:
(1) Data separation in multi-tenant environments: When multiple clients or teams use the same project, data can be separated by region, facilitating permission management.
(2) Management of development, testing, and production environments: By creating separate regions for each environment, deployment and testing can be performed efficiently.
(3) Modularization of project functionality: In large-scale projects, functionalities can be divided into regions, making development and maintenance easier.

The technical details of the region function are as follows:
(1) Structure of the chest flow execution controller: The model layer defines the relationship between regions and their chests using Region and RegionChest models. The repository layer uses repository classes for database operations, handling persistence and retrieval. The service layer implements business logic through RegionService, managing complex operations and transactions. The controller layer provides API endpoints via FieldUtilityController, handling HTTP requests.
(2) Database integration: Asynchronous processing is used to communicate efficiently with the database. Placeholders are used to mitigate security risks such as SQL injection.
(3) API endpoints: createRegionWithChestGroup is used for creation, deleteRegionAndMemberChests for deletion, and endpoints such as updateChestGroupByRegionData are used for synchronization.
(4) Error handling: Appropriate error messages and HTTP status codes are returned for invalid requests or database errors. The system is designed to clearly inform users of the cause of the problem and how to address it.

The region function is an essential component for efficiently and flexibly managing data and settings within a project, whereby users can intuitively operate regions and chests via the chest flow configuration GUI processor, and the chest flow execution controller ensures data integrity and security through a robust architecture, thereby enhancing project scalability and manageability and contributing to improved productivity across the team.

The following provides a detailed explanation of the characteristics and execution flow of the recalculation function, based on further investigation of the relevant files, mainly focusing on the files RecalculationService.scala and ChestFieldService.scala, wherein the recalculation function enables the recomputation of results for existing chests to reflect the latest data and changes, making it possible to efficiently perform recalculations while considering dependencies among chests. First, the relevant files will be analyzed; RecalculationService.scala is a service class that manages the overall recalculation process and functions as a blueprint for generating objects, providing the following four primary functions: (1) identifying and setting the target chests for recalculation, (2) executing the recalculation, (3) handling sequence chests, and (4) managing the progression of the recalculation process.

The main methods of RecalculationService.scala are as follows:
(1) checkSourceChests: The purpose is to determine whether the source chests of chests in the waiting state are awaiting recalculation, to ensure that dependent chests are recalculated first, and to allow the selection of source chests of recalculation target chests even though, by default, the chest group at that point is assigned to the waiting state; the process flow involves obtaining the IDs of the target chests, acquiring the flow that targets those chests, retrieving a list of chests in the waiting state, and verifying whether the source chests are in the waiting state.
(2) setRecalculationChests: The purpose is to identify the chests that need to be recalculated and update their state to “recalculation”; the process flow involves retrieving all chests in the waiting state, excluding child chests of sequence chests, selecting as recalculation targets those chests whose source chests are not awaiting recalculation, and updating the state of the selected chests to “recalculation.”
(3) recalculateChests: The purpose is to execute the recalculation process on chests that have been designated for recalculation; the process flow involves retrieving the chests in the “recalculation” state, invoking executeRecalculation on each chest, and performing the recalculation.
(4) executeRecalculation: The purpose is to perform the appropriate recalculation process based on the chest type; the process flow involves determining the chest type (e.g., “map,” “yield,” “split,” “reduce”) and invoking the corresponding processing method based on the type, wherein, for example, in the case of a sequence chest, executeSequenceChestsInRecalculation is invoked.
(5) executeSequenceChestsInRecalculation: The purpose is to recalculate each child chest within a sequence chest, where regeneration of child chests is also possible, and in such cases, the chests are regenerated based on the recalculation results of the dependencies; the current implementation does not allow partial execution within regular processing, and all child chests of the recalculation target chest are recalculated; the process flow involves updating the sequence chest to the expanded state, generating child chests within the sequence as necessary, and initiating the execution of each child chest.

The second relevant file, ChestFieldService.scala, has the following two main methods:
(1) enterRecalculationMode: The purpose is to switch the project into recalculation mode and prepare for recalculation; the process flow involves retrieving the current project, updating the project's mode to “recalculation,” updating the state of chests belonging to the chest group to “wait,” and deleting the related chest group.
(2) cancelRecalculationMode: The purpose is to cancel the recalculation mode and return to normal mode; the process flow involves updating the project mode to “normal” and reverting the chests in the “wait” state back to “normal.”

The execution flow of the recalculation function proceeds according to the following steps 1 through 5:
(1) Switching to recalculation mode: The method enterRecalculationMode of ChestFieldService is invoked to change the project mode to “recalculation,” update the state of chests and their child chests belonging to the chest group in the project to “wait,” delete unnecessary chest groups, and prepare for recalculation.
(2) Identifying the chests to be recalculated: The method setRecalculationChests of RecalculationService is called to identify, from among the chests in the waiting state, those whose source chests are not awaiting recalculation; this enables recalculation with consideration for dependencies, and the state of recalculable chests is updated to “recalculation.”
(3) Executing the recalculation: The method recalculateChests of RecalculationService is used to perform recalculation on the target chests, whereby executeRecalculation is invoked for each chest, and recalculation is performed according to its type; recalculation is sequentially carried out starting from chests without dependencies within the initially assumed recalculation chests, progressively narrowing the scope of recalculation, and computation ends when no targets remain.
(4) Recalculating sequence chests: In the case of sequence chests, the method executeSequenceChestsInRecalculation is invoked to generate and execute child chests; the sequence chest is set to expanded state, the necessary child chests are generated, and recalculation is executed.
(5) Completion of recalculation and state update: The state of chests that have completed recalculation is updated to “completed,” and once all recalculations are finished, the method cancelRecalculationMode of ChestFieldService is invoked to return the project mode to normal.

The features of the recalculation function are as follows:
(1) Management of dependencies: During recalculation, dependencies among chests are considered, ensuring that source chests are recalculated first.
(2) Efficient recalculation: Only the chests that require recalculation are selectively processed, thereby reducing unnecessary computational resources.
(3) Processing tailored to chest type: Recalculation processing is appropriately performed according to the chest type, such as “map,” “yield,” “split,” or “reduce.”
(4) Thorough state management: The states of chests and projects are appropriately updated and managed to allow clear tracking of recalculation progress.
(5) Support for sequence chests: Recalculation of sequence chests is supported, and generation and execution of child chests are automated.

The recalculation function is an essential feature for keeping the computation results of chests up to date in response to data changes and updates, wherein the recalculation process is designed to be performed efficiently and accurately through the central components RecalculationService and ChestFieldService, and by thoroughly managing states and considering dependencies among chests, it prevents confusion or errors during recalculation.

Although the above has described specific embodiments of the system of the present invention, the present invention is not limited thereto, and various modifications and improvements to the computer configuration and functions in the embodiments can be made without departing from the gist of the present invention by those skilled in the art.

In the embodiments, four components have been provided, but the number of components may be increased or decreased by appropriately dividing or integrating the functions of these components.

What we claim is:

1: An application programming interface (API) utilization support system implemented on a computer system comprising a plurality of processors and memory, the API utilization support system designed to operate in conjunction with an API of an external artificial intelligence (AI) system supporting complex data processing, the API utilization support system comprising:
a chest flow configuration graphical user interface (GUI) processor including a GUI rendered on a display and interface elements arranged to enable visual creation, connection, and selection of a plurality of data processing nodes (chests) on a canvas, to generate a flow structure defining a data flow between the chests, and to allow definition of processing order and dependencies for each of the chests;
a database unit comprising a plurality of tables including at least account information, project information, chest detail information, connection relationship information among chests, message processing support helper information, AI model information, uploaded data file information, script data, and data flow identification information; and
a chest flow execution controller operatively connected to the chest flow configuration GUI processor and the database unit, which comprises circuitry and logic components to respond to sequential operation requests from the GUI by performing data exchange with the database unit, managing generation, deletion, placement, and updating of chests, controlling data flows and dependencies among chests, supporting graphical selection of execution of processing steps associated with the chests, constructing and transmitting messages to the API of the external AI system, receiving corresponding responses, and processing the responses in relation to the associated chests,
wherein the chest flow configuration GUI processor, the database unit, and the chest flow execution controller are network-connected components structured to make collaborative operation resulting in construction and execution of complex processing flows that involve interactions with the external AI system and are defined by visual and sequential user inputs.

2: The API utilization support system according to claim 1,
wherein the chest flow execution controller further comprises:
a notebook executor including a virtualized execution environment for processing scripts or structured queries associated with the chests and memory and output modules adapted to retain and provide execution results in a format usable for subsequent processing within the system; and
a file storage including memory components arranged to user-uploaded data files and system-generated files and management logic for holding storage and retrieval operations.

3: The API utilization support system according to claim 1,
wherein the chest flow execution controller further comprises a computation processing support module comprising:
a transmission interface for sending a script associated with the chest and corresponding input data to the API of the external AI system;
a response handler for acquiring a response from the API and performing analysis and formatting of the response as a processing result; and
a delivery component for providing the processed response to the chest or to subsequent processing modules within the system.

4: The API utilization support system according to claim 1,
wherein the chest flow execution controller further comprises a text preprocessing unit comprising:
a text analysis module for processing unstructured or semi-structured text data; and
a data extraction module for generating structured data formatted in a manner suitable for processing by the API of the external AI system.

5: The API utilization support system according to claim 1,
wherein the chest flow execution controller comprises:
a dependency management module that regulates the execution order and interdependencies of data processing operations across a plurality of chests, based on construction information of the dataflow defined by the chest flow configuration GUI processor;
a message generation module that constructs and transmits inquiries to the API of the external AI system from each chest in a consistent message format defined according to the configuration of each chest, and a response management module that stores the obtained API responses as messages associated with the respective chests; and
a message propagation module that enables sequential propagation and transformation of messages through subsequent chests, applying content conversion as needed, wherein the entire processing flow is thereby updated dynamically and in real time to allow feedback control of outputs throughout the system.

6: The API utilization support system according to claim 1,
wherein a respective chest is a basic unit for data processing and includes at least one of different operation modes comprising: a map-type chest that performs identical processing in parallel to a plurality of target data sets; a yield-type chest that performs repeated processing in a sequential manner; a reduce-type chest that combines multiple input data into an integrated result; and a split-type chest that divides input data into subsets for application of different processing thereto,
wherein the chests are represented as visual objects in a field on the user interface of the chest flow configuration GUI processor, and
wherein a user interface allows a user to construct the entire dataflow by setting visual flow objects between the plurality of chests on said field.

7: The API utilization support system according to claim 1,
wherein the chest flow execution further comprises a partial execution unit comprising:
a selection mechanism for executing only a portion of the plurality of chests included in the dataflow as designated by a user; and
a snapshot generator for producing a shot data structure that records input/output states of the designated chests as a snapshot based on the user specification;
wherein the partial execution unit further comprises a control mechanism arranged to selectively execute the designated portion of the chests by comparing and matching their states with those of other chests based on the shot data structure.

8: The API utilization support system according to claim 1,
wherein the chest flow execution controller further comprises a recalculation unit comprising:
a dependency-based execution engine for performing recalculation and re-execution of related flows in accordance with dependency relationships among a plurality of chests included in the dataflow;
a re-editing interface operable in conjunction with the GUI to accept range-designation inputs from the user and to permit modification of configuration content for a selected group of chests; and
a consistency verification module for automatically verifying consistency between the re-edited chests and their dependent chests, and for initiating recalculation within the designated range based on the verification result.

9: The API utilization support system according to claim 1,
wherein the chest flow execution controller further comprises a message helper unit in which processing logic related to generation, transformation, formatting, or transmission of API messages in each chest is described in a common definition format, and
wherein the message helper unit has a structure referable from a plurality of chests and allows the same message processing definition to be shared and reused across multiple chests.

10: The API utilization support system according to claim 1,
wherein the chest flow configuration GUI processor further comprises a stream display unit that displays, in a stream-format interface dynamically updated along a time axis or processing order, summary information related to processing results or states associated with respective chests, and
wherein the user is enabled, via the stream display unit, to visually and consecutively grasp the summary information of multiple chests on a single screen, thereby efficiently tracking the state changes of the overall processing flow and dynamically monitoring transitions in dependencies and processing results among the chests.

11: The API utilization support system according to claim 1,
wherein the chest flow execution controller further comprises:
a chest initial calculation unit including a processing engine that performs initial computation based on scripts or templates associated with a chest at the time of generating a new chest in the dataflow and produces corresponding properties and tags; and
a recalculation unit including an editing interface dependency management module for applying modifications to a user-selected range of chests, updating inter-chest dependencies, and executing reprocessing of the entire or partial dataflow, and
wherein the graphical user interface includes a selection mechanism that permits a user to apply either the chest initial calculation unit or the recalculation unit to a corresponding chest.

12: The API utilization support system according to claim 1,
wherein the chest flow execution controller further comprises a message tag unit including a tag management structure that retains message tags that include information added to each message to identify conversion rules or processing conditions when the message is processed between chests, and
wherein the message tag unit serves as a mapping reference during conversion processing between chests, and the message tag is also usable as a flag for classification, priority, execution target designation, or processing mode switching of the message.

13: The API utilization support system according to claim 1,
wherein the chest flow execution controller further comprises a dataflow backup unit including a storage module for retaining configuration information of a dataflow constructed by a user in a template format,
wherein the storage module records the entire dataflow, including chest configurations, connection relationships, message processing definitions, and tag information, as a template structure, and
wherein the recorded dataflow template is structured to be applicable to any project and is usable as a reusable component within a corresponding project.

14: The API utilization support system according to claim 1,
wherein the API utilization support system comprises a project operation interface unit for visually managing projects and operating chests on a field, and wherein the project operation interface unit comprises:
a project management unit interface component for listing, selecting, creating, updating, and deleting of multiple projects and to acquire and display relevant information of a selected project;
a chest operation unit including a visual display component for presenting chests and dataflows between them on a field corresponding to a selected project, and an input interface for accepting operations including addition, movement, and connection of chests;
an output stream display unit including a list display component for presenting messages or processing result data output from each chest;
a chest display unit including control components for managing the display state of each chest and handling user interaction and object representation on the field;
a flow display unit including graphical components for visually presenting dataflows between chests using connection lines or similar elements, thereby representing the flow of data;
a sequence management unit including interface elements for handling expansion and collapse operations based on logical sequence relationships among groups of chests, and for presenting child chests upon expansion; and
a field operation processing unit comprising functional modules for executing processing related to creation, updating, recalculation, and sequence execution of chests and flows in response to operation requests from the interface unit, and for supplying corresponding business logic.

15: The API utilization support system according to claim 1,
wherein the chest flow configuration GUI processor further comprises a plurality of function management units configured to provide various system functions in a distributed manner in response to user operations, and
wherein the function management units comprises:
an account management unit including components for user account registration, authentication, and management of account settings;
a file operation unit including an interface for uploading, downloading, and deleting data files;
a user support unit comprising display modules for presenting information on system usage and frequently asked questions (FAQs);
a message helper management unit including editing tools and display elements for adding, editing, deleting, and managing auxiliary information (message helpers) used in message processing;
a notebook management unit comprising modules for creating, editing, executing, and deleting notebooks via a user interface;
a project management unit including interface components for listing, creating, deleting, selecting, and updating projects;
a template management unit comprising logic for storing and retrieving dataflow templates and performing mutual conversion between templates and projects;
an AI model management unit including functional modules for training, registering, and using AI models based on user-provided data;
an application state sharing unit comprising structures for managing application-wide state information;
a utility frame unit including a shared user interface framework for controlling and presenting pages of various utility functions; and
a navigation control unit comprising navigation display components for presenting links to respective pages and showing current page information or contextual usage status,
wherein the navigation control unit serves as a central access interface, facilitating efficient user access to the various function management units, and
wherein the AI model management unit supports construction and in-system use of custom AI models by users.

16: The API utilization support system according to claim 1,
wherein the chest flow execution controller further comprises an AI chat collaboration unit that includes components for executing coordination processing with a chat API of an external artificial intelligence (AI) system,
wherein the AI chat collaboration unit comprises: (a) a message formatting unit including a filtering and transformation module for processing message data generated in a chest, the module applying predefined properties based on conditions such as role, tag, and text content, and converting the message into a format required by the AI system, including a list format of role-content pairs; (b) a chat query generation unit comprising logic for constructing request data for a chat model of the AI system based on the formatted message and transmitting the request to acquire an AI response; (c) a response generation unit including processing components for receiving the AI response, extracting relevant information, applying tagging or format conversion where applicable, generating a final response message, and storing the response in an executor or a state management unit within the system, and
wherein the AI chat collaboration unit comprises functional structures that support dialog processing with the AI system in response to user input and enable automatic generation and delivery of contextually appropriate responses.

17: The API utilization support system according to claim 16,
wherein the chest flow execution controller further comprises an AI model tuning unit for constructing and managing AI models,
wherein the AI model tuning unit comprises: (a) a custom model tuning module including processing logic for training and updating a user-defined AI model using a dataset output from the message formatting unit as training data; (b) an embedding model query module including components for executing inference processing based on vector embeddings; (c) a model registration management module including structures for recording the above modules in association with AI model helpers, and for maintaining references to the registered models for use in subsequent chest processing; and (d) a model identification response module including functionality for acquiring identification information of the registered AI models and providing such information to the user to indicate availability status of the AI models, and
wherein the AI model tuning unit includes mechanisms by which a user may register, reference, and utilize independently constructed or trained AI models within the system.

18: The API utilization support system according to claim 17,
wherein the chest flow execution controller further comprises an external search collaboration unit for supporting information acquisition using an external search engine,
wherein the external search collaboration unit comprises: (a) a search message extraction module including logic for identifying and extracting keywords or URLs from messages in a chest and for converting the extracted content into a format compatible with an external search API; (b) a search execution module including components for transmitting queries to an external search service, such as Google, based on the extracted keywords or URLs, and for acquiring corresponding search result data; and (c) a search response generation module including functionality for automatically generating a response message based on the acquired search results, storing the response in the executor within the system, and formatting the response into a form suitable for presentation to the client, and
wherein the external search collaboration unit includes structural components that support real-time acquisition of external information from user input or chest messages and integrate such information into the in-system processing flow for generation of contextually enriched responses.

19: The API utilization support system according to claim 16,
wherein the chest flow execution controller further comprises a standard AI system chat query further comprises: (a) a query function controller comprising logic for defining primary processing functions related to the chat query and for controlling the operation of sub-function modules; (b) a message formatter including components for formatting query messages, applying tags, and merging the messages with system-level messages; (c) an AI API communicator including interfaces for transmitting queries to and receiving responses from the API of the external AI system; and (d) a system message manager comprising storage and processing structures for maintaining system message templates used as inputs to the AI model, and for embedding context-sensitive instructions into the templates, and
wherein the query function controller is implemented as a central coordination unit among the modules, and the respective modules operate in cooperation to process dialog interactions with the external AI system using a configuration that supports extensibility and modular reuse.
